(19) United States
(12) Patent Application Publication
(10) Pub. No.: US 2013/0304742 A1
(43) Pub. Date: Nov. 14, 2013

(54) HARDWARE-ACCELERATED CONTEXT-SENSITIVE FILTERING

(71) Applicant: LOS ALAMOS NATIONAL SECURITY, LLC, Los Alamos, NM (US)

(72) Inventors: Jorge Hugo Roman, Los Alamos, NM (US); Thomas Michael Boorman, White Rock, NM (US); Andrea Michelle Spearing, Los Alamos, NM (US); Andrew John Dubois, Santa Fe, NM (US); David Harold Dubois, Los Alamos, NM (US); Ekaterina Alexandra Davydenko, Los Alamos, NM (US)

(73) Assignee: LOS ALAMOS NATIONAL SECURITY, LLC, Los Alamos, NM (US)

(21) Appl. No.: 13/795,847

(22) Filed: Mar. 12, 2013

Related U.S. Application Data
(60) Provisional application No. 61/609,792, filed on Mar. 12, 2012.

(51) Int. Cl. G06F 17/30; H04L 12/58

(52) U.S. Cl. CPC G06F 17/30598; H04L 51/12
USPC 707/740; 707/748; 707/736; 709/206

(57) ABSTRACT

Various technologies related to hardware-accelerated context-sensitive filtering are described. Compact filter rules can implement powerful filtering functionality via concept rules and weightings. Superior performance can be achieved via hardware acceleration. A variety of scenarios such as search, document filtering, email filtering, and the like can be supported.

### CROSS REFERENCE TO RELATED APPLICATION

This application claims priority to U.S. Provisional Application No. 61/609,792, filed Mar. 12, 2012, which is incorporated herein in its entirety by reference.

### ACKNOWLEDGMENT OF GOVERNMENT SUPPORT

This invention was made with government support under Contract No. DE-AC52-06NA25396 awarded by the U.S. Department of Energy. The government has certain rights in the invention.

### BACKGROUND

There are a wide variety of searching and filtering technologies available; however, they have various shortcomings. For example, the ability of users to precisely express complex filter concepts is limited. And, the performance of various tools can degrade as the search criteria become more complex.

### SUMMARY

A variety of techniques can be used for filtering. Hardware acceleration can be used to provide superior performance.

A rich set of features can be supported to enable powerful filtering via compact filter rule sets. For example, filter rules can implement locality operators that are helpful for establishing context. Concept rules can be used to specify concepts that can be re-used when specifying rules. Rules can support weighting.

Considerable ease-of-use and performance improvements in the filtering process can be realized.

Such technologies can be used in a variety of domains, such as search, email filtering (e.g., outgoing or incoming), and the like. As described herein, a variety of other features and advantages can be incorporated into the technologies as desired.

The foregoing and other features and advantages will become more apparent from the following detailed description of disclosed embodiments, which proceeds with reference to the accompanying drawings.

### BRIEF DESCRIPTION OF THE FIGURES

FIG. 1 is a block diagram of an exemplary system implementing the hardware-accelerated context-sensitive filtering technologies described herein.

FIG. 2 is a flowchart of an exemplary method of implementing the hardware-accelerated context-sensitive filtering technologies described herein.

FIG. 3 is a block diagram of an exemplary system compiling rules for use in hardware-accelerated context-sensitive filtering.

FIG. 4 is a flowchart of an exemplary method of compiling rules for use in hardware-accelerated context-sensitive filtering.

FIG. 5 is a block diagram of an exemplary system performing hardware-accelerated context-sensitive filtering.

FIG. 6 is a flowchart of an exemplary method of performing hardware-accelerated context-sensitive filtering.

FIG. 7 is a block diagram of an exemplary system implementing multi-stage hardware-accelerated context-sensitive filtering.

FIG. 8 is a flowchart of an exemplary method of implementing multi-stage hardware-accelerated context-sensitive filtering.

FIG. 9 is a block diagram of an exemplary computing environment suitable for implementing any of the technologies described herein.

FIG. 10 is a block diagram of illustrating the computation of the total input score by using the technologies described herein.

FIG. 11 is a schematic illustrating matched patterns can be distinctively depicted in the original text, thereby giving a user a quick view of the coloring (contribution of this section to the overall score) by using the technologies described herein.

FIG. 12 is a schematic of an Indago annotated analysis result available to the end user, using a publicly available article (Dan Levin, “China's Own Oil Disaster,” The Daily Beast, Jul. 27, 2010).

FIG. 13 is a digital image of a NetLogic NLS220HAP Layer 7 Hardware Acceleration Platform (HAP) card which can be used with technologies described herein.

FIG. 14 is a schematic of an overview of an exemplary eMF-HAI structure.

FIG. 15 is a flow chart outlining the per-thread processing that is executed using the disclosed technologies.

FIG. 16 is a Indago scalability diagram.

FIG. 17 is a diagram of a simple rule set using Indago.

FIG. 18 is a schematic of an annotated and hyperlinked document generated by using the technologies described herein.

FIG. 19 is a graph of Indago score distribution versus relevance.

FIG. 20 is a graph of hardware speedup versus file size.

FIG. 21 is a graph of percentage decrease total runtime versus file size.

FIG. 22 is a graph of software-only time breakdown.

FIG. 23 is a graph illustrating hardware-assist Processing Time Breakdown

FIG. 24 is a series of pie charts illustrating processing breakdown.

FIG. 25 is a graph illustrating software-only percentage increases.

FIG. 26 is a graph illustrating hardware-assisted percentage increases.

FIG. 27 is a graph illustrating threads versus total time (file size, 91958 Bytes).

FIG. 28 is a diagram providing an overview of a notional gateway system.

FIG. 29 is a diagram of the components and workflow in an exemplary system.

FIG. 30 is a diagram illustrating message scoring flow.

FIG. 31 is screen shot illustrating changing the Zimbra Timeout Value.

FIG. 32 is diagram providing an overview of an exemplary review process.

FIG. 33 is a screen shot of a web-based ZCS Login screen.

FIG. 34 is a screen shot of a sample inbox display for DC Review.

FIG. 35 is screen shot showing an active DC Review Browser Link.

FIG. 36 is a screen shot of the DC Reviewer Interface.

FIG. 37 is a screen shot of Index.html: annotation of a rerouted message.

FIG. 38 is a screen shot of a sample rerouted message (Condition 1).

FIG. 39 is a screen shot of a sample unsupported file format message (Condition 2).

FIG. 40 is a screen shot of a sample software error message (Condition 4).

FIG. 41 is a screen shot of a web email interface.

FIG. 42 is a screen shot illustrating a sample message composition with subject line and top/bottom classification marking.

FIG. 43 is a screen shot illustrating a sample delayed message warning created from an embodiment of the disclosed system.

FIG. 44 is a screen shot of a sample graph of a rule set interface.

### DETAILED DESCRIPTION

### Example 1

### Exemplary Overview

The technologies described herein can be used for a variety of hardware-accelerated context-sensitive filtering scenarios. Adoption of the technologies can provide performance superior to software-only implementations.

The technologies can be helpful to those desiring to reduce the amount of processing time to filter documents. Beneficiaries include those in the domain of search, security, or the like, who wish to perform large-scale filtering tasks. End users can also greatly benefit from the technologies because they enjoy higher performance computing and processing.

### Example 2

### Exemplary System Employing a Combination of the Technologies

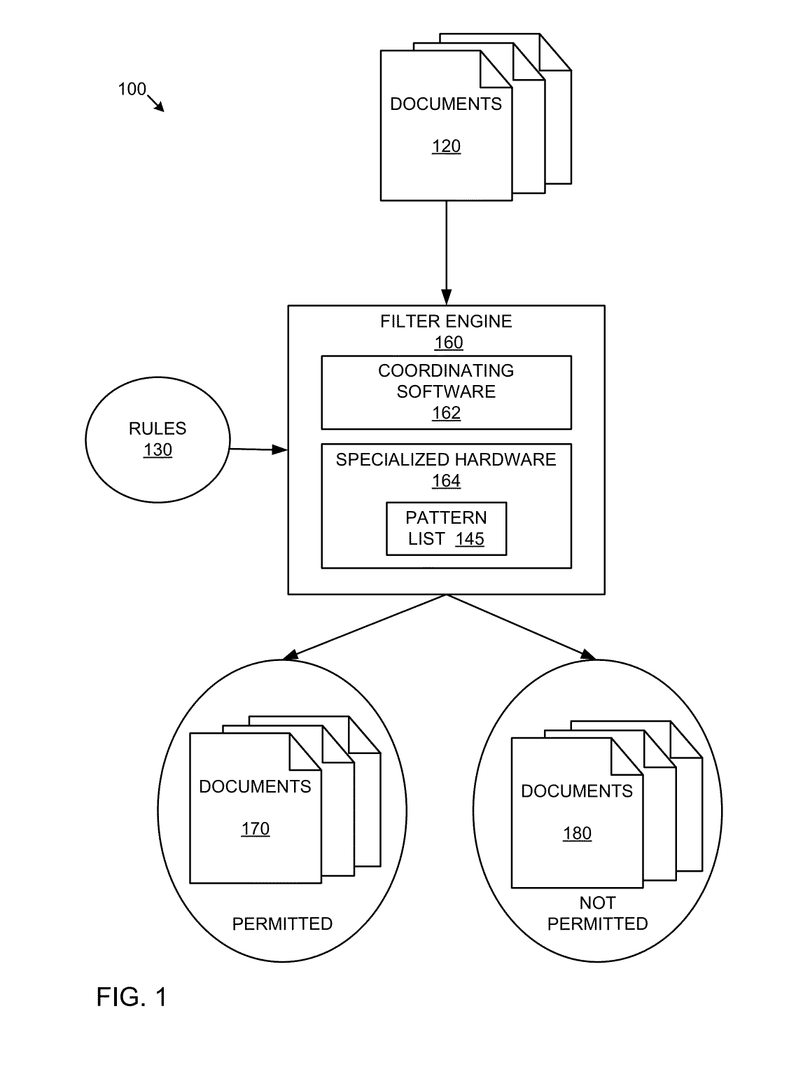

FIG. 1 is a block diagram of an exemplary system 100 implementing the hardware-accelerated context-sensitive filtering technologies described herein. In the example, one or more computers in a computing environment implement a filter engine 160 that accepts as input documents 120 for filtering and filter rules 130.

The engine 160 includes coordinating software 162, which coordinates the participation of the specialized hardware 164, which stores a pattern list 145 (e.g., derived from the rules 130 as described herein).

The filter engine 160 can classify incoming documents 120 as permitted documents 170 or not permitted documents 180. For example, the filter engine 160 can input an indication of whether a document is permitted (e.g., by an explicit output or by placing the document in a different location depending on whether it is permitted or the like). Although the example shows classifying documents as permitted or not permitted, other scenarios are possible, such as matching or not matching, or the like.

In practice, the systems shown herein, such as system 100 can be more complicated, with additional functionality, more complex inputs, more instances of specialized hardware, and the like. Load balancing can be used across multiple filter engines 160 if the resources needed to process incoming documents 120 exceeds processing capacity.

In any of the examples herein, the inputs, outputs, and engine can be stored in one or more computer-readable storage media or computer-readable storage devices, except that the specialized hardware 164 is implemented as hardware. As described herein, a software emulation feature can emulate the hardware 164 if it is not desired to be implemented as hardware (e.g., for testing purposes).

### Example 3

### Exemplary Method of Applying a Combination of the Technologies

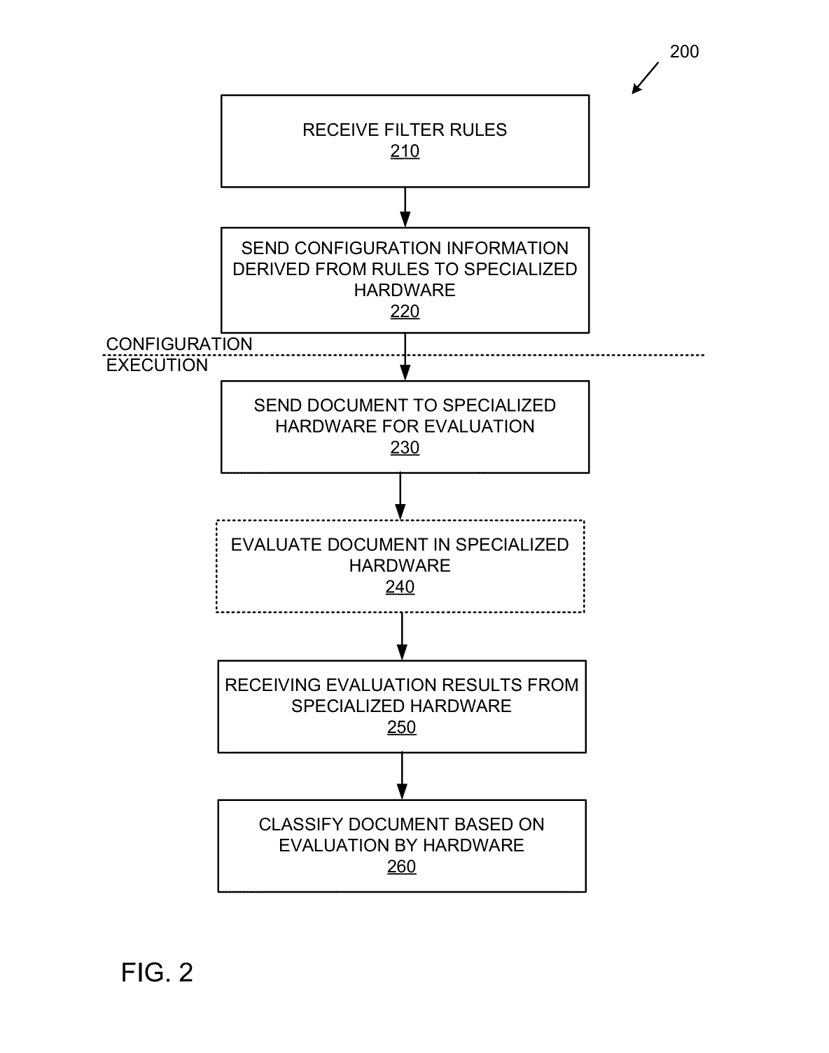

FIG. 2 is a flowchart of an exemplary method 200 of implementing the hardware-accelerated context-sensitive filtering technologies described herein and can be implemented, for example, in a system such as that shown in FIG. 1. The technologies described herein can be generic to the specifics of operating systems or hardware and can be applied in any variety of environments to take advantage of the described features.

At 210, filter rules are received. Such rules can comprise conditions indicating when the rule is met and associated word patterns. As described herein, locality conditions, supplemental definitions, and weightings can be supported.

At 220, configuration information derived from the rules is sent to the specialized hardware. As described herein, such information can comprise the word patterns appearing in the rules.

At 230, a document to be filtered is sent to specialized hardware for evaluation.

At 240, the document is evaluated in specialized hardware according to the configuration information. Such an evaluation can be a partial evaluation of the document. Further evaluation can be done elsewhere (e.g., by software that coordinates the filtering process).

At 250, the evaluation results are received from the specialized hardware. As described herein, such results can include an indication of which patterns appeared where within the document.

At 260, the document is classified based on the evaluation by the specialized hardware.

The acts 210 and 220 can be done as a part of a configuration process, and acts 230, 240, 250, and 260 can be done as part of an execution process. The two processes can be performed by the same or different entities. The acts of 230, 250, and 260 can be performed outside of specialized hardware (e.g., by software that coordinates the filtering process).

The method 200 and any of the methods described herein can be performed by computer-executable instructions stored in one or more computer-readable media (e.g., storage or other tangible media) or stored in one or more computer-readable storage devices.

### Example 4

### Exemplary System Employing a Combination of the Technologies

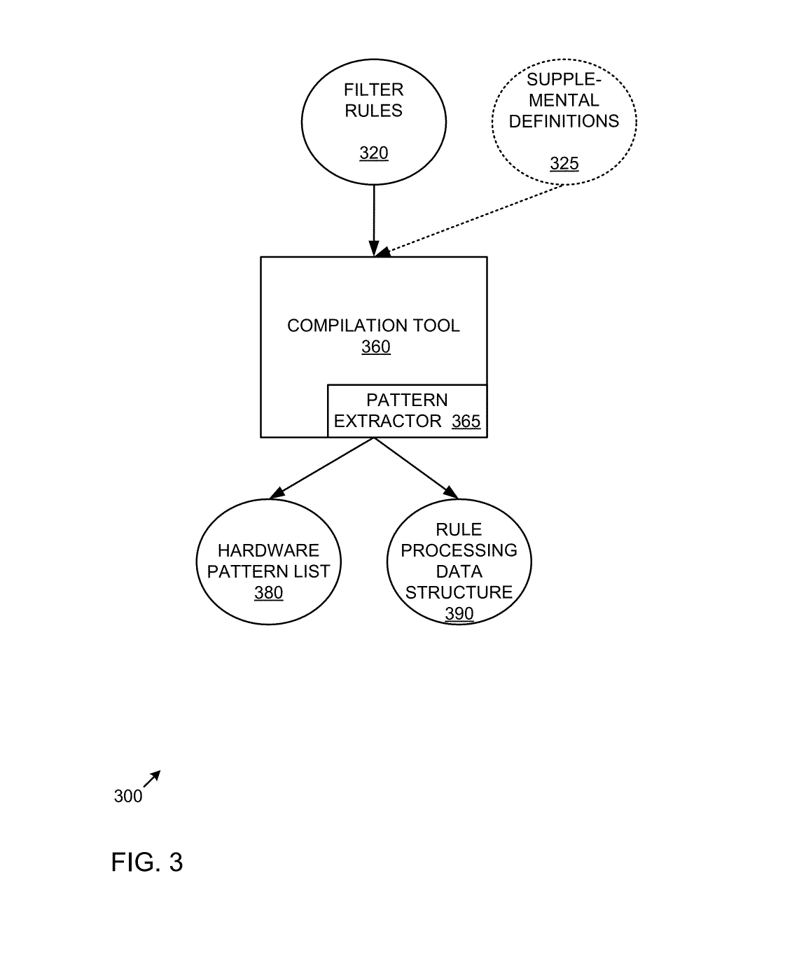

FIG. 3 is a block diagram of an exemplary system 300 compiling rules for use in hardware-accelerated context-sensitive filtering. In the example, a compilation tool 360 accepts filter rules 320 as input. Supplemental definitions 325 can also be accepted as input as described herein.

The compilation tool 360 can comprise a pattern extractor 365, which can extract patterns from the rules 320, supplemental definitions 325, or both. As part of the compilation process, various pre-processing and other techniques can be used to convert the rules 320, 325 into a hardware pattern list 380 and rule processing data structure 390. The compilation tool 360 can expand the compact representation of the rules 320, 325 to a more exhaustive and explicit representation of the rules that is acceptable to the specialized hardware.

The hardware pattern list 380 can include the patterns appearing in the rules 320, 325. In practice, the pattern list 380 can be implemented as a binary image that is loadable into specialized hardware, causing the hardware to provide the document evaluation results described herein.

The rule processing data structure 390 can be used as input by software that coordinates the hardware-accelerated context-sensitive filtering. For example, it can take the form of a Java class that implements various functionality associated with processing the evaluation results provided by the specialized hardware (e.g., to process the rules 320, 325).

### Example 5

### Exemplary Method of Applying a Combination of the Technologies

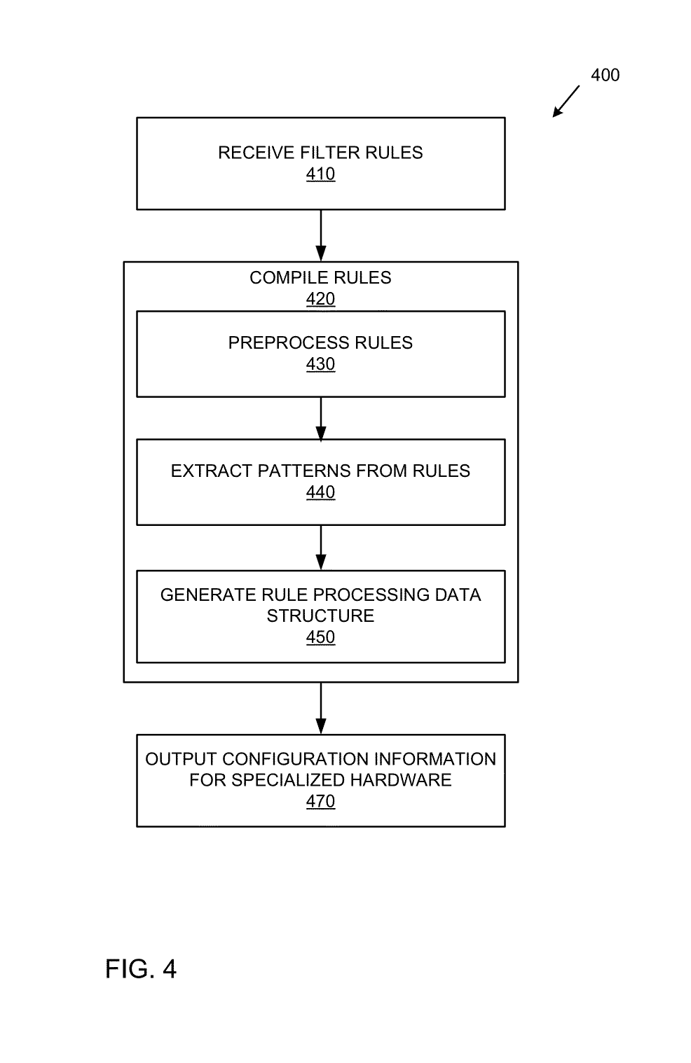

FIG. 4 is a flowchart of an exemplary method 400 of compiling rules for use in hardware-accelerated context-sensitive filtering technologies described herein and can be implemented, for example, in a system such as that shown in FIG. 3.

At 400, filter rules are received. Any of the rules and supplemental definitions described herein can be supported.

The rules are compiled at 420. Compilation places the rules into a form acceptable to the specialized hardware (e.g., a driver or API associated with the hardware). Some stages (e.g., the later hardware-related stages) of compilation can be implemented via software bundled with the specialized hardware.

At 430, the rules are pre-processed. Such pre-processing can include expanding a compact representation of the rules to a more exhaustive and explicit representation of the rules that is acceptable to the specialized hardware (e.g., by expanding references to supplemental definitions).

At 440, patterns are extracted from the rules. As described herein, such patterns can take the form of regular expressions.

At 450, a rule processing data structure is generated. Such a data structure can be used in concert with evaluation results provided by the specialized hardware to process the rules.

At 470, configuration information for the specialized hardware is output. Such configuration information can take the form of a binary image or the list of patterns that can be used to generate a binary image. To achieve configuration of the software, the patterns are converted to or included in a specialized hardware format.

### Example 6

### Exemplary System Employing a Combination of the Technologies

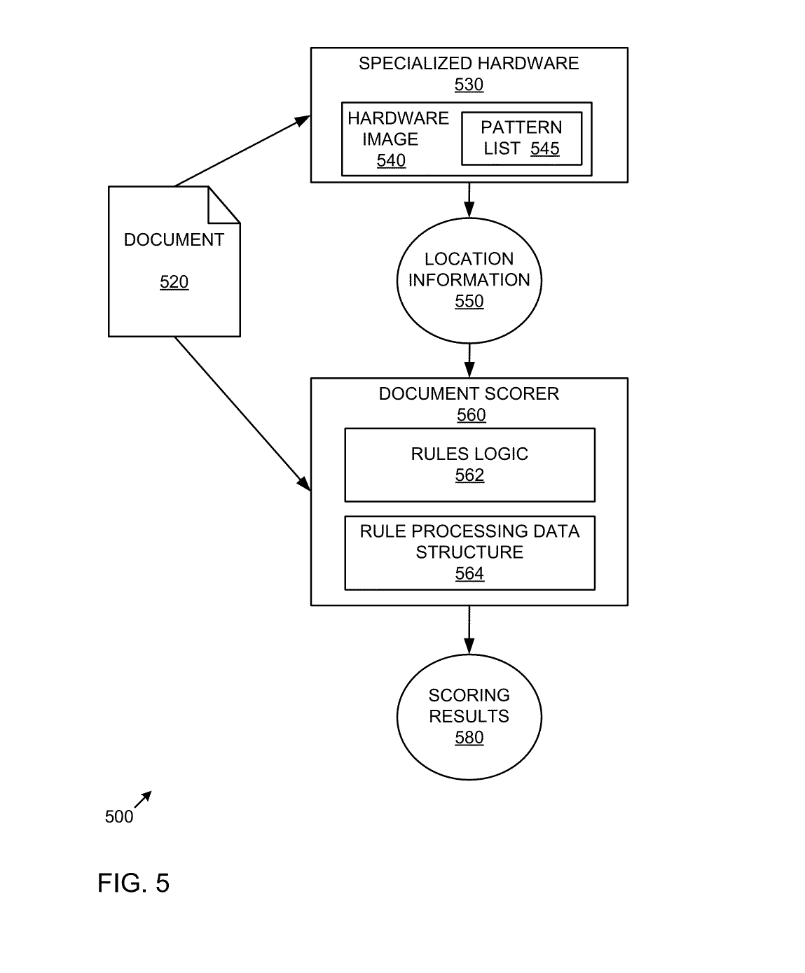

FIG. 5 is a block diagram of an exemplary system 500 performing hardware-accelerated context-sensitive filtering as described herein. In the example, a document 520 is accepted as input by the specialized hardware 530 and a document scorer 560, which work in concert to process the document.

The specialized hardware 530 typically includes a hardware (e.g., binary) image 540 that is understandable by the processor(s) of the specialized hardware 530. Incorporated into the hardware image 540 is a pattern list 545 (e.g., derived from the filter rules as described herein). In practice, the pattern list may not be recognizable within the hardware image 540 because it may be arranged in a way that provides superior performance.

The specialized hardware 530 outputs evaluation results that include location information 550. For example, the location information 550 can indicate where within the document 520 the patterns in the pattern list 545 appear (e.g., for patterns appearing in the document, respective locations are indicated).

The document scorer can accept the location information 550 as input and use rules logic 562 and a rule processing data structure 564 to score the document 520, providing scoring results 580. As described herein, the rules logic 562 and data structure 564 can support locality conditions that can be determined via examination of the location information 550 (e.g., in combination with locality analysis of the document 520).

The scoring results 580 can be used to classify the document 520 (e.g., via a threshold or other mechanism).

In practice, coordinating software can coordinate document submission to the specialized hardware 530. Such hardware can be incorporated with the document scorer 560, or be run as a separate module.

### Example 7

### Exemplary Method of Applying a Combination of the Technologies

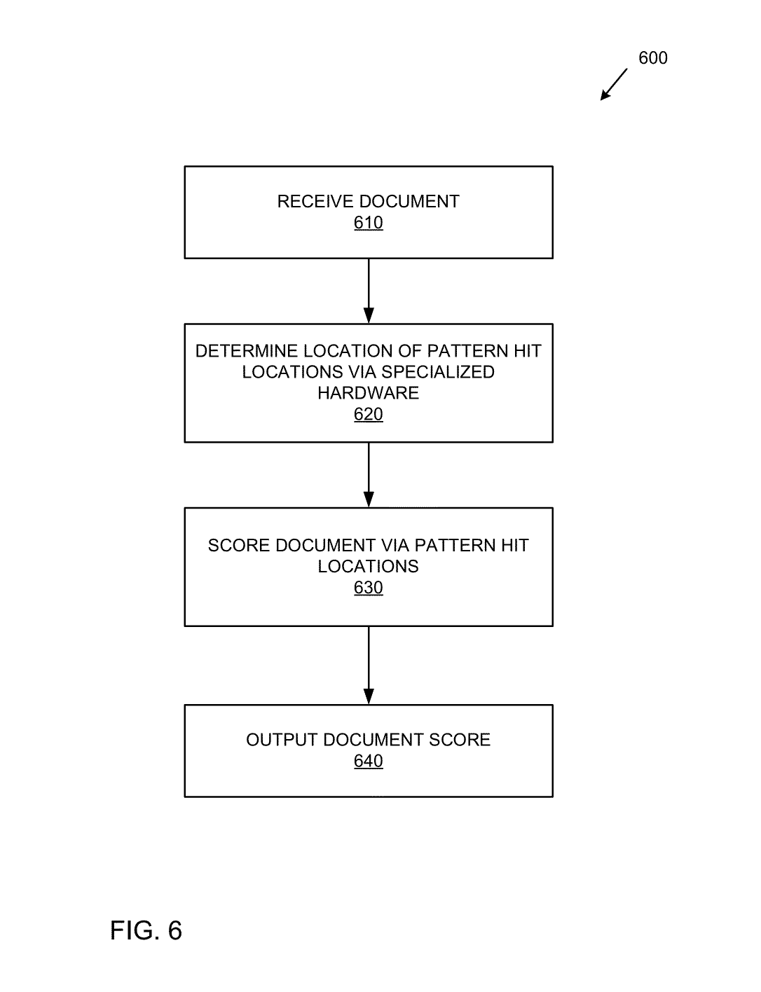

FIG. 6 is a flowchart of an exemplary method 600 of performing the hardware-accelerated context-sensitive filtering technologies described herein and can be implemented, for example, in a system such as that shown in FIG. 5.

At 610, a document is received for filtering.

At 620, the location of pattern hit locations (e.g., patterns extracted from the rules) are determined via specialized hardware. For example, the document can be sent to the hardware and location information can be received in response.

At 630, the document is scored via the pattern hit locations. As described herein, rules can be weighted, resulting in a score that reflects such weightings.

At 640, a document score is output.

### Example 8

### Exemplary System Employing a Combination of the Technologies

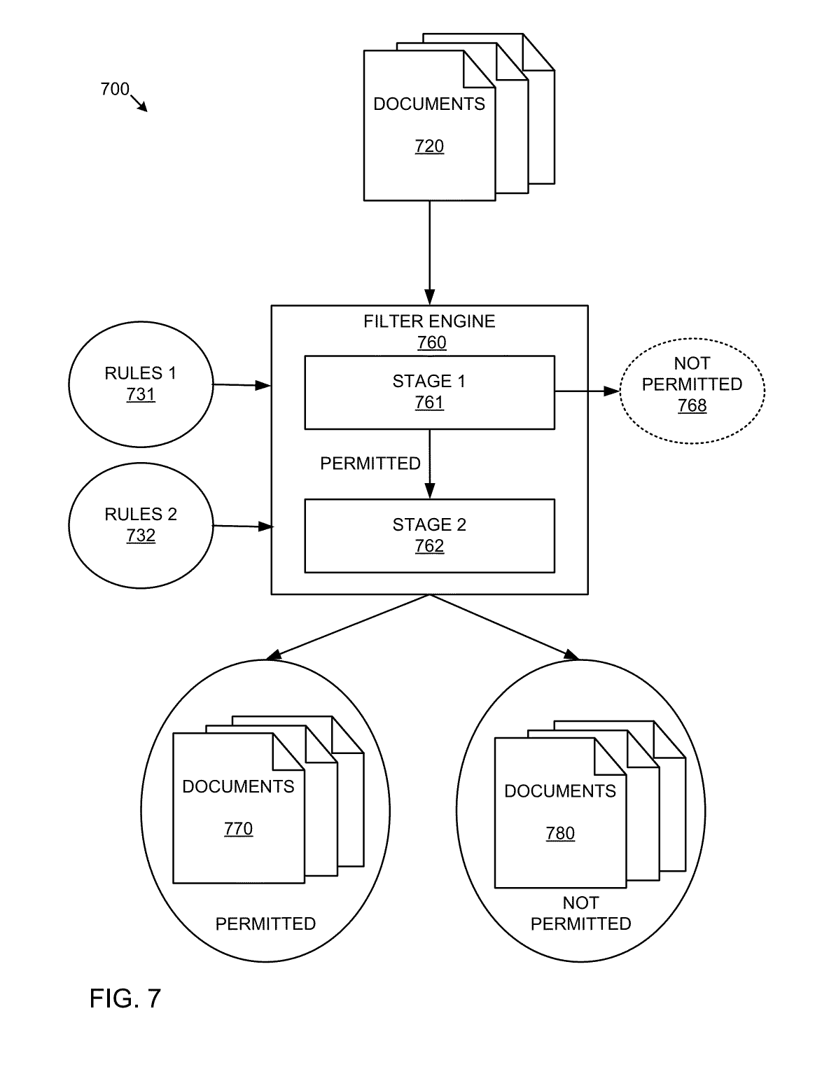

FIG. 7 is a block diagram of an exemplary system 700 implementing multi-stage hardware-accelerated context-sensitive filtering and can be implemented in any of the examples described herein. In the example, a filter engine 760 accepts documents 720 and rule sets 731, 732.

The filter engine comprises at least two stages 761 and 762, which apply respective rule sets 731 and 732 (e.g., using the hardware accelerated filtering technologies described herein). The stages 761 and 762 can differ fundamentally in their function. For example, one may provide context-sensitive filtering, while the other need not. One may implement locality conditions, while the other need not.

The engine 760 can provide output in the form of a classification of the document 720 (e.g., permitted 770 or not permitted 780). An intermediary not permitted 768 can be supported (e.g., documents that are knocked out before being submitted to the last stage).

### Example 9

### Exemplary Method of Applying a Combination of the Technologies

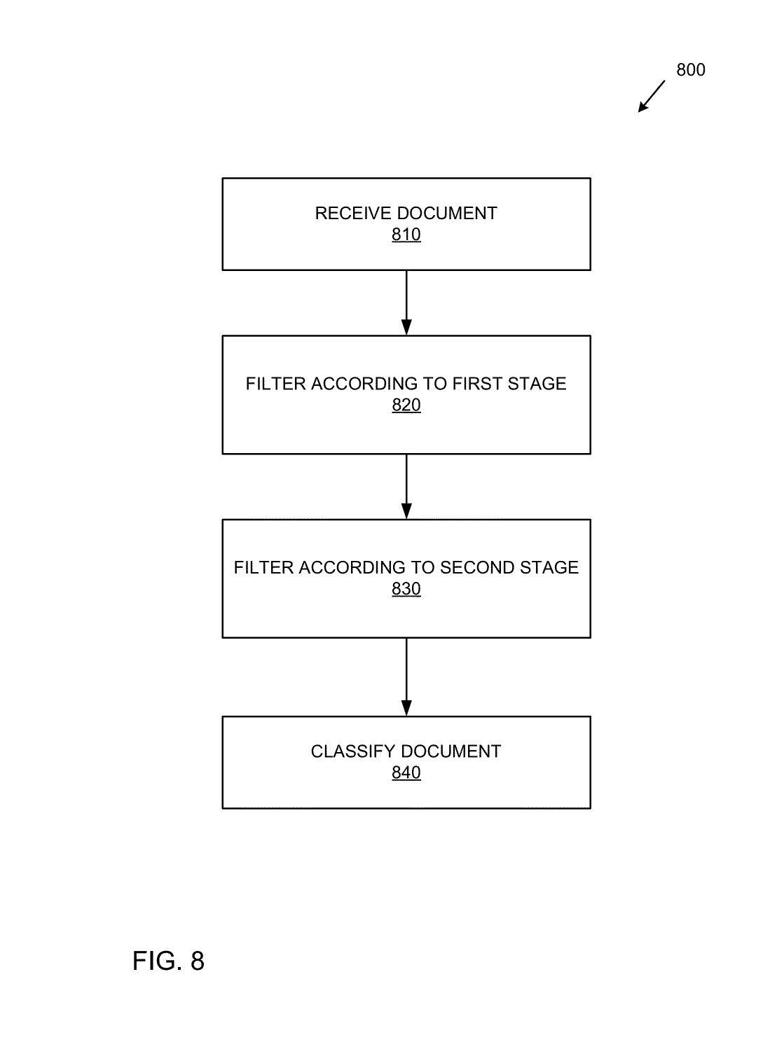

FIG. 8 is a flowchart of an exemplary method 800 of implementing multi-stage hardware-accelerated context-sensitive filtering technologies described herein and can be implemented, for example, in a system such as that shown in FIG. 7.

At 810, a document is received.

At 820, the document is filtered according to a first stage.

At 830, the document is filtered according to a second stage. Additional stages can be supported. A knock-out indication can prevent the second stage filtering from occurring.

At 840, the document is classified based on results of one or more of the stages.

### Example 10

### Exemplary Hardware Acceleration

In any of the examples herein, hardware acceleration can take the form of submitting a document to specialized hardware to achieve some or all of the context-sensitive filtering functionality. For example, a software/hardware cooperation arrangement can divide labor so that certain tasks (e.g., pattern matching) are performed in hardware that is specially designed to accommodate such tasks.

### Example 11

### Exemplary Specialized Hardware

In any of the examples herein, specialized hardware can take the form of hardware dedicated to specialized tasks, such as pattern matching, signature recognition, high-speed document processing, or the like.

Although any of a variety of hardware can be used, some examples herein make use of a NetLogic Microsystems® NLS220HAP platform card with NLS205 processors available from NetLogic Microsystems of Santa Clara, Calif. Other hardware products by NetLogic Microsystems or other manufactures can be used as appropriate.

### Example 12

### Exemplary Context-Sensitive Filters

In any of the examples herein, a context-sensitive filter can be implemented by a collection of filter rules. Context sensitivity can be achieved via locality conditions as described herein.

### Example 13

### Exemplary Rules

In any of the examples herein, filter rules can take a variety of forms. In one arrangement, concept rules and weighted rules are supported. Concept rules can be defined to identify concepts and used (e.g., reused) in other rule definitions that piece together the concepts to implement a filter.

Concept rules can be used to define words, phrases, or both. Such a rule can specify a plurality of conceptually-related words for later reuse. Other rules can incorporate such concept rules by reference. A concept rule can specify one or more other concept rules as words for the concept rule, thereby implementing nesting.

Weighted rules can indicate a weighting to be applied when the rule is satisfied. For example, a highly weighted rule can result in a higher score when the rule is met. Negative weightings can be supported to tend to knock out documents that have certain specified conditions.

A rule can be satisfied more than once, resulting in multiple applications of the weight. Other weighting techniques include constant weight, slope weight, step weight, and the like.

Nested rule definitions can be used with advantage to achieve robust, reusable rule sets without having to manually explicitly define complex rules for different domains.

### Example 14

### Exemplary Supplemental Definitions

In any of the examples herein, supplemental definitions can take the form of rules that are reused from a library of rules that may be of use to rule developers. For example, concept rules can be used as supplemental definitions. The supplemental definitions can be supplied in addition to the rules and processed together with the rules. For example, a simple rule in compact form may result (e.g., via preprocessing) in a large number of rules and associated patterns that are ultimately sent to the hardware.

### Example 15

### Exemplary Locality

In any of the examples herein, locality operations can support specifying a locality condition. Such a condition can take the form of “in the same x,” where x can be a document, paragraph, sentence, clause, or the like. Words specified must satisfy the specified condition (e.g., be present and be in the same x) to meet the locality condition.

### Example 16

### Exemplary Locality Syntax

In any of the examples herein, the syntax for specifying a rule having a locality condition can be specified via indicating the locality type, and words and/or concept rule references (e.g., enclosed in delimiters). The syntax can support having the locality type followed by the words and/or concept rule references.

For example, a possible syntax is,
locality type: (<words and/or concept rule references>)
   where location type specified a document, paragraph, sentence, clause, or the like.

For example, the locality type can be reduced to a single character (e.g., d, p, s, c, or the like), and the words and/or concept rule references can be specified in between parenthesis after the colon.

Concept rules can be indicated by a special character (e.g., “=”) next to (e.g., preceding) the concept rule name.

So, for example,
c: (horrible=weather)

specifies that the word “horrible” and any word defined by the concept rule “weather” must be in the same clause in order for the rule to be met.

### Example 17

### Exemplary Patterns

In any of the examples herein, patterns can take the form of a pattern that can be matched against text. Wildcard, any letter (e.g., 4), and other operators can be supported. Regular expressions can be supported to allow a wide variety of useful patterns.

Such patterns are sometimes called “word” or “word patterns” because they typically attempt to match against words in text and can be processed accordingly.

### Example 18

### Exemplary Hardware Pattern List

In any of the examples herein, the hardware pattern list can take the form of a list of patterns that are sent to the specialized hardware for identification in documents. In practice, the pattern list can be incorporated into a binary image that achieves processing that results in evaluation results that can be processed by software to determine whether conditions in the rules have been met.

### Example 19

### Exemplary Evaluation Results

In any of the examples herein, evaluation results can take the form of results provided by the specialized hardware to indicate evaluation performed by the hardware against a document. For example, the locations of patterns (e.g., extracted from filter rules) within a document can be indicated in the results.

### Example 20

### Exemplary Document

In any of the examples herein, a document can take any of a variety of forms, such as email messages, word processing documents, web pages, database entries, or the like. Because the technologies herein are directed primarily to text, such documents typically include textual components as part of their content.

### Example 21

### Exemplary Document Classification

In any of the examples herein, documents can be classified according to filtering. So, for example, outgoing email messages can be classified as permitted or not permitted. Any number of other classification schemes can be supported as described herein.

In some cases, it may be desirable to have a human reviewer process certain documents identified via filtering.

### Example 22

### Exemplary Rule Compilation

In any of the examples herein, filter rules can be complied to a form acceptable to the specialized hardware and usable by the coordinating software. Pre-processing can include expanding the rules (e.g., according to concept rules referenced by the rules).

### Example 23

### Exemplary Stages

In any of the examples herein, multiple stages can be used. For example, a first stage may determine whether a document has sufficient content in a particular human language (e.g., English). A subsequent stage can take documents that qualify (e.g., have sufficient English content) and perform context-sensitive filtering on them. A given stage may or may not use hardware acceleration and pattern matching.

Such an arrangement can use an earlier hardware-accelerated pattern matching stage to knock out documents that are inappropriate or unexpected by a subsequent stage.

### Example 24

### Exemplary Email Filter Implementation

In any of the examples herein, the technologies can be applied to implement an email filter. For example, incoming or outgoing email can be processed by the technologies to determine whether an email message is permitted or not permitted (e.g., in an outgoing scenario, whether the message contains sensitive or proprietary information that is not permitted to be exposed outside the organization).

### Example 25

### Exemplary Highlighting

After filtering is performed, a document can be displayed such that the display of the document depicts words in the document that satisfy the filter rules with distinguishing formatting (e.g., highlighting, bold, flashing, different font, different color, or the like).

### Example 26

### Exemplary Navigation within Document

Navigation between hits can be achieved via clicking on a satisfying word. For example, clicking the beginning of a word can navigate to a previous hit, and clicking on the end of a word can navigate to a next hit

### Example 27

### Exemplary Software Emulator

In any of the examples herein, a software emulator can be used in place of the specialized hardware. Such an arrangement can be made switchable via a configuration setting and can be useful for testing purposes.

### Example 28

### Exemplary Rule Compilation Implementation

The technologies described herein can use a variety of rule compilation techniques. User Target Rules can be implemented as filter rules representing concepts of interest to the user. They can use a syntax that allows reuse of synonym definition that supports hierarchical relationships of nested definitions. The rules contain references to locality (e.g., Entire Document, Paragraph, Sentence, and Clause). A line expresses a locality followed by a set of Unix regular expressions. The rules can be compiled to optimize data representation and also generate Hardware Patterns. The hardware patterns can be derived from the rules by identifying the unique regular expressions found in a rule set.

The rules can be compiled after any changes are made. Filtering of content uses a compiled and optimized Java class at run-time. The hardware pattern matching also compiles the regular expressions internally by compiling the patterns into an optimized representation supported by the hardware (e.g., NetLogic or the like) that is also used at run-time.

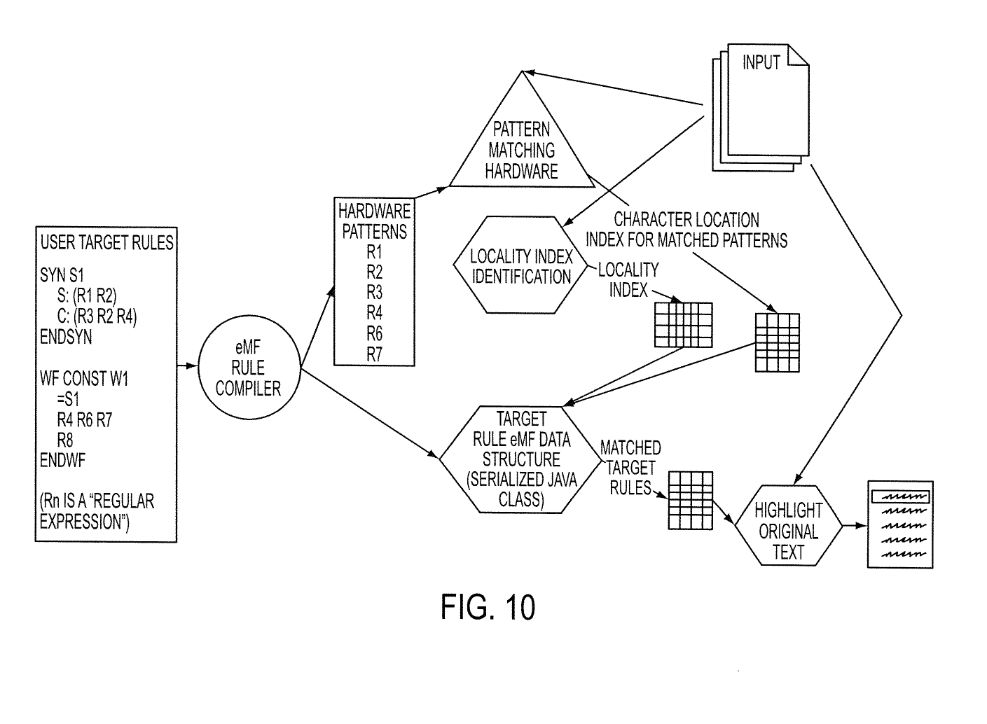

Input text is analyzed by pattern matching hardware to identify index locations of respective matching patterns in the original text. The locality index identifies the start and ending index of paragraphs, sentences and clauses in the original text. These two outputs are then combined to determine which target rules matched. Based on the number of matches for respective rules, the total input score is computed as illustrated in FIG. 10.

The matched rules can be used to distinctively depict (e.g., highlight) the matching concepts in the original text, using color coding to represent the weighted contribution of each matched patterns. Patterns that contribute to a rule with high weights are colored in a first color (such as red), and the ones with the smallest contribution are colored in a second color (such as green). Shades in between the first color and the second color are used to indicate amount of contribution to total score by a specific pattern. The distinctively depicted text can also be hyperlinked to allow hit to hit navigation.

### Original Text Highlight and Navigation

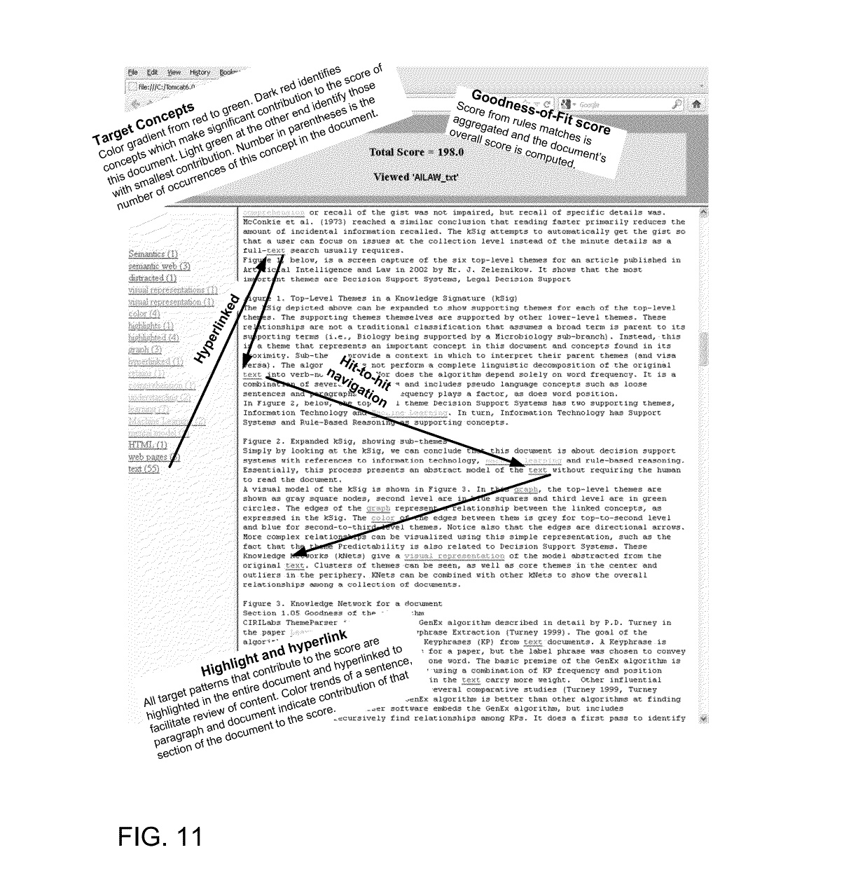

Matching patterns are highlighted and color coded based on the weight of the target rule that contains the pattern. Hit-to-hit navigation allows the user to go to the next instance of that pattern by clicking on the last part of the word. The user can go to the previous instance by clicking on the first part of the word. Also as depicted in FIG. 11, matched patterns can be distinctively depicted in the original text, thereby giving a user a quick view of the coloring (contribution of this section to the overall score).

### Example 29

### Exemplary Embodiment of the Technologies

Various features of the technologies can be implemented in a tool entitled “Indago,” various features of which are described herein.

### Example 30

### Exemplary Features

Indago's approach to deep-context data searches can address demands for the rapid and accurate analysis of content. Indago can provide in-line analysis of large volumes of electronically transmitted or stored textual content; it can rapidly and accurately search, identify, and categorize the content in documents or the specific content contained in large data streams or data repositories (e.g., any kind of digital content that contains text) and return meaningful responses with low false-positive and false-negative rates. Indago can perform automated annotation, hyperlinking, categorization, and scoring of documents, and its ability to apply advanced rule-syntax concept-matching language enables it, among other things, to identify and protect sensitive information in context.

### Example 31

### Exemplary Applications

Indago's capabilities meet the needs of many applications including, but not limited to:
Corporate
Litigation
Product marketing
Scientific research
Regulatory
Patent research
Law enforcement
Military/defense
Foreign policy

Such applications can benefit from rapid, accurate, context-sensitive search capabilities, as well as the potential to block the loss of sensitive information or intellectual property.

### Example 32

### Exemplary Benefits

Indago's benefits include, but are not limited to, the following:
Rapid search, identification, annotation
Accurate results
User-specified targets
Context-sensitive
Virtually unlimited number of documents searchable
Affordable solution
Energy-efficient system

### Example 33

### Exemplary Overview

Indago can search, identify, and categorize the content in documents or specific content in large data streams or data repositories and return meaningful and accurate responses.

### Example 34

### Exemplary Functionality

Indago's can perform context-sensitive analysis of large repositories of electronically stored or transmitted textual content.

As data generation and storage technologies have advanced, society itself has become increasingly reliant upon electronically generated and stored data. Digital content is proliferating faster than humans can consume it. Current search/filter technology is well suited for simple searches/matches (that is, using a single keyword), but a more powerful paradigm is called for complex searches.

Current products do not meet the need for the rapid and accurate context-sensitive analysis of content. Current approaches merely match patterns, but do not attempt to understand the content. Existing products become bogged down to the point of being ineffective; when there are more than a small number of search rules, they produce unacceptably high numbers of false positives, and filtering, or using only specific characteristics and discarding anything that does not match, may result in the loss of desired targets. The demand on user time is enormous.

Indago can address such issues via software algorithms, open-source search tools, and a unique, first-time use of off-the-shelf hardware to provide in-line analysis (that is, analysis of data within the flow of information) of large volumes of electronically transmitted or stored textual content. Indago can rapidly and accurately search, identify, and categorize the content in documents or the specific content contained in large data streams or data repositories and return meaningful responses with low false positive and false negative rates.

The algorithms contained in the Indago software can compute the relevance (or goodness-of-fit) of the text contained in an electronic document based on a predefined set of rules created by a subject matter expert. Indago can identify concepts in context, such that searching for an Apple computer does not return information on the fruit apple, and can effectively search and analyze any kind of digital content that contains text (e.g., email messages, HTML documents, corporate documents, and even database entries with free-form text). These software abilities can be implemented via a combination of Indago's software algorithms and the acceleration provided by this use of off-the-shelf hardware that greatly speeds the action of the software.

### Example 35

### Exemplary Operation

Indago can benefit from a unique synergy of two significant advancements: developed algorithms that compute concept matches in context combined with a unique, first-time use of off-the shelf hardware to achieve acceleration of the process. The innovative algorithms can implement the intelligent searching capability of the software and the integrated hardware, a NetLogic Hardware Acceleration Platform, reduces document-content processing time.

The rules used by the algorithms are easy to implement because they are modular and can be reused or combined in different ways, and are expressed as hierarchical concepts in context. The rules make it easy to encode the subject matter expert's interpretation of complex target concepts (e.g., the sought-after ideas). An example is sensitive corporate knowledge, such as proprietary information that may be inadvertently released to the public if not identified. The rules incorporate user-specified scoring criteria that are used to compute a goodness-of-fit score for each document. This score is used for filtering and identifying “relevant” documents with high accuracy. Rules can be weighted via four different types of weighting functions that are built into the algorithms and can therefore be used to filter and thus optimize precision and/or recall and identify duplicate documents. Indago's contextual analysis rules allow the creation of complex target models of concepts. These target models are used to build increasingly sophisticated rules that operate well beyond simple word occurrence, enabling Indago to make connections and discover patterns in large data collections.

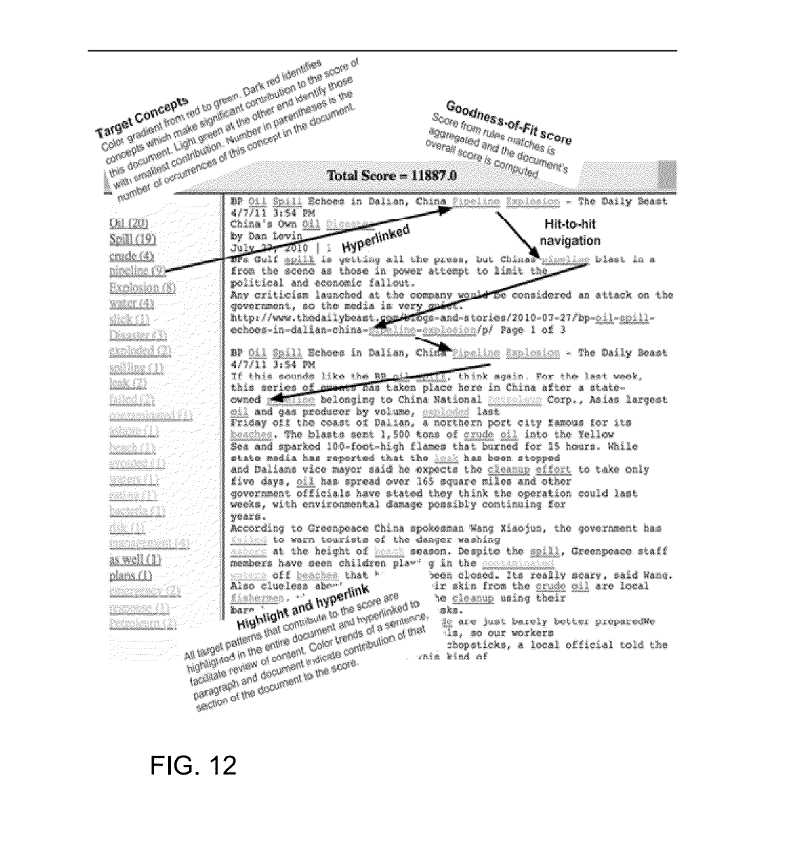

An end user of Indago will typically work with Indago's graphical user interface and determine the data repositories, emails, or other information to be searched. The user then receives the annotated results, which will have color-coded highlighted words and text blocks signifying the relative importance of the identified text. An example of Indago's annotated analysis result available to the end user, using a publicly available article (Dan Levin, “China's Own Oil Disaster,” The Daily Beast, Jul. 27, 2010) is shown in FIG. 12. The user can then use the hyperlinking feature to review the results.

A difference in the disclosed Indago from other approaches is the weighted identification of concepts-in-context. Most filters and search engines use either a simple word list or Boolean logic, a logical calculus of truth values using “and” and “or” operators, to express desired patterns. Simple word-occurrence searching techniques, in which a set of terms is used to search for relevant content, result in a high rate of false positives—often seriously impacting accuracy and usefulness. Current search/filter technology is suited for simple searches/matches (e.g., a Google search for “apple” will return information for both apple the fruit and Apple computers), but a more powerful paradigm—Indago—is required for complex searches, such as finding sensitive corporate knowledge that may be flowing in the intranet and could be accidentally or maliciously sent out via the Internet.

Although Boolean logic can express complex context relationships, it can be problematic—so that users of Boolean searches are forced to trade precision for recall and vice versa. A single over-hitting pattern can cause false positives; however, filtering out all documents containing that pattern in a bad context may eliminate documents that do have other targeted concepts in the desired context. If the query contains hundreds of terms, finding the one causing the rejection may require significant effort. For example, if searching for “word A” and “word B” anything that does not contain both these words will be rejected.

In contrast to the currently available approaches, Indago includes sophisticated weighting that can be applied to both simple target patterns and to multiple patterns co-occurring in the same clauses, sentences, paragraphs, or an entire document. The concepts-in-context approach of the software allows more precise definition, refinement, and augmentation of target patterns and therefore reduces false positives and false negatives. Search targets have their context within a document taken into account, so that meaning is associated with the responses returned by the software. The goodness-of-fit algorithm contained within the software allows a tight matching of the intended target patterns and also provides a mechanism for tuning rules, thereby reducing both false positives and false negatives. The goodness-of-fit algorithm uses a dataflow process that starts with the extraction of text from electronic documents. The extracted text is then either sent to hardware or software for basic pattern matching. Finally, the results of the matches are used to determine which target pattern rules were satisfied and what score to assign to a particular match. Scores for each satisfied rule are added to compute the overall document score.

Another difference from current approaches is that Indago uses off-the-shelf hardware in a unique way for implementation. This first-time hardware-assisted approach is lossless, highly scalable, and highly adaptable. Tests of Indago's hardware-accelerated prototype have shown a base performance increase of 10 to 100 times on pre-processing tasks.

### Example 36

### Exemplary Building Blocks

One possible Indago deployment is an email filter hardware capable of using a hardware-accelerated interface to a Netlogic NLS220HAP platform card. The NetLogic NLS220HAP Layer 7 Hardware Acceleration Platform can be leveraged to provide hardware acceleration for document-content processing. This card is designed to provide content processing and intensive signature recognition functionality for next-generation enterprise and carrier-class networks. This performance far exceeds the capability of current-generation multicore processors while consuming substantially less energy. Further, multiple documents may be processed in parallel against rule databases consisting of hundreds of thousands of complex patterns. Although one embodiment of the technology is designed and for the data communications industry, the deep-packet processing technology can be applied to the field of digital knowledge discovery as described herein.

Two open-source software tools which can be used within the Indago software are the following:
Apache Foundation Tika—The Tika software module allows the extraction of text from most electronic documents, including archives such as .zip and .tar files. Because Tika is an open-source framework, many developers are using it to create data parsers for performing syntactic analysis. Indago does not rely on the file extension to determine content—rather, it reads the data stream to make that determination and calls the appropriate parser to extract text. Most common formats are supported, including MS Office file formats, PDF, HTML, variants of zip compression, and others. The framework is extensible, allowing new formats to be incorporated and used within the framework.
Porter word stemmer—The Porter word stemmer allows the identification of word roots, which can then be used to find word families so that all of the variations of a word can be matched as needed instead of having to specify each variation.
   Additionally, the open Source CLAM AV can be used for email filtering but is not required for batch processing. The CLAM AV application programming interface (API) is the basis for the virus/spam filter interface, and is coupled to the Zimbra Collaboration Suite (ZCS), which is one of many web-based office productivity suites. However, the use of the API allows integration to other mail server software besides ZCS. The API creates a daemon service that waits for email messages to be scored, then action to reroute can be taken. Rerouted documents are highlighted for matching content in order to facilitate adjudication.

The current email exfiltration implementation also has a command-line interface for batch processing. The current design does not preclude the hardware integration of additional functionality, including rules processing, which will in significant speed-up and unlock additional capability in a fully integrated system.

### Example 37

### Exemplary Additional Features

Indago includes a number of features which provide improvements related to, but not limited to, accuracy, cost, speed, energy consumption, rule-set flexibility, and performance.

### Accuracy of Matches.

While improvement can also be estimated in terms of cost, speed, or energy consumption, for this problem space, a primary improvement Indago offers is best understood in terms of accuracy of matches.

Number of Returns.

A Google search with thousands of results is not useful if the most-relevant document doesn't appear until the 10^{th} page of results; few if any have the patience to scan through many pages of false positives.

False Positives.

Simple search implementations often return many hits with the significant drawback of a high false positive rate, that is, many marginally related or unrelated results that are not useful or are out of context. For instance, the term “Apple” might return results related to both fruit and computers. Indago's low false positive and on-target matching returns only the highly relevant content.

False Negatives.

Similarly, a very fast Boolean search is not useful if relevant documents are missed by the use of a “NOT” clause. Indago's concepts-in-context capability allows searching for very general terms that would otherwise be eliminated because of the high rate of false positives. For example, in the legal field missed documents, which are “false negatives,” may contain key evidence. Indago is focused on finding relevant information with a minimum number of false positives and false negatives.

Speed.

Software solutions become bogged down to the point of being ineffective when there are more than a small number of search rules. Indago's use of hardware acceleration cuts the processing time by a third, and future releases may push additional operations to the hardware for even greater speed-up and added capability.

### Example

Recent accuracy tests of the software-only rules implementation used a large body of roughly 450,000 publicly available email messages from the mailboxes of 150 users. The messages and attachments totaled some 1.7 million files. Subject matter experts reviewed a subset of over 12,000 messages under fictitious litigation criteria to identify a set of responsive and non-responsive documents. Tested against their results, Indago demonstrated a successful retrieval rate of responsive documents of 80%.

### Green, High-Performance, and Cost-Effective Solution.

Indago is an efficient hardware-accelerated approach designed to enable the inspection of every bit of data contained within a document at rates of up to 20 Gbps, far exceeding the capability of current generation multi-core processors, while consuming substantially less energy. Indago is an in-line content analysis service as compared to implementations that require batch processing and large computer clusters with high-end machines. Indago's current hardware acceleration is based upon Netlogic technology. Netlogic technical specifications quote power consumption at approximately 1 Watt per 1 Gbps of processing speed; at the full rate of 20 Gbps of contextual processing, estimated power consumption would be 20 Watts, which is at least ten times better than the power consumption of a single computer node. Comparison to a cluster of computer nodes, as some competing approaches require, is far more impressive. Further, the anticipated cost is less than competing options, while performance is greater.

### Rule-Set Flexibility.

The degree of flexibility afforded by Indago is not possible with Boolean-only query methods. Indago provides a variety of weighting functions in its grammar definition. Additionally, Indago provides the option of negative weighting to accommodate undesirable contexts. Finally, the query rules are modular and thus easier to maintain than Boolean queries.

### Consistent Performance.

The amount of digital content that must be analyzed to solve real-world problems continues to grow exponentially. Humans are excellent at quickly grasping the general concept of a document, but person-to-person variability can be significant and variation of performance for a single individual can vary greatly depending on competing demands for attention. Teams of people simply cannot consistently analyze very large collections of documents. Indago, on the other hand, excels at performing these repetitive tasks quickly and consistently.

### Enhanced Effectiveness.

Indago can consistently analyze large collections of unstructured text such that the post-processed output contains scoring and annotation information that focuses analyst attention on the precise documents, and words within those documents, that are most likely to be of interest. By offloading the repetitive tasks associated with the systematic baseline analysis of a large body of documents, humans can do what they do best. Indago's contextual analysis includes color-coded triage to pinpoint attention on high-interest text matches with single-click navigation to each specific textual instance. The efficiency and effectiveness of the subsequent analyst review is enhanced, allowing more time to interpret meaning and trends. In addition, Indago's scoring mechanism allows the added flexibility of tweaking the balance between precision and recall, if desired.

### Example 38

### Exemplary Applications

Analysis, sorting, manipulation, and protection of data are required across a diverse set of industries and applications. Digital data is pervasive and the need to analyze textual information exists everywhere. Indago is particularly powerful because its ability to support a hardware-assisted, concept-in-context approach allows domain-optimized algorithm adaptation.

Today's data deluge crosses scientific and business domains and political boundaries. While of great use to many fields, Indago may be particularly useful in foreign policy as it can search out information on specific topics of interest worldwide, thus bringing attention to potential threats or geographical areas that should be monitored for significant events.

### Protection of Corporate Intellectual Property or Sensitive Information.

“Exfiltration” is a military term meaning the removal of assets from within enemy territory by covert means. It has found a modern usage in computing, meaning the illicit extraction of data from a system. Indago protects sensitive information as follows:

Email Exfiltration.
Indago can be used to search transmitted data streams to identify sensitive information in context and, based on that identification, take action to prohibit or allow the transmittal of digital content. Indago can include an electronic mail filter with advantages over current approaches because the state of the art is limited by word list matches and does not include a concepts-in-context search capability. While current technology is very fast, it can be easily defeated by a knowledgeable individual and can miss target material. For example, many email filters depend on the extension of the file name to filter potential harmful content. The filter looks for “.exe” files. However, a real “.exe” could be renamed and still be harmful.

Exfiltration, General.
Indago can also be used to search data repositories to identify sensitive information and, based upon that identification, the information can be flagged for additional protection or action can be taken to prohibit or allow access.
   As viruses pose a threat so does the disclosure of corporate intellectual property. Indago can be used to monitor all forms of internet traffic and flag suspected sources and/or individuals.
   An insider threat (i.e., someone who is looking for sensitive corporate knowledge but should not have access to it) is a significant concern. Intra-web sites contain vast amounts of corporate knowledge that may not be properly protected. Indago can facilitate the monitoring of such data flow.

### Fast and Accurate Large Repository Search.

Indago allows more complex searches that retrieve relevant content by focusing on the context. For example, the word “Apple” for a non-computer person usually refers to a fruit, but for most computer people it can be either the fruit or the computer company. The use of the rule set and hierarchical concept-in-context matching enables more precise matching for the target interpretation.

Anyone who needs the accurate search and analysis of digital content, and particularly the search of large data streams or large data repositories, is a potential beneficiary of Indago's context-based capability. These needs include, but are not limited to, the following:

Legal Discovery.
Indago can be used in the legal field for the accurate and efficient retrieval of corporate documents as they relate to litigation cases. Current approaches use a broad search and then typically employ humans in a time-consuming process to manually pare down the returned documents in order to categorize each document as responsive (e.g., containing relevant information to the case) or unresponsive. In addition to providing a more-relevant set of documents to begin with, Indago's summarization, annotation, and hyperlinking make the review of those documents more efficient.

Data Mining.
Indago can be used for data mining of corporate repositories. Data mining is time consuming because these repositories can be very large and are growing exponentially. Indago's flexible grammar scales easily, allowing millions of discrete patterns to be meaningfully clustered for subsequent analysis.

Product Marketing.
Indago can be used in the following areas:
   Search and classification
   Document and language analysis
   Market research and business strategy
   Plagiarism detection
   Detection of unauthorized release or duplication of product information
Scientific Research.
   Search and classification—Indago can be used as a complex concept search tool
   Literature searches—Indago can be used to annotate search results based on the specific needs of the researcher

Patent Research.
Indago can be used to search through existing patents and return accurate, pertinent information.

Public Sector
Law enforcement—Indago can be used for the routine monitoring of news stories for threat indicators
Military/defense—Indago can be used as a “War Room” analysis tool to monitor open-source news for indications of emerging problems
Regulatory bodies—Indago can analyze large and complex sets of regulations to find gaps and overlaps

### Example 39

### Exemplary Additional Overview

As technology has continued to advance, modern society has become increasingly reliant upon electronically generated and stored data and information. Digital content is proliferating faster than humans can consume it, and digital archives are growing everywhere, both in number and in size. Correspondingly, the need to process, analyze, sort, and manipulate data has grown tremendously. Applications that alleviate the processing burden and allow users to access and manipulate data faster and to more effectively cross the data-to-knowledge threshold are in demand, particularly if they enable informed, actionable decision-making.

Indago can address this need. Indago can implement a context-based data-to-knowledge tool that provides a powerful paradigm for rapidly, accurately, and meaningfully searching, identifying, and categorizing textual content. Context-based search and analysis creates new and transformative possibilities for the exploration of data and the phenomena the data represent. Indago can reduce the data deluge and give users the power to access and fully exploit the data-to-knowledge potential that is inherent—but latent—in nearly every data collection. End-users and human analysts are thus more efficient and effective in their efforts to find, understand, and synthesize the critical information they need.

Indago can be implemented as a cost-effective solution that provides unparalleled performance and capability, and that leverages proven, commercial off-the-shelf technology. It can enable a broad and diverse set of users (e.g., IT personnel, law firms, scientists, etc.) to engage their data faster, more accurately, and more effectively, thus allowing them to solve problems faster, more creatively, and more productively. Furthermore, Indago can be domain-adaptable, power-efficient, and fully scalable in terms of rule-set size and complexity.

Indago can monitor in-line communications and data exchanges and search large repositories for more complex patterns than possible with today's technologies. Furthermore, current technology is prohibitive to use because of the high false-positive rates.

Indago can present a unique, outside-the-box innovation in terms of how it can exploit deep-packet-processing technology, its adaptability and breadth of applicability, and its unparalleled performance potential.

### Example 40

### Exemplary Additional Information

As data generation and storage technologies have advanced, society itself has become increasingly reliant upon electronically generated and stored data. Digital content is proliferating faster than humans can consume it. Proliferation of electronic content benefits from automated tools to analyze large volumes of unstructured text. Network traffic as well as large corporate repositories can be scanned for content of interest, either to stop the flow of unwanted information such as corporate secrets or to identify relevant documents for an area of interest.

Network filters rely mostly on simple word list matches to identify “interesting” content, and searches rely on Boolean logic queries. Both approaches have their advantages and limitations. A keyword list is simple and can be implemented easily. Boolean logic with word proximity operators allows finer definition of target pattern of interest. However, both may retrieve too many false positives. A document may contain the right words, but not in the right context. For example, a web search for apple brings both references to the computer company and the fruit. Disclosed herein is an approach that searches for concepts-in-context with reduced number of false positives. Furthermore, by the use of commercial off the shelf hardware

The process can be accelerated significantly so that the analysis can be done in near real time. Context-based search and analysis can greatly enhance the exploration of data and phenomena by essentially reducing the data deluge and increasing the efficiency and effectiveness of the human analyst and/or end-user to access and fully exploit the data-to-knowledge potential that is inherent but latent in nearly every collection.

The rules allow synonym definition, reuse, nesting, and negative weight to balance precision and recall.

The rules can be an encapsulation of the target knowledge of interest.

The rules can be shown as a graph that depicts the concepts and their relationships, which can serve as a map of the target knowledge.

A scoring algorithm can use rules and weights to determine which parts of the map are matched by a particular document and computer a goodness of fit score for an entire document.

### Example 41

### Exemplary Boolean Query Comparison

### Boolean Query Example:

(bad OR horrible OR huge OR humongous OR monstrous) AND (weather OR rain* OR sleet OR storm* OR hail OR snow* OR tornado* OR hurricane* OR typhoon*) NOT (“Miami Hurricanes” OR “Snow White”)

Comparable rules for Huge, Weather, HorribleWeather, BadWeather, etc., translate to 31 simple queries.

$$= Huge is ( 3 ) , \\ = Weather is ( 7 ) , \\ = Horrible Weather is ( 1 \times 7 + 3 \times 1 + 3 = 13 ) , \\ = Bad Weather is ( 1 \times 7 + 13 + 1 = 21 ) , \\ Negative is ( 2 ) . Total weighted rule number is ( 8 + 21 + 2 ) = 31$$

A more complex example related to “oil disaster preparation” translates to −2.5M simple queries used to score and annotate incoming documents.

### Example 42

### Exemplary Further Overview

Indago can be implemented as a context-based data-to-knowledge tool that rapidly searches, identifies, and categorizes documents, or specific content contained in large data streams or data repositories, and returns meaningful and accurate responses.

### Example 43

### Exemplary Further Description

Indago can be implemented as a high-performance, low-power, green solution, and an inline service as compared to implementations that require large computer clusters with high-end machines. Some characteristics can include:
Deep contextual knowledge identification on document repositories and network traffic

Advanced rule syntax concept matching language
Execution of the equivalent of millions of Boolean queries
Automated annotation, hyperlinking, categorization, and scoring of documents
High-accuracy matches with low false negatives
Cost-effective, energy-efficient, single-PC solution
Hardware-accelerated and scalable

The ability to identify concepts-in-context has significant advantages over current approaches.

Indago computes the relevance (or goodness-of-fit) of the text contained in an electronic document based on a predefined set of rules created by a subject matter expert. This approach permits user-defined, domain-optimized content to be translated into a set of rules for fast contextual analysis of complex documents.

Indago can include hundreds of rules that contain “context” references and may be weighted to give a more accurate goodness-of-fit to the target pattern of interest. The goodness-of-fit algorithm allows a tight matching of the intended target patterns and also provides a mechanism for tuning rules. In addition, the concepts-in-context approach allows more precise definition, refinement, and augmentation of target patterns and therefore reduces false positives and false negatives.

Due to the concurrency offered by the specialized hardware (e.g., Netlogic NLS220HAP platform card), Indago can process multiple documents in parallel against rule databases consisting of hundreds of thousands of complex patterns for fast throughput. The matched pattern indices are used to determine context and identify the rules matched. The scoring function then computes the contribution of each match to generate a complete document score for the goodness-of-fit. The results of these matches are then evaluated to construct matches in context in software.

### Example 44

### Exemplary Hardware

The initial Indago deployment is an email filter capable of using a hardware-accelerated interface to a Netlogic NLS220HAP platform card. Indago leverages the NetLogic NLS220HAP Layer 7 Hardware Acceleration Platform to provide hardware acceleration for document-content processing. This card is designed to provide content-processing and intensive signature-recognition functionality for next-generation enterprise and carrier-class data communications networks. The NLS220HAP is a small-form-factor, PCIe-attached accelerator card, which can be integrated into commercial off-the-shelf (COTS) workstation-class machines. The Netlogic card contains five Netlogic NLS205 single-chip knowledge-based processors.

Each NLS205 processor has the ability to concurrently support rule databases consisting of hundreds of thousands of complex signatures. The unique design and capability of these processors enable the inspection of every bit of data traffic being transferred—at rates up to 20 Gbps—by accelerating the compute-intensive content-inspection and signature-recognition tasks. This performance far exceeds the capability of current generation multicore processors while consuming substantially less energy. While this technology is designed for the data communications industry, deep-packet processing technology can be applied to the field of digital knowledge discovery.

Indago has demonstrated a hardware accelerated base performance increase of one to two orders of magnitude on pre-processing tasks over a software-only implementation.

### Example 45

### Exemplary Technical Supporting Information

Exemplary technical supporting information for Indago is described below.

### Hardware Information.

Indago eMail Filter-Hardware Acceleration Interface (eMF-HAI), provides a software interface to the NetLogic NLS220HAP Hardware Acceleration Platform card. This interface allows for the seamless integration of the NLS220HAP card into the larger eMF-HAI application. The software leverages the NetLogic NETL7 knowledge-based processor Software Development Kit (SDK).

The SDK has been used to develop C/C++ based codes that enable the following on the NLS220HAP card: Binary databases generated from application-specific rule sets specified using Perl Compatible Regular Expressions; configuration, initialization, termination, search control, search data, and the setting of device parameters; document processing at extreme rates; and transparent interface between Java-based code and C/C++.

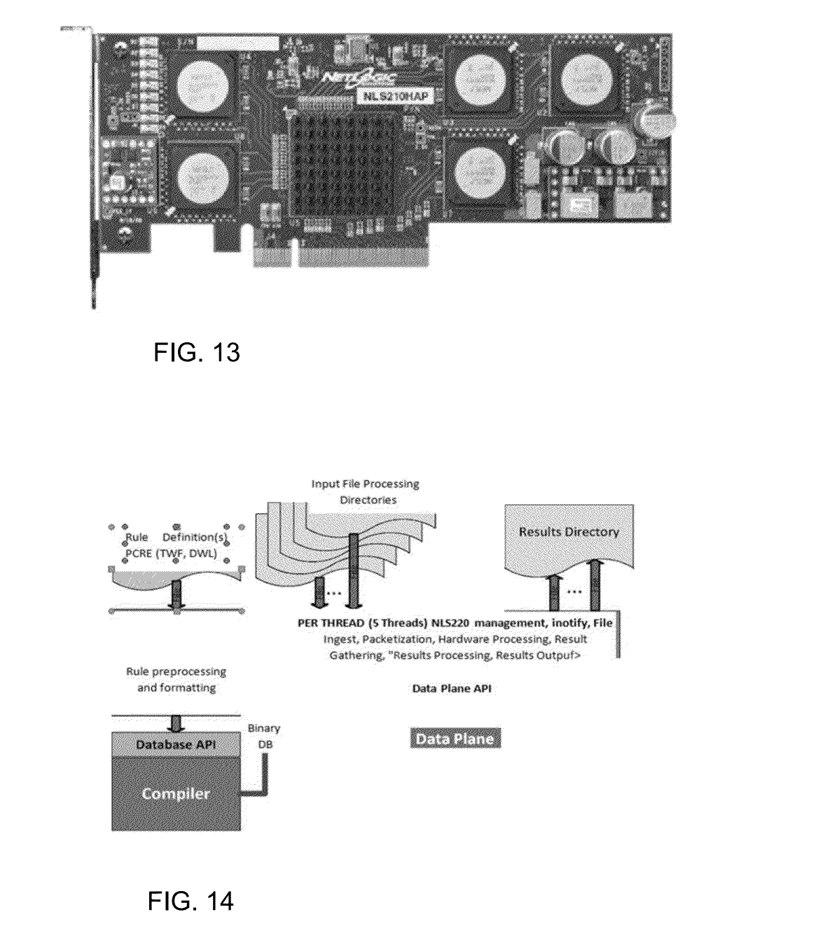

A NetLogic NLS220HAP Layer 7 Hardware Acceleration Platform (HAP) card (see FIG. 13) is used, which is designed to provide content-processing and intensive-signature recognition functionality for next-generation enterprise and carrier-class networks. The NLS220HAP card is a PCIe-attached accelerator card that uses five NetLogic NLS205 single-chip, knowledge-based processors. The unique design and capability of these processors enable the inspection of every bit of data traffic being transferred at rates up to 20 Gbps by accelerating the compute-intensive content-inspection and signature-recognition tasks. The NLS205 knowledge-based processor implements NetLogic's Intelligent Finite Automata (IFA) architecture, which provides built-in capabilities to perform deep-packet inspection (DPI) for security and application-aware systems. It utilizes a multi-threaded hybrid of multiple advanced finite automata algorithms. The IFA architecture provides low power-consumption and memory requirements while providing high performance. The NLS205 processor is designed to perform content inspection across packet boundaries. It has the ability to concurrently support hundreds of thousands of complex signatures. The architecture allows the processor to execute both Perl-Compatible Regular Expressing (PCRE) and string-based recognition. Both anchored and unanchored recognition are implemented with arbitrary length signatures. Rule updating can be done on the fly with zero downtime.

The NLS220HAP card is supported by a full-featured Software Development Kit (SDK). It is supplied as source code and presents Application Programming Interfaces (API) that provide runtime interfaces to the NLS220HAP card. The SDK includes a database/compiler API and a data plane API. The database/compiler API enables the compilation of databases expressed in either PCRE or raw format. The compiler takes all the pattern groups expressed in PCRE and produces a single binary image for the specific target platform (in our case the NLS220HAP card). The data plane API provides a runtime interface to the NLS220HAP card. It provides interfaces and data structures for configuration, initialization, termination, search control, search data, and the setting of device parameters.

FIG. 14 provides an overview of an exemplary eMF-HAI structure. Both database and data plane APIs are shown along with the underlying software supplied by NetLogic with the SDK. Above the APIs, the inventors developed processing for the eMF-HAI, which leverages the SDK, is depicted. The database of rules for the eMF-HAI is broken into several groups consisting of multiple rules expressed using PCRE syntax. Currently two groups are defined: the Top IK Word Families (TWF) group, and the Dirty Word List (DWL) group.

The TWF group is based upon the one thousand most frequent word families developed by Paul Nation at the School of Linguistics and Applied Language Studies at Victoria University of Wellington, New Zealand. The list contains 1,000 word families that were selected according to their frequency of use in academic texts. This list is more sophisticated than the lists created with the Brown corpus, as it contains not only the actual high frequency words themselves but also derivative words which may, in fact, not be used so frequently. With the inclusion of the derived words the total number of words in the list is over 4,100 words.

The DWL group is a domain-specific set of rules defined using PCRE. It can vary in size depending upon the application. The DWL can be defined as individual words of interest, or more complex rules can be defined using PCRE. For the eMF-HAI, code was created (CreateRules.cpp) that combines the two rule-group files, TWF and DWL, into a single, properly formatted, input file suitable for compilation using the NetLogic compiler for the NLS220HAP card. The output file generated by the compiler is a binary image file containing the rule database for the application. This functionality has been subsumed by the higher level DWL rule generation software and should no longer be needed. It is included here for historical and reference purposes. For eMF-HAI, the dataplane API was used to construct the main code for use with the NLS220HAP card. This code accomplishes two functions that are leveraged in the larger document-processing application: (1) the determination whether the document contains enough readable English text to warrant further processing, and (2) the identification and reporting of matching rules, defined in the DWL, within the document. Both functions are accomplished concurrently in a single pass of the document through the hardware.

For the first function, the length of matches (in bytes) reported by the hardware in the TWF group are counted. The code understands and corrects for multiple overlapping matches, selecting and counting only the longest match and ignoring any other co-located matches. Once the document has been passed through the interface and the matched bytes have been counted, the code calculates the ratio of matched bytes to the total number of bytes in the document.

For the second function the hardware reports back all matches found in the DWL group. For each rule, a count of matches is maintained along with a linked list of elements consisting of the index into the file where the match occurred and the length of the match. Two other counts are maintained per document for the DWL: (1) the number of unique rules that are triggered, and (2) the total rules matched.

Since the majority of the document processing in the eMF is written in Java, the C/C++ code produced for the eMF-HAI includes a reasonably simple way of interfacing. A purely file-based interface and leverage inotify was utilized. Inotify is a Linux kernel subsystem that extends file systems to notice changes to their internal structure and report those changes to applications. The inotify C++ (inotify-cxx.cpp) implementation was used, which provides a C++ interface. POSIX Threads (Pthreads) are used to map five instances of the eMF-HAI code to the five NLS205 processors available on the NLS220HAP card.

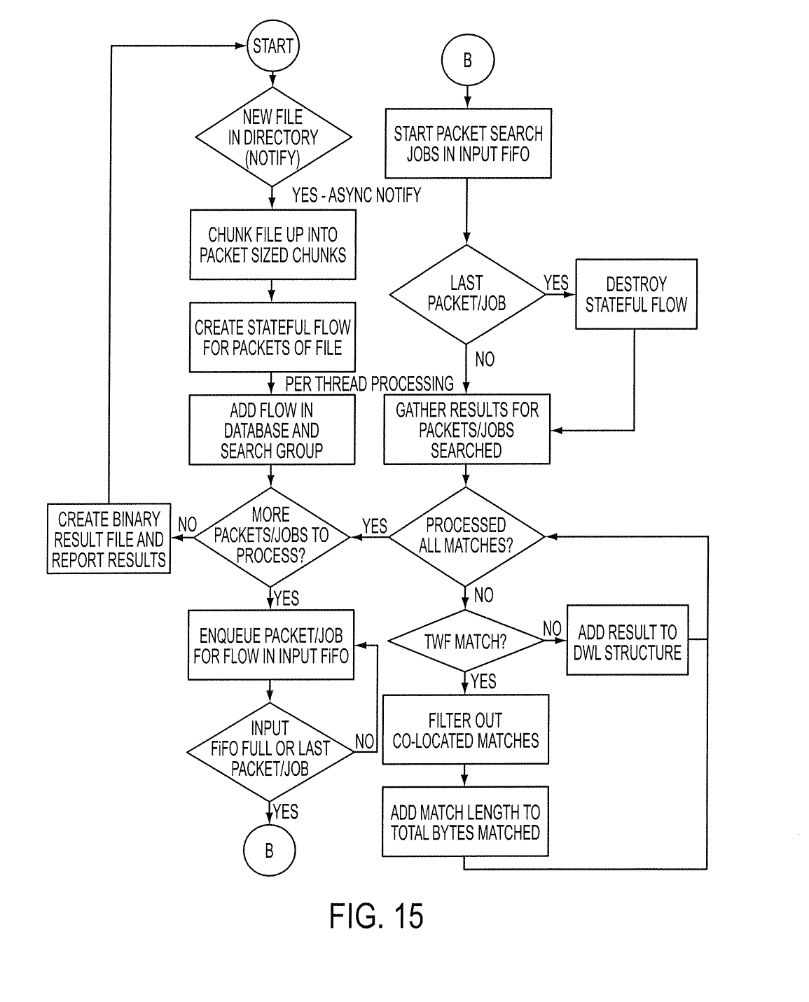

In FIG. 15, a flowchart is provided outlining the per-thread processing that is executed for each device. Each instance is assigned to a specific input directory and uses inotify to inform the thread when a new input file has been deposited for processing. The instance will then process the file independently and in parallel with the four remaining instances. Per file results are written in binary format into the results directory. Load balancing is implemented within the front end of the document processing pipeline across the five instances.

The overall eMF was written to provide a software emulation of the eMF-HAI to help with development. The selection of using the hardware or software is accomplished by simply modifying a configuration variable before running the eMF application.

### Example 46

### Exemplary Use of Hardware

The use of the hardware over an all-software solution can reduce processing time for the whole process by a third because it improves the pattern-matching step by six orders of magnitude over the existing software implementation. Software-only approaches are typically limited to on-the-order of thousands of implementable rules before severe performance limitations begin to arise. As rule-set size increases, performance decreases due to effects such as memory caching and thrashing. Indago's hardware-accelerated implementation is effectively unlimited. It can be co-designed for fully optimal performance based upon domain and complexity requirements (up to hundreds of thousands of rules, if required) without reaching hardware-imposed limitations.

### Example 47

### Exemplary Further Description

The approach taken has various possible advantages at least some of which are the following. First is the use of the hardware to accelerate basic pattern matching, and second is the nested word matching in context performed. The hardware was designed to match simple patterns, but nothing precludes its usage with more complex patterns. This is the first step in the filtering process. The matches are then taken into a hierarchical set of rules that estimate goodness of fit towards a target pattern of interest.

The hardware acceleration reduces clock time by five orders of magnitude for that part of the process, making the technology usable in near-real-time applications. The matching in context portion significantly reduces the number of false positives and false negatives. A disadvantage of simple word list matches is the fact that it may generate to many results that may not be relevant. The context rules are used defined and therefore can be used in any domain.

General email filtering can benefit from this approach as commercial organizations can not monitor intellectual property that may be divulged accidentally in out-flowing emails. Data mining for law firms can also benefit as the relevant document set for a litigation may be large. The rules can be customized to represent the responsive set of target patterns that would be used to search document that maybe relevant. This task is typically done by interns today.

The filter software computes the goodness of fit of a given text to a user defined set of target patterns. The target patterns are composed of rules which specify concepts in context. The rules can be nested and have no limit. The rules are user specified and therefore are an input to the filter. The rules are transformed internally for pattern matching and a version of these are sent to the hardware. The hardware returns initial pattern matches which are then combined to provide context. The original text is then scored using criteria specified for each rule. The filter uses a standard “spam/virus” filter interface as well as a command line interface for testing or batch uses. The filter can intercept and reroute suspected messages for review, such as for human review.

The current end user interface is invoked using the Zimbra Collaboration Suite (ZCS). Suspected messages are rerouted to a special email account for adjudication. ZCS uses a web interface which includes an email client. All sent messages filtered for suspected content. The rules and configuration parameters drive the process, therefore it should be applicable to any domain and easily changed for a different setting. Early testing was done using the open-source Apache JAMES project.

### Example 48

### Exemplary Implementations

The technologies described herein can be implemented in a variety of ways.

Proliferation of electronic content requires automated tools to analyze large volumes of unstructured text. Network traffic as well as large corporate repositories can be scanned for content of interest; either to stop the flow of unwanted information such as corporate secrets or to identify documents relevant to an area of interest. Network filters rely mostly on simple word list matches to identify “interesting” content and manual searches typically rely on Boolean logic queries. Both approaches have their advantages and limitations. Word-list-based filters are simple to implement. Boolean logic with word proximity operators allows a finer definition of the patterns of interest. However, both often retrieve too many false positives. A document may contain the right words, but not in the right context. For example, a web search for apple brings both references to the computer company and the fruit. In this paper we will document an approach that we have developed that searches for concepts-in-context with reduced number of false positives. Furthermore, by the use of commercial-off-the-shelf hardware, we have accelerated the process significantly so that data feeds can be processed in-line.

As technology has continued to advance, modern society has become increasingly reliant upon electronically generated and stored data and information. Digital archives are growing everywhere both in number and in size. Correspondingly, the need to process, analyze, sort, and manipulate data has also grown tremendously. Researchers have estimated that by the year 2000, digital media accounted for just 25 percent of all information in the world. After that, the prevalence of digital media began to skyrocket, and in 2002, digital data storage surpassed non-digital for the first time. By 2007, 94 percent of all information on the planet was in digital form. The task of processing data can be complex, expensive, and time-consuming. Applications that alleviate the processing burden and allow users to access and manipulate data faster and more effectively to cross the data-to-knowledge threshold, particularly for large data streams or digital repositories, to enable informed actionable decision-making are in demand.

A real life test set is publicly available in the form of ENRON email messages. The set has some 0.5 million email messages that contain data from about 150 users. The messages and attachments total some 1.7 million files. Consistent analysis of this set by humans is impossible to achieve. Many of the analysis aspects are subjective, human experiences and biases become a significant factor that becomes an inconsistency issue. This problem nullifies the ability to analyze a large set of documents with a divide and conquer approach. In contrast, computer based tools may consistently analyze large collections of unstructured text contained in documents. These tools can generate consistent results. The result of the analysis can then be used by humans to interpret the meaning of the changes such as trends. Various questions such as the following can be addressed: why a sender no longer discusses information on a certain topic; why a different topic used; why a sender uses a new topic area; is this a evolution of previous discussions; is it a new problem or a new perspective on a problem; why was the topic area found to be a dead end. These questions are likely best answered by a human and the technology can support such decisions by doing the repetitive preparation task and systematically analyzing a large corpus of documents to expose the patterns for human consumption.

### Approach

A filter can be used in line to monitor near real time information flow. A hardware accelerated concepts-in-context filter called “Indago” described herein is one that can be used.

Indago can perform contextual analysis of large repositories of electronically stored or transmitted textual content. The most common and simplest form of analyzing a large repository uses simple word-occurrence searching techniques in which a set of terms is used to search for relevant content. Simple word list search results have a high rate of false positives, thus impacting accuracy and usefulness. Indago's contextual analysis allows creation of complex models of language contained in unstructured text to build increasingly sophisticated tools that move beyond word occurrence to make connections and discover patterns found in large collections.

Indago computes the relevance (or goodness-of-fit) of the text contained in an electronic document based on a predefined set of rules created by a subject matter expert. These rules are modular and are expressed as hierarchical concepts-in-context. The rules can be nested and are complex in nature to encode the subject matter expert's interpretation of a target concept, such as sensitive corporate knowledge. The rules have a user specified scoring criteria that is used to compute a goodness-of-fit score for each individual document. This score can be used for filtering or for matching relevant documents with high accuracy. Rules can be weighted via four different types of weighting functions and thus can be used to optimize precision and recall. The process can also be used to identify duplicate documents as they would generate identical matches.

Software-only approaches are typically limited to on the order of hundreds of implementable rules before severe performance limitations begin to arise. Researchers have documented that simple phrase searching dramatically increased search performance time. As rule set size increases, performance decreases due to effects such as memory caching and thrashing. Indago's hardware-accelerated implementation is effectively unlimited. It can be co-designed for fully optimal performance based upon domain and complexity requirements (up to hundreds of thousands of rules, if required), without reaching hardware-imposed limitations.

Indago rule sets can be adapted to the application space. User-defined, domain-optimized content is translated into a set of rules for fast contextual analysis of complex documents. Simple search and filtering applications use a “one rule only” approach (typically a single Boolean rule or list of keywords). While the rule is user specified, the processing is done one at a time. In contrast, Indago can include hundreds of rules that contain “context” references and may be weighted to give a more accurate goodness-of-fit to the target pattern of interest.

Indago can employ rule-set flexibility that is not possible with Boolean-only query methods. Indago provides a variety of weighting functions in its grammar definition. In addition, Indago provides the option of negative weighting to accommodate undesired contexts. Finally, the query rules are modular and thus easier to maintain than long Boolean queries.

Indago enhances analyst-in-the-loop and/or end user effectiveness. Indago can analyze large collections of unstructured text with the end result that focus analyst's attention on precisely the documents, and words within those documents, that are most likely of interest. By offloading the repetitive tasks associated with the systematic base-line analysis of a large corpus of documents, the efficiency and effectiveness of the subsequent analyst review is enhanced, allowing more time to interpret meaning and trends. In addition, Indago's scoring mechanism allows the added flexibility of tweaking the balance between precision and recall, if desired by the use of the weighting functions.

### Hardware Acceleration

Indago uses a combination of software and hardware to achieve near-real-time analysis of large volumes of text. The currently deployed implementation is used as a context filter for an email server. However, the technology has broad applicability, as the need for fast and accurate search, analysis, and/or monitoring of digital information transcends industry boundaries.

A difference from current approaches is that Indago can provide a unique, hardware-assisted, lossless, highly scalable and highly adaptable solution that exploits commercial off-the-shelf (COTS) hardware end-to-end. Tests of Indago's hardware-accelerated implementation have shown a base performance increase of 1 to 2 orders of magnitude on pre-processing tasks compared to the existing, unoptimized software and cut the overall processing time by a third. Acceleration of additional functionality, including rules processing, will result in significant speed-up and unlock additional capability in a fully integrated system. The initial implementation is an email filter hardware acceleration interface (eMF-HAI) to a Netlogic NLS220HAP platform card. This card is designed to provide content processing and intensive signature recognition functionality for next-generation enterprise and carrier-class data communications networks. The unique design and capability of the five Netlogic NLS205 single-chip knowledge-based processors enable the inspection of data traffic being transferred at rates up to 20 Gbps by accelerating the compute intensive content inspection and signature recognition tasks. While this technology is designed for and the data communications industry, deep-packet processing technology can be applied to the field of digital knowledge discovery. This card is designed to provide content processing and intensive signature recognition functionality for next-generation enterprise and carrier-class networks.

The NLS220HAP is a small form factor, PCI-e attached, accelerator card that can be integrated into commercial off-the-shelf workstation class machines. It utilizes five NetLogic NLS205 single-chip knowledge-based processors. Each NLS205 processor has the ability to concurrently support rule databases consisting of hundreds of thousands of complex signatures. The unique design and capability of these processors enable the inspection of every bit of document data being processed at rates up to 20 Gbps by accelerating the compute intensive content inspection and signature recognition tasks. This performance far exceeds the capability of current generation multicore processors while consuming substantially less energy.

Due to the concurrency offered by the NLS220HAP, multiple documents may be processed in parallel against rule databases consisting of hundreds of thousands complex patterns. The matched pattern indices are then used to determine context and identify the rules matched. The scoring function then computes the contribution of each match to generate a complete document score for the goodness-of-fit.

### Indago Scalability

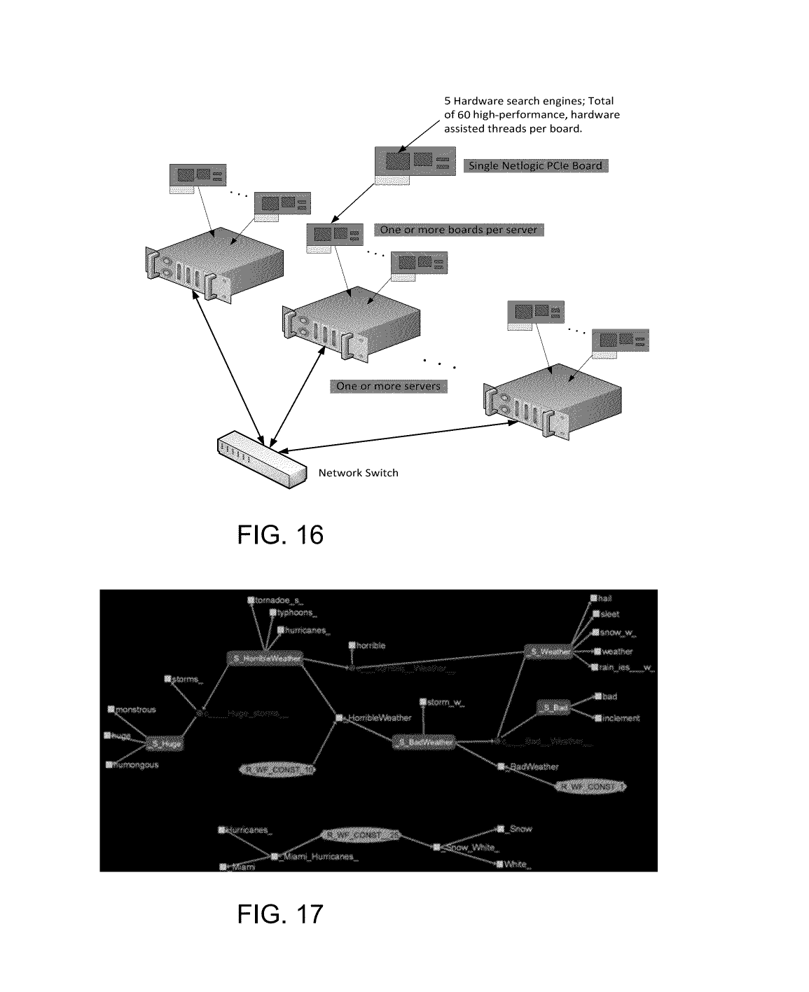

Indago can be scaled in multiple ways depending on the operating environment and the application requirements, see FIG. 16. The lowest level of scalability is at the single PCIe board level. A NetLogic PCIe board contains five separate hardware search engines each of which can support up to 12 threads enabling a total of 60 high-performance, hardware-assisted threads on a single board.

Referring to FIG. 16, an Indago scalability diagram is provided. An Indago application running on a single server platform can scale its performance by utilizing increasing numbers of hardware threads on a single board. If this is not sufficient, board-level scalability can be leveraged by adding additional PCIe boards to the server. The board-level scalability allows for adding substantial horsepower without increasing the server footprint and with minimal power.

The highest level of scalability is at the node-level where multiple servers, each potentially containing multiple NetLogic PCIe boards, are interconnected with a high-performance network (e.g., 10GE) to form a traditional compute cluster. In this scenario, the Indago application runs on each of the servers independently using some type of network load balancing to distribute the data to be processed. If the servers each contain multiple NetLogic boards, then the amount of processing that could be achieved with even a modest sized cluster would be significant.

The Indago approach has advantages over current applications in the two closest technology areas of text searching and content filtering.

### Text Searching

A key player in the internet field and to some extent, intranet searching is Google. This is easy to use search technology; however most searches are simple word lists. On the Content Management System arena Autonomy is a key player that touts Corporate Knowledge Management and includes algorithms for searching, clustering and other type of text management operations. TextOre is a new commercial product based on Oak Ridge National Laboratories Piranha project, and R&D 2007 winner. This product can help mine, cluster and identify content in very large scale. The original Piranha algorithm can run from a desktop machine, but uses a supercomputer to achieve best performance. The implementation is based on word frequency for finding and clustering documents. In general, text searching most often uses a simple word list, other operations such as clustering may use word co-occurrence indices and frequency counts to cluster like documents. Furthermore the documents need to be preprocessed in preparation for these operations, and therefore these techniques may not be suitable for inline content filtering.

### Content Filtering

Simple word list based tools plug into a web browser to block unwanted content. These usually target parental control customers. Antivirus software can also be considered in this category, but virus definitions are simple bit-sequence matching. Most filtering engines are designed for one-at-a-time web page, while Indago is designed to filter large volume of content in near real time.

Neither text searching nor filtering attempts to understand the content and merely match patterns. Both use simple rules and are limited to a small rule set. If the rule set grows by an order of magnitude these systems would begin to degrade. Indago's hardware accelerated performance is independent of rule set complexity

Another difference from current approaches is the weighted identification of concepts-in-context. Most filters and search engines use either a simple word list or Boolean logic to express target patterns. For example, Google uses a simple list, augmented by additional data (e.g., prestige of pages linking to the document, page ranking, etc.), to produce good retrieval rates; however, the number of matches can be impracticably high with many false positives.

Simple search implementations often return many hits but with the significant drawback of a high false positive rate.

Boolean logic can express complex context relationships but can be problematic. A single over-hitting pattern can cause false positives; however, filtering out all documents containing that pattern may eliminate documents that have it, or other targeted concepts, in a desired context. Users of this style of searching are forced to trade precision for recall and visa versa as opposed to being able to enhance both. And when the query contains hundreds or thousands of terms, just finding the few culprit patterns may require significant effort.

Indago includes sophisticated weighting that can be applied to both simple patterns and to multiple patterns co-occurring in the same clauses, sentences, paragraphs, or an entire document. The goodness-of-fit algorithm allows a tight matching of the target patterns and also provides a mechanism for tuning rules, thereby reducing both false positives and false negatives. The concepts-in-context approach allows more precise definition, refinement, and augmentation of target patterns and therefore reduces false positives and false negatives. Researchers have documented the negotiation process for creating and acceptable Boolean query in the Request to Produce documents for a Complaint. The basis for their complaint is:
All documents discussing or referencing payments to foreign government officials, including but not limited to expressly mentioning “bribery” and/or “payoffs.”
   The resulting agreed to Boolean query string is:
(payment! OR transfer! OR wire! OR fund! OR kickback! OR payola or grease OR bribery OR payoff!) AND (foreign w/5 (official! OR ministr! OR delegate! OR representative!)).
   The exclamation symbol “!” denotes a wild card, such that “payment!” matches payment, payments and any other word that begins with payment. “w/5” refers to two words that at most have four words in between. This Boolean search would translate into two Indago rules. Instead of referencing word distance Indago rules specify that they are in the same sentence or clause. This level of specificity is not possible in either list searching or Boolean queries.

### Implementation

The goodness-of-fit algorithm uses a dataflow process that starts with extraction of text from electronic documents; the text is then either sent to hardware for basic pattern matching or a software emulator. The matches are used to determine the satisfied rules from which the score is computed.

For the first step of the process, the integrated Tika module does the extraction of text from most electronic documents including archives such as zip and tar files. It is an open source framework with many developers creating data parsers. It does not rely on the “file” extension to determine content, it reads the data stream to make that determination and calls the appropriate parser to extract text. Most common formats are supported such as MS Office file formats, PDFs, HTML pages, even compressed formats like tar and zip, plus more. The framework is extensible; therefore, new formats can be incorporated and can be used in the framework.

The Porter word stemmer is also integrated and allows the identification of word roots, which can then be used to find word families so that all of the variations of a word can be matched as needed instead of having to specify each variation.

### Rules and Scoring

Rules can be used for defining the targeted concepts and determining the goodness-of-fit of a document's text to those concepts. The two main types of rules are concept rules and weighted rules. Concept rules are used to define words and/or phrases. The main purpose of this type of rule is to group conceptually-related concepts for later reuse. Concept rule blocks begin with the label “SYN” and end with “ENDSYN”. Weighted rules are used to assign a specific weight to one or more concept rules. Weighted rule blocks begin with the label “WF<weight function parameters>” and end with “ENDWF”. They are usually comprised of one or more references to concept rules. Only the weighted rules contribute to the total score of the document when they are matched.

### Concept Rule Syntax

A concept rule definition can start with the following:
SYN <RuleName>
   where <RuleName> is a unique identifier of the concept rule that will be used for expansion of other Concept Rules. Every rule definition must close with the following line:
ENDSYN
   Rule lines can be constructed with single words or multiple words (phrases). Words may appear in any order on the line; word order does not constrain matching.
blue line
   will match: “The line connecting these two points is in blue.” (1)

As well as: “The water is so blue that it's hard to find the line where the sky meets the ocean.” (2)

Rule lines may contain regular expressions.
warm\w* days?
   In the line above, the regular expression “\w*” means “match any zero or more word characters,” meaning that “warm” may be followed by any number of letters, and “day” is optionally followed by an “s?”.

This rule line matches all of the following sentences:
“The water in the lake is warmer with every day.” (3)
“I look forward to the day when it's warm enough to wear shorts.” (4)
“Warmer days are much anticipated.” (5)
“Today is a warm day compared to yesterday.” (6)
   If word order is important, the phrase is contained within double quotes. For example:
“warm\w* days?”
   will match sentences (5) and (6), shown above, but not sentences (3) and (4). It is recommended that rule writers think carefully when using “\w*” because wildcards can often match in unexpected contexts. For example:
plan\w*
   will match “plan”, “plans,” and “planning.” It will also match “plane,” “plant,” and “planet.”

It is also possible to specify that all elements of a set of two or more words appear within a particular syntactic locality. The supported locality constrainers are listed below, in descending order of restrictiveness:

Document locality, which is specified with the following rule syntax:
d:(<words and/or SYN references>)
   The word list enclosed in a document-level locality translates to requiring that all of the words/concepts in the list appear within the document.

Paragraph locality, which is activated with the following rule syntax:
p:(<words and/or SYN references>)
   The word list enclosed in paragraph-level locality translates to matching all of these words within the same paragraph. A paragraph is defined as a series of words or numbers ending with any one of {‘.’ ‘!’ ‘?’}. By default, paragraphs are limited to having no more than 10 sentences.

Sentence locality, which is specified with the following rule syntax:
s:(<words and/or SYN references>)
   The word list enclosed in sentence-level locality requires that each of the listed words appear within the same sentence. This is the DEFAULT locality; if no locality is specified, and the words do not appear in double quotes, each of the specified words must appear, in any order, to trigger a match to the specified definition. By default, sentences are limited to having no more than 30 words.

Clause locality, which is specified with the following rule syntax:
c:(<words and/or SYN references>)
   The word list enclosed in clause-level locality requires each of the words to appear within the same clause in order to count as a match for this rule line. A clause cannot be longer than the sentence that contains it and is therefore limited to having no more than 30 words.

SYN rules can group concepts that are related to one another in some meaningful way so that the SYN can be incorporated into other SYN rules or weighted rules. Each line in a SYN rule definition is considered to be interchangeable with each other line within the same rule definition. Once a rule is defined, it can be reused in other rule definitions by referring to its unique name. It can be referenced by preceding the name with an equal sign (‘=’) anywhere in rule definition lines. Comment lines, which are ignored, start with the “#” symbol.

# Initial declaration, can be placed before or after its
# intended use.
SYN Huge

huge
monstrous
humongous

ENDSYN
SYN Big

big
large
=Huge

ENDSYN
SYN Weather

weather
hail
sleet
snow\w*

#don’t want “rainforest” or “raincheck.”.

rain[ies]?\w*

ENDSYN

...

# Defining something that might deserve weighting later
SYN HorribleWeather

# The reference to another rule also can be used in any
# of the locality boundaries with or without other words,
# phrases, or SYN references.
# It might be good to define a SYN for “horrible” as well.
c:( horrible =Weather )
c:( =Huge storms?)
typhoons?
hurricanes?
tornadoe?s?

ENDSYN

...

# Reusing previously declared rule in combination with
# other words.
SYN BadWeather

c:( bad =Weather )
storm\w*

ENDSYN

In the above reuse example, it may be beneficial to remember subset and superset relationships. Anything that is “huge” is at least “big.” It is likely beneficial to reference the superlative form from the less extreme SYN, rather than the other way around. Similarly, it is useful to create very specific concepts and then reference them within more general ones. That way, the specific form can be used in a heavily-weighted rule while the more general concept can be used to establish context and/or be used in a lesser-weighted rule.

### Weighted-Rule Syntax

Weighted rules can be implemented as collections of one or more concepts, with a weighting function assigned to each collection. The syntax is generally the same as for a concept rule, except that these rules are meant mainly for usage of concept rules, as they do not have any unique name identifier. As mentioned before, their primary use is to define the weight function by which the included concept rules will contribute to the total score of the document. A variety of weight functions were made available for defining how the rule in weighted. They are:
CONST, for a constant weight applied each time the rule line is matched in the document.
SLOPE, to allow for a successively increasing or decreasing point increment with each successive occurrence of matching text in the document.
STEP, to allow the rule writer to explicitly articulate the point increment for each successive occurrence of matching text in the document.

Weighting function blocks begin with “WF” and end with “ENDWF.” The weighting functions are described in more detail below.

Consider the following text as it is scored by various weight functions. “numHits” is the number of matches found in the text for a particular rule.
“It seems that the weather was bad around the globe last week. There were a number of huge storms on the East Coast of the U.S., a hurricane off of the Texas coastline, and numerous typhoons in Asian waters.” (7)

CONST
A constant weighting function assigns the specified number of points each time the rule is matched in the text of the document.

```
  CONST weightConstant
means that the points contributed by and rule line contained in the WF
block are described by the following equation:
  incrementForThisRule = numHits * weightConstant
For the weightConstant rule:
  WF CONST 5
    =BadWeather
  ENDWF
using rule snippets above, text (7) would be scored with five points for
each of the two matches to the rule associated with the concept
“BadWeather,” for a total of 10 points.
Similarly,
  WF CONST 25
    =HorribleWeather
  ENDWF
would yield a score of 75 points, based on matching four instances of
“Horrible Weather” (“huge storms,” “hurricane,” and “typhoons”).
Negative weightings are allowed, and are for dampening the impact of
“known bad” contexts. For example, “the Miami Hurricanes”
and “Snow White” are unlikely to be a reference to weather of
any sort.
  WF CONST −25
    “Miami Hurricanes”
    “Snow White”
  ENDWF
SLOPE
```

```
  SLOPE slope offset
means that the points contributed by and rule line contained in the WF
block are described by the following equation:
  incrementForThisRule = slope * (numHits−1) + offset
The default values for slope and offset are 0 and 1, respectively. Thus,
the weight rule
  WF SLOPE
    =HorribleWeather
  ENDWF
would yield a score of 0 * ( 3 − 1 ) + 1 = 1 point.
If, instead, the rule was defined as
  WF SLOPE 3 0
    =HorribleWeather
  ENDWF
the score would be 3 * ( 3 − 1 ) + 0 = 6 points.
STEP
Step functions are designed to allow for specific amplification or
dampening of a set of rules for each successive match.
```

STEP step0 step1 step2 ...

means that the points contributed by and rule line contained in the WF
block are described by the following equation:
if ( numHits <= numSteps )

incrementForThisRule = Σstepᵢ, for i = 1 to numHits − 1
(this translates to step₀ + step₁+ ... + step_{numHits-1})

else

incrementForThisRule = step₀ + step₁+ ... + step_{numHits-1}
+ step_{numHits-1} * (numHits − numSteps)

Each match increments the score by the value of the step associated
with the match count for that match, until the match count exceeds
the number of declared steps. Once the number of matches exceeds
the number of steps, the point increment is the same as the last
step weighting for that and all subsequent matches.

STEP 10 5 3 2 1 0

means that the first match contributes 10 points to the score, the next one
contributes 5, etc., and that all matches beyond the 5^{th} contribute nothing.
The rule

WF STEP 10 5 1 0

=Horrible Weather

ENDWF

would contribute 10+5+1 = 16 points to the total score of test (7).

Finally, the concept rules are modular and thus are easier to maintain than Boolean queries. Incorporating synonymy into a Boolean often leaves it looking like a run-on sentence. The resulting complexity often causes internal inconsistencies and logical gaps with respect to synonyms. Indago's modules allow the user to build modular concepts and then refer to them as many times as necessary. When new synonyms are discovered, they can be easily added to the relevant module. A complete weather related rule set may look like:

| SYN Huge | | hail |
|---|---|---|
| | huge | sleet |
| | monstrous | snow\w* |

| | |
|---|---|
| humongous | #don't want “rainforest” or “raincheck.” |

| | |
|---|---|
| ENDSYN | rain[ies]?\w* |

ENDSYN

SYN Weather

| | |
|---|---|
| weather | SYN HorribleWeather |

c:( horrible =Weather )
c:( =Huge storms?)
typhoons?
hurricanes?
tornadoe?s?

ENDSYN
SYN Bad

bad
inclement

ENDSYN
SYN BadWeather

c:( =Bad =Weather )
=HorribleWeather
storm\w*

ENDSYN
WF CONST 1

=BadWeather

ENDWF
WF CONST 10

=HorribleWeather

```
ENDWF
WF CONST −25
  “Miami Hurricanes”
  “Snow White”
ENDWF
```

“It seems that the weather was bad around the globe last week. There were a number of huge storms on the East Coast of the U.S., a hurricane off of the Texas coastline, and numerous typhoons in Asian waters.”
   Using the text and rules above to express the idea that superlative terms warrant a higher weighting, the passage would score 35 points: 10 points for each mention of horrible weather (huge storms, hurricane, typhoons) and 1 point for each mention of merely bad weather (weather . . . bad, storms and the three horrible weather references). In FIG. 17, rules are shown as text inside and ellipse with the label preceded by a “R_”. Synonyms are shown in rounded boxes with the label preceded by an “S_” References to synonyms have the label preceded by “_” Clauses are shown with the label preceded by “c_” The remainder are literal constants.

On the right-middle section of FIG. 17, the BadWeather rule is presented with branches for the synonym BadWeather, which references the synonym HorribleWeather, “storm” and a clause that contains the synonyms “Bad” and “Weather.” The synonym “Weather” is shared with the HorribleWeather rule via the HorribleWeather and the BadWeather synonyms. The HorribleWeather rule is shown in the center left-hand-side of the image, and uses several synonyms that include nested references. The rule with negative weight for non-weather related concepts is shown on the center lower section of the image and is not connected to the other concepts. The inclusion of negative concepts would not immediately exclude the text containing these concepts. But it would require presence of more concepts in the “right” context to overcome this negative weight.

This graph shows the encapsulation of the target concepts of interest. It shows the concepts and relationships. It is a mental model of the kind of information we are after. A very simple example is shown here; the one used in the results section contains hundreds of rules. A text of interest matches certain parts of this model, and these matches are then shown through the use of text highlight on a web page for user consumption. The text analyzed is highlighted with the concept matched contributing to the score of a document.

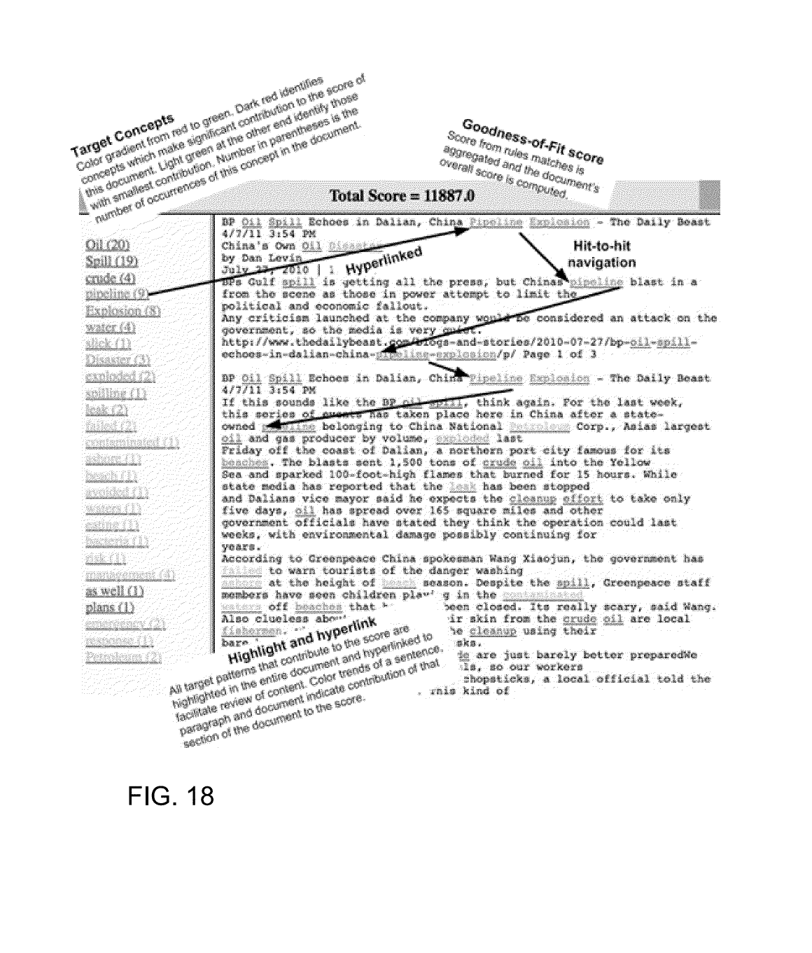

FIG. 18 shows an annotated document from The Daily Beast. In the top most panel of FIG. 18, the total score for the document, 11887.0, is provided. Below that and to the left, concepts from the model that appear in the document are shown. Different colors are used to denote that it was part of a rule with significant weight. It goes from dark red, which is used for more important concepts, to light green for the lesser ones. These same concepts are color coded in the original text along with hit-to-hit hyperlink navigation as shown in the right hand panel of FIG. 18.

Indago delivers higher accuracy and scalability than Boolean queries and more consistency than humans. While improvement can be estimated in terms of cost or speed or energy consumption, for this problem space, it is perhaps best understood in terms of relevancy of matches. A Google search with thousands of results is not useful if the most-relevant document doesn't appear until the 10^{th} page of results; none of us has the patience to scan through many pages of false positives. Similarly a very-fast Boolean search is not useful if relevant documents are missed because important concepts were omitted from some portion of the query or were filtered out by the use of a NOT operator. In the legal field, missed documents (e.g., false negatives), may contain the “smoking-gun” evidence. Failure to produce such a document may lead to a contempt charge and failure to read it might mean losing the case. The focus of this system has been to find relevant information while minimizing both false positives and false negatives. The use of hardware acceleration cuts the processing time by a third; future releases may push additional operations to the hardware for even more speed up and added processing capability.

Indago was used to score a large and publicly-available large data set of email messages, referenced earlier, and their respective attachments for relevance to the general concept of environmental damage as a result of pipeline leakage or explosions. From the more than 750,000 discrete documents, just over 12,000 were selected by a variety of search algorithms for human judicial review. Indago also identified around 1000 additional documents that were not included in the judicial relevance review, suggesting that Indago may have a higher recall than other algorithms that defined the 12,000 set.

The email collection was used to quantify the discrimination capability of the technologies. The concept model included a vast array of concepts-in-context in an effort to find relevant documents among the huge collection of irrelevant ones. “Relevance” is usually subjective, and this was no exception. Judicial reviewers were relied on to establish relevance for litigation purposes and then evaluated a sample of the documents for conceptual relevance. For example, if a document contained relevant background information, and discussed actual pipeline blowouts or oil leaks, or insurance against, or response to, potential blowouts, it was deemed conceptually relevant. This process was, however, incomplete, and in many cases, the litigation assessment was used as a proxy for conceptual relevance. This will, by definition, increase the number of false positives for Indago scoring, but there was inadequate time to fully evaluate each of the 12,000 documents without using Indago's scoring and markup.

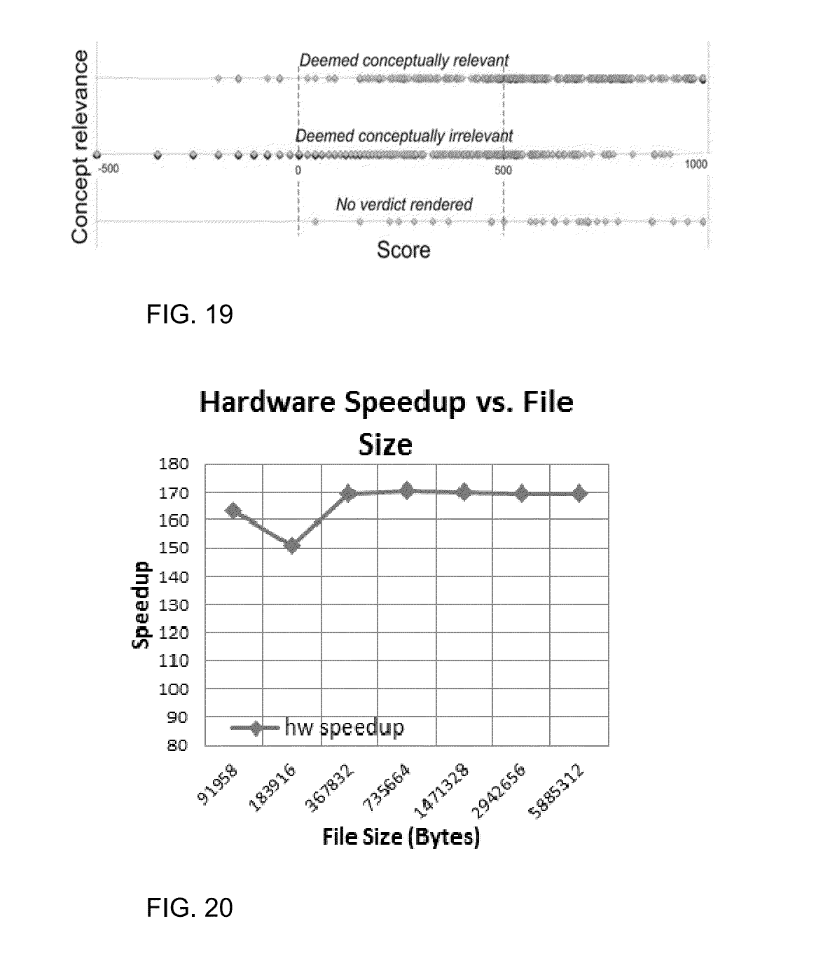

Indago read the model and scored each document. An adjusted minimum of −500 and maximum of 1000 was used to facilitate creating the scattergram with score as the X axis and Conceptual relevance at the Y axis as shown in FIG. 19. Notice that the conceptually relevant documents are clustered on the high part of the band. Those deemed irrelevant are clustered in the middle, and the others are spread on the positive side of the score band. What seems clear is that the Conceptually-Relevant clusters with much higher scores than the human-admitted indecisiveness and it is generally higher scoring than the rejected group of documents.

The goodness-of-fit against the target model results are documented in Table 1. The Indago Score Group column categorizes documents by their total adjusted score from “Huge Negative” (lowest score set at −500) to “Huge Positive” (largest score set at +1000). The documents groups are further broken down as “yes” versus “no” in terms of meeting the legal relevance and/or conceptual relevance criteria. Of the documents judged for legal relevance, there was no clear verdict on 189.

As shown in Table 1 below, there were a grand total of 12,087 documents analyzed (not counting six image-only files). Of this total, those with “Huge Negative” to “Tiny Positive” scores (i.e. less than 25) were deemed not to meet enough of the target model. These 11,492 were considered to be irrelevant from the perspective of the computer-based model, independent of the conceptual and litigation relevance assigned through human review. The remaining 595 (101+107+387 from the “Total” column) had a high-enough score to be relevant to the target model.

TABLE 1
Indago scoring and human-judged relevance.

| Indago | | Mean | Legally Relevant? | | | Conceptually Relevant? | | |
|---|---|---|---|---|---|---|---|---|
| Score Group | Score | Score | Yes | No | No Verdict | Yes | No | Total |
| Huge Negative | X < −100 | −185 | | 27 | | | 27 | 27 |
| Moderate Neg | −100 ≦ X < −50 | −68.5 | | 68 | 1 | | 68 | 69 |
| Negative | −50 ≦ X < 0 | −16.6 | 31 | 3096 | 25 | 3 | 3124 | 3152 |
| Zero | X = 0 | 0.0 | 55 | 7758 | 131 | | 7813 | 7944 |
| Tiny Positive | 0 < X < 25 | 9.1 | 31 | 267 | 2 | 22 | 276 | 300 |
| Small Positive | 25 ≦ X < 50 | 34.9 | 21 | 76 | 4 | 38 | 59 | 101 |
| Moderate Pos | 50 ≦ X < 100 | 76.7 | 22 | 81 | 4 | 41 | 63 | 107 |
| Huge Positive | 100 ≦ X | 368 | 142 | 223 | 22 | 273 | 92 | 387 |
| Grand Total | −500 ≦ X ≦ 1000 | | 302 | 1596 | 189 | 377 | 11522 | 12087 |

Only 302 documents in the entire collection were deemed to be legally responsive, according to the judicial reviewers. Of these, Indago found 185 (21+22+142) giving a 61% retrieval rate and a 39% false negative rate. Similarly, for the adjudicated 565=(185+380) found to have a high-enough score, 380 (76+81+223) were not responsive giving a false positive rate of 67%. The other 30 (4+4+22) documents had no verdict.

There were a total of 377 documents deemed conceptually-relevant through human review. Of those, only 3 received negative scores by Indago and only one passed our “not simply generic oil pollution” concept relevance test. The responsiveness cut-off was set at 25 points, which eliminated nearly 300 documents of which only 7% were relevant. Depending on the optimal precision and recall required by the problem space, in conjunction with the resource levels available manual review, this number can be easily adjusted without re-processing the documents. For conceptual relevance, Indago's relevant retrieval rate is 93% and 7% false negative. False positive rate for all those found to have a high enough score (59+63+92=214)/(377+59+63+92 591) of 36%.

The model can be improved. Testing indicated ability to search for generic concepts in the targeted context, though sometimes the contextual items themselves were out of context and a handful of concepts appearing in close proximity triggered false positives. For example, generic definitions of pollution and leaks were included in the model, but upon review, documents were deemed conceptually irrelevant if they addressed only resultant air pollution, the leaks were quite small, or the oil was merely incidental. Although it may be argued that Indago found precisely what it was asked to find, such documents were still considered as false positives for this study.

Manually reviewing annotated documents with near-zero (<25) scores facilitated identification and suppression of false positive contexts. In other words, the concept tagging of these low-scoring documents revealed a useful set of context filters that were subsequently incorporated into the targeting rules to further improve precision without sacrificing recall. The initial processing of the entire collection revealed 1,389 documents with scores exceeding 50. The median score was 999. After incorporating the new filters, the median dropped to 47, and 272 files scores dropped to zero or less. Of the newly-negative-scoring documents that were part of the adjudicated set, not a single one had been deemed responsive. Of 54 documents, the highest scoring 10 were all deemed responsive, while only four of the lowest scoring 28 documents were responsive. Depending upon the user's goal in conducting the search, it may only be necessary to read a few top-scoring documents in order to get the gist of an issue. A Boolean “yes” doesn't help differentiate among “really yes,” and “maybe yes.”

Indago has several advantages over the current alternatives. For example, Indago allows one to make use of negative weightings for undesired contexts. Indago's raw scoring of the adjudicated documents ranged from a low of −2,370 to a high of 35,120. A Boolean query doesn't provide a mechanism for sorting the documents by matched content, whereas our does. The unfortunate result of this exercise is that it highlighted the inaccuracy of the human adjudication process. There are a number of high-scoring documents deemed to be non-responsive that are exact copies of other documents that were judged to be responsive.

Document size has an impact on scoring. As yet, scores are not normalized by size, so exceptionally positive and, to a lesser extent, negative, scores are more likely with large documents. As shown in Table 2, below, there were no false negatives among the larger file groups, and in fact the vast majority of the false negatives were among the smallest files. In many cases, these were the “body” documents with large attachments and thus “inherited” their relevance from wording that was not actually included in the document itself. The rates of false positives were significantly worse with large documents, primarily because negation for bad contexts was limited to the first few instances whereas the points for good context were attributed for each encounter of the concept. Techniques for using negative weightings can be improved in the example.

TABLE 2
Document Size as it Relates to Relevancy

| | False | False | True | True | Un- | |
|---|---|---|---|---|---|---|
| | Nega- | Posi- | Nega- | Posi- | deter- | Grand |
| Document Size | tive | tive | tive | tive | mined | Total |
| Small (4-16k) | 23 | 25 | 10022 | 197 | 153 | 10420 |
| Moderate (17-49k) | 3 | 44 | 664 | 42 | 10 | 763 |
| Large (50-100k) | 3 | 42 | 332 | 50 | 4 | 431 |
| Very Large | | 48 | 219 | 37 | 10 | 314 |
| (150-300k) | | | | | | |
| Huge (>300k) | | 55 | 73 | 26 | 11 | 165 |
| Grand Total | 29 | 214 | 11310 | 352 | 188 | 12093 |

Indago performed better against some types of documents than others. The lack of “natural language” contained in typical spreadsheets rendered the differential weightings for conceptual co-occurrence within single clauses, sentences, and/or paragraphs somewhat ineffective in the example.

In spite of concerns about score variability based on document size, for each size group, the average score Indago gave to “true positives” was quite a bit higher than that given to the false positives. Similarly, Indago's average scores for true negative (e.g., irrelevant based on human evaluation) documents was less than the average for similarly-sized it misidentified.

TABLE 3
Average Indago Scores by Document
Size and Relevance Disposition

| | False | False | True | True | Un- | |
|---|---|---|---|---|---|---|
| | Nega- | Posi- | Nega- | Posi- | deter- | Grand |
| | tive | tive | tive | tive | mined | Total |
| 2 Small | 10.7 | 92.0 | −3.2 | 215.6 | 7.3 | 1.4 |
| 3 Moderate | −4.0 | 129.7 | −18.5 | 510.1 | 200.3 | 22.1 |
| 4 Large | 6.0 | 100.5 | −19.6 | 548.2 | 75.0 | 59.0 |
| 5 Very Large | | 99.5 | −21.7 | 469.8 | 171.2 | 60.9 |
| 6 Huge | | 142.4 | −48.6 | 457.5 | 283.1 | 116.9 |
| Grand Total | 8.7 | 116.1 | −5.2 | 342.6 | 43.9 | 7.9 |

As stated, some of the false positives were identical copies of other “responsive” documents, and more importantly they had been labeled as non-responsive. The duplication comes from the fact that messages to multiple recipients are treated as being unique even though the content is the same. Apparently some of these different files were assigned to different judges and one judge decided that the document was responsive and the other decided it was non-responsive. Since many of the decision aspects are subjective, one's experiences and biases become significant factors and introduce inconsistencies. It is difficult for different people to provide consistent responses when manually evaluating thousands of pages of documents. Some researchers state that the difference in responsiveness adjudication is most often a result of human error as opposed “gray area” documents. Some researchers recommend the simplification of the target patterns to minimize variation. By contrast, Indago results are consistent across large or small collections and the rule set can be composed of hundreds of rules.

### Technology Application

Analysis, sorting, management, and protection of data can be applied across a diverse set of industries and applications. Indago is particularly powerful because its hardware-assisted, concept-in-context approach allows domain-optimized algorithm adaptation.

Protection of Corporate Intellectual Property or Sensitive Information—Exfiltration is a military term for the removal of assets from within enemy territory by covert means. It has found a modern usage in computing, meaning the illicit extraction of data from a system.

Email Exfiltration: Indago can be used to search transmitted data streams to identify sensitive information in context, and based upon that identification, take action to prohibit or allow the transmittal of digital content. One implementation of Indago is an electronic Mail Filter that has advantages over current approaches, as the state of the art is limited by word list matches and does not contain the ability to search concepts-in-context. The advantage of current technology is that it is very fast, but can be easily defeated by a knowledgeable individual. Similarly it can miss target material. For example many email filters depend on the extension of the file name to filter potential harmful content. The filter looks for “.exe” files. However, a real “.exe” could be renamed and still be harmful.

Exfiltration (general): Similarly, Indago can be used to search data repositories to identify sensitive information, and based upon that identification, the information can be flagged for additional protection or action can be taken to prohibit or allow access, as appropriate.

As viruses pose a threat so does disclosure of Corporate Knowledge. Indago can be used to monitor different forms of internet traffic and flag suspected sources/individuals.

An insider threat is a significant concern. Who is looking for sensitive corporate knowledge that should not have access to it? Intra web sites contain vast amounts of corporate knowledge that may not be properly protected. Monitoring of such flow could be facilitated by the use of this technology.

Fast and Accurate Large Repository Search—Indago allowing more complex searches that retrieve more relevant content by focusing on the context. As stated before, the word “Apple” for non-computer folks usually refers to a fruit, for most technical computer folks it can be either the fruit or the computer company. The use of the rule set and hierarchical concept-in-context matching allows more precise matching for the target interpretation. Researchers have documented a fictitious negotiation for a Boolean query to be used to retrieve relevant documents for a legal case.

As data generation and storage technologies have advanced, society itself has become increasingly reliant upon electronically generated and stored data. Digital content is proliferating faster than humans can consume it. Tools are needed to perform repetitive tasks so that humans focus on what they do best and that is to recognize patterns at a higher level. Current search/filter technology is well suited for simple searches/matches, but a more powerful paradigm is required for complex searches such as finding sensitive corporate knowledge that may be flowing in the intranet and could be accidentally or maliciously sent out the internet. Context-based search and analysis can greatly enhance the exploration of data and phenomena by reducing the data deluge and increasing the efficiency and effectiveness of the human analyst and/or end-user to access and fully exploit the data-to-knowledge potential that is inherent but latent in nearly every collection.

Indago can be implemented as a cost-effective solution that provides unparalleled performance and capability using proven, commercial off-the-shelf technology. It allows users (e.g., IT personnel, law firms, scientists, etc.) to engage their data faster, more accurately, and more effectively, thus allowing them to solve problems faster, more creatively, and more productively. Furthermore, Indago is domain-adaptable, power efficient, and fully scalable in terms of rule set size and complexity.

Indago can provide a unique, outside-the-box innovation in terms of how it exploits deep packet processing technology, its adaptability and breadth of applicability, and its unparalleled performance potential.

Analyst-in-the-Loop applications leverage the speed and consistency of the algorithm to enhance the productivity, efficiency, and accuracy of an expert by accurately focusing attention on content of potential interest for final and actionable context-based inspection and decision-making. Indago's contextual analysis includes color-code triage to focus attention on high interest text matches with single click navigation to each specific textual instance.

### Timing Detailed Comparison Software Emulator Versus Hardware Accelerator

Testing utilized a Java program that runs the entire Indago processing flow. This program can be configured to use the NetLogic NLS220HAP hardware-assisted flow, or a software-only emulation of the hardware-assisted flow. The program can also be configured to output millisecond accurate timing for each of the major processing steps of the Indago processing flow.

For testing, the program was configured to print out timing information and was executed using input test files of increasing size. All test files were generated from a single base file “bad_text.txt” (base size=91,958 Bytes) that contains content that will generate a high score when analyzed by the Indago processing flow against a target rule set. Larger file sizes are generated by concatenating “bad_text.txt” multiple times. For reference one typewritten page is ˜2,048 Bytes and a short novel ˜1 MB.

For both hardware-assisted and software-only testing we present timing results for the main processing steps: SW emul (software emulation), Input File (Input File Processing), Score (Scoring), and TOT user (overall run time of Java program). All timings with the exception of TOT user are measured in milliseconds.

Table 4 presents the results obtained for the hardware-assisted testing. The hardware-assisted processing implements a high resolution timer that measures the actual processing time of both the hardware-assisted C/C++ code and the actual NLS220HAP hardware. These results are listed under the HARDWARE/HW timer column of the results.

TABLE 4
Hardware-assisted Timing Results
HARDWARE

| | HW timer | Input File Proc | Score | TOT user |
|---|---|---|---|---|
| File Size | (ms) | (ms) | (ms) | (sec) |
| 91958 | 30.6213 | 5018 | 8003.612 | 11.254 |
| 183916 | 57.2672 | 10403 | 17334.777 | 21.74 |
| 367832 | 112.262 | 22051 | 39957.399 | 46.317 |
| 733664 | 221.376 | 45770 | 100799.774 | 109.016 |
| 1471328 | 440.259 | 99374 | 316086.911 | 331.557 |
| 2942656 | 875.878 | 206707 | 1080336.714 | 1112.51 |
| 5885312 | 1754.72 | 524479 | 4303655.574 | 4388.746 |

Table 5 displays the results for the software-only testing. Since this testing does not utilize the hardware the column HW timer is replaced by SW emul.

TABLE 5
Software-only Timing Results
SOFTWARE

| | SW emul | Input File Proc | Score | TOT user |
|---|---|---|---|---|
| File Size | (ms) | (ms) | (ms) | (sec) |
| 91958 | 4996.828 | 5002 | 8228.748 | 17.096 |
| 183916 | 8624.274 | 9696 | 16654.907 | 29.882 |
| 367832 | 19022.905 | 19878 | 37880.787 | 63.223 |
| 735664 | 37732.369 | 41848 | 96760.357 | 142.823 |
| 1471328 | 74837.01 | 89751 | 298063.672 | 387.719 |
| 2942656 | 148395.304 | 212025 | 1087587.096 | 1267.34 |
| 5885312 | 297721.617 | 533686 | 4324489.587 | 4704.019 |

The steps for both software-only and hardware-assisted testing are show below. In the hardware-assisted steps, the hardware functionality is shown in italics. The Java code communicates with the hardware-assisted C/C++ code via the file system; writing input text files into a process directory, and results into a related output directory. In each case the software waits; the hardware utilizes the lightweight, kernel subsystem, inotify, while the software polls directly on the file system.

### Software-Only Steps:

1) Text extraction to text file

2) Create Results Directory for input text file

3) Place text file for inspection into process directory
a. Top 1K Family keyword matching
b. Rules matching
c. Results processing (co-location, over-lapping rules)
d. Results binary file writing

4) Further processing

### Hardware-Assisted Steps:

1) Text extraction to text file

2) Create Results Directory for input text file

3) Place text file for inspection into process directory
a. Wait (inotify) for text file to be placed into process directory
b. Top 1K Family keyword matching
c. Rules matching
d. Results processing (co-location, over-lapping rules)
e. Results binary file writing

4) Wait for Results binary file to appear (polling)

5) Further processing

It is noted that the software-only processing process is done in a single thread of execution. There are no waits for the input text file to be placed into the process directory or waits for the binary results file to be placed into the results directory. For the hardware-assisted processing this wait can incur a 500 millisecond delay and one sees this for File Sizes up to 1,471,328 bytes.

The hardware-assisted code implements five processing threads which watch five corresponding input processing directories. The upper level Java program does simple load balancing on input files; placing incoming text files for processing into one of the available input processing directories. Once a file is deposited into the input processing directory the kernel, via the inotify subsystem, notifies the thread that there is a file to be processed.

TABLE 6
Overall Results

| | TOT user % | | % inc HW | % inc SW |
|---|---|---|---|---|
| File Size | decrease | HW speedup | timer | emul |
| 91958 | 34.17173608 | 163.1814456 | 0.870175335 | 0.725949743 |
| 183916 | 27.24717221 | 150.5970957 | 0.870175335 | 0.725949743 |
| 367832 | 26.74026857 | 169.4509718 | 0.960319345 | 1.205739869 |
| 735664 | 23.67055726 | 170.444714 | 0.971958454 | 0.983522969 |
| 1471328 | 14.48523286 | 169.9840548 | 0.988738617 | 0.983363674 |
| 2942656 | 12.21692679 | 169.4246276 | 0.989460749 | 0.982913321 |
| 5885312 | 6.702205072 | 169.6690167 | 1.003384033 | 1.006273844 |

Table 6 presents the overall results computed from timings displayed in Table 4 and Table 5. The column, TOT user % decrease, displays the percentage decrease in overall run-time of the Java program when utilizing the hardware-assist. HW speedup measures the speedup for the processing steps 3a through 3d shown above when hardware-assist is used. The column % inc HW timer and % inc SW emul measure the percentage increase moving from one File Size value to the next. The last two columns compute the percentage of time increase from the previous set for hardware or software. Notice that both processing times double with every increase of the file size.

FIG. 20 plots the hardware speedup (HW speedup) versus the input File Size. The results show that the hardware-assisted code has the potential to offer speedups of approximately 170 times that offered by the software-only code. This is only for the processing steps 3a through 3d shown above but it does show the potential offered by the inclusion of the hardware.

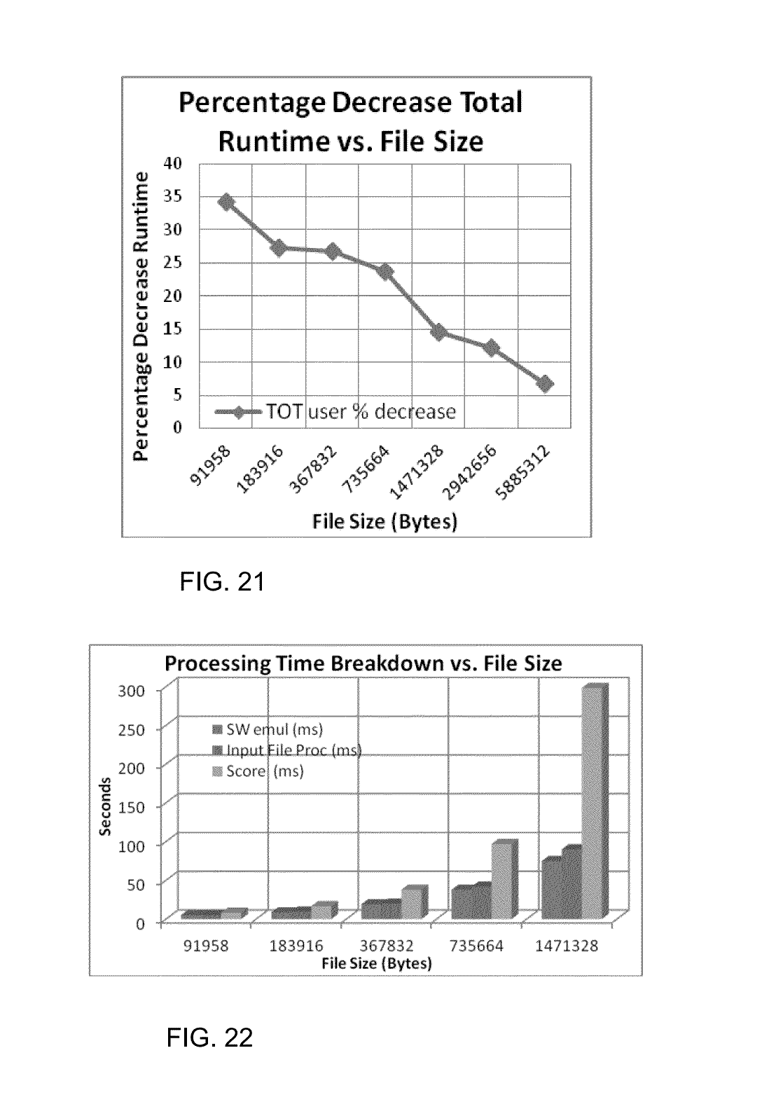

FIG. 21 displays a plot of the percentage decrease in total runtime (TOT user) versus File Size. As the file size grows, the pattern matching step becomes a smaller factor in the overall runtime and the complexity of computing the concepts in context begins to drive the process.

FIG. 22 shows the timing breakdown for the time-dominant Indago processing steps for the software-only processing. The scoring phase rapidly begins to dominate the processing time as file size increases.

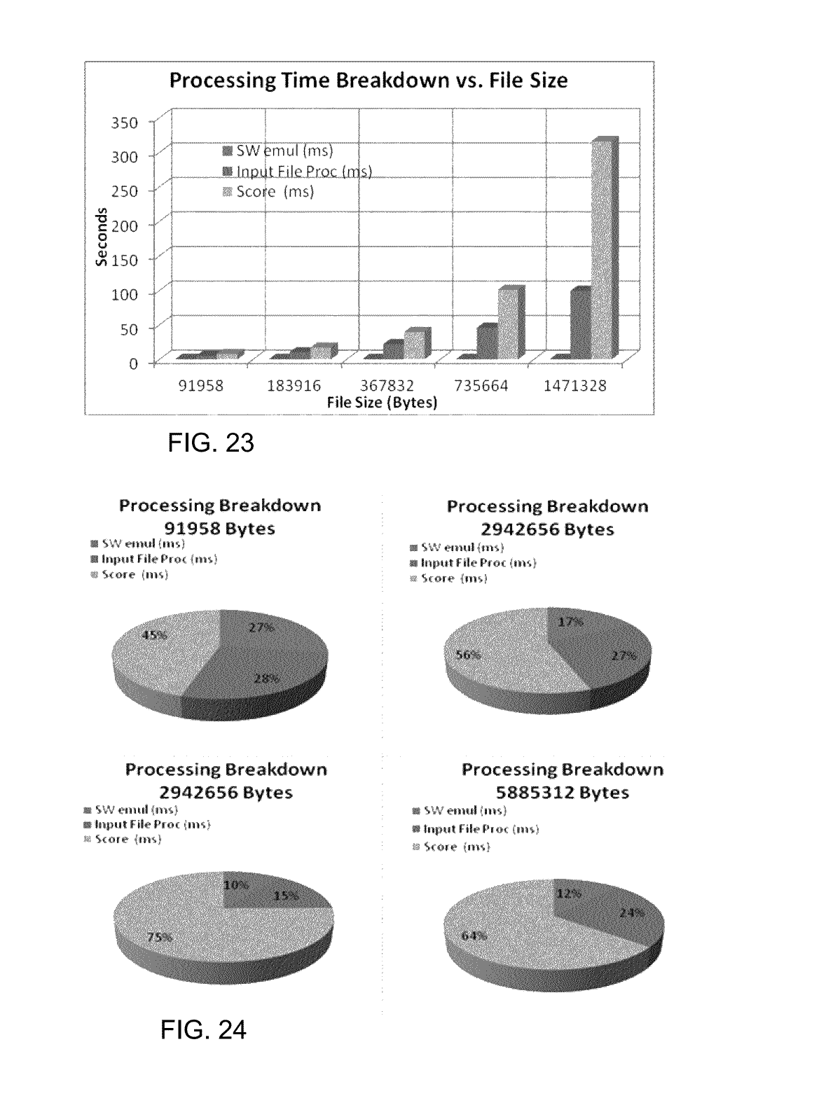

FIG. 23 shows the benefits of the hardware-assist for the SW emul portion of the processing. In this plot we can see that the processing time for the SW emul becomes negligible in the overall processing time. In FIG. 24, the processing time percentages for the time-dominant Indago processing steps are shown. As can be seen the SW emul portion of the processing time becomes less of a factor in the overall processing time as the file size increases. So while the hardware-assisted SW emul processing is still approximately 170 times faster than software-only processing, one sees a much smaller percentage decrease in the overall run-time.

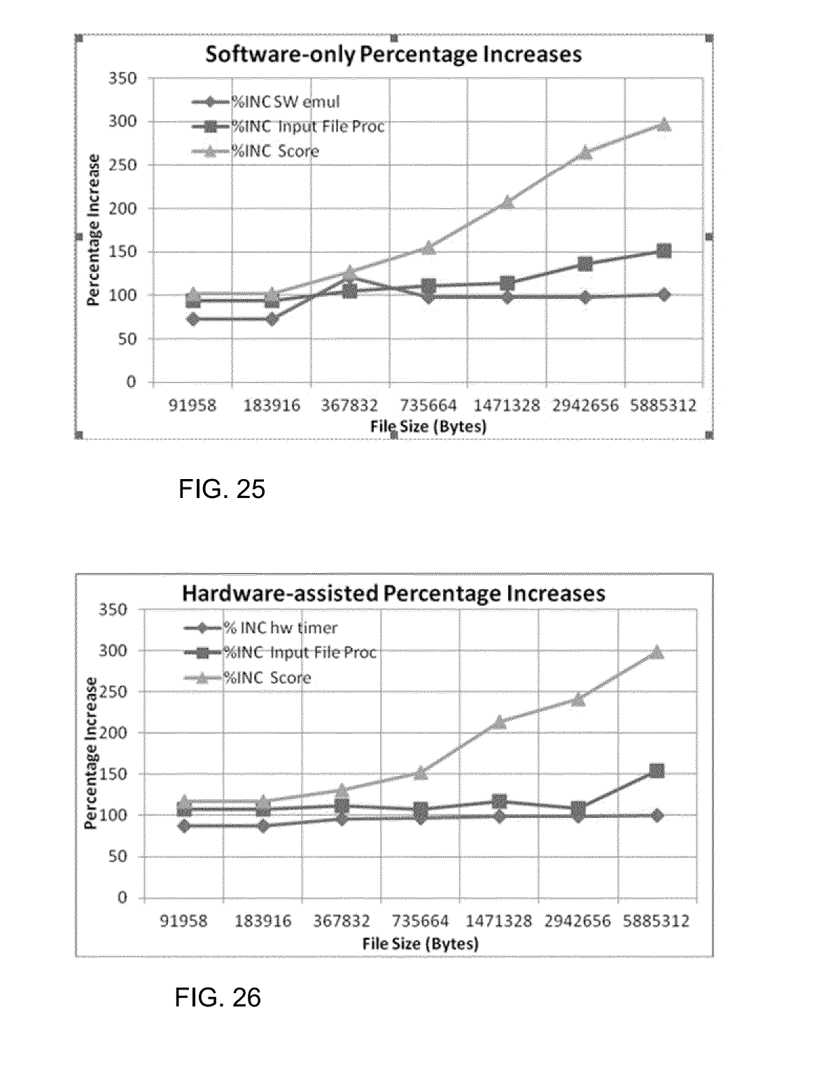

FIGS. 25 and 26 plot the percentage increase for each of the time-dominant Indago processing steps versus file size for both hardware-assisted and software-only processing. For both cases one can see that the SW emul/HW timer processing sections are effectively flat so for each doubling of file size we get a corresponding doubling in processing time. This is not the case for the Input File Proc process or the Score processing.

The hardware-assisted flow provides five hardware-based, fully concurrent, processing pipelines. It is designed to handle situations where there are many documents in progress and so it is informative to look at the scaling performance of the hardware-assisted flow and once again compare with software only.

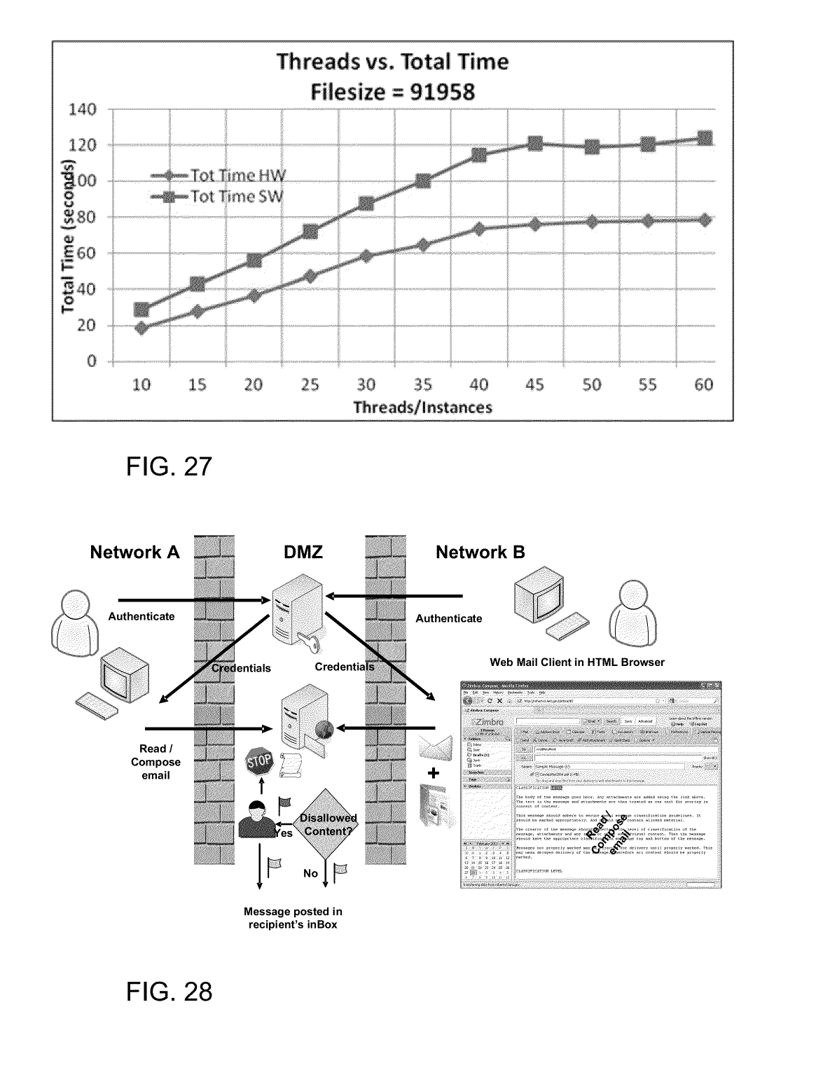

FIG. 27 compares the scaling performance of the hardware-assisted flow with the software-only Java program. For this plot, the indicated number of simultaneously executed threads were run on independent copies of the same file, which produces a large number of matches. Here the hardware decreases the overall runtime by 30% for all cases with the number of threads. One can see the same behavior for all file sizes tested. One sees a slightly greater than 8× speedup with 60 threads compared to a single thread for both the software-only and hardware-assisted flows which can be accounted for by the fact that the test system is a dual, quad-core server.

More functionality could be moved to the hardware acceleration to speed up the process further. Similarly, a simple parallelization process across several servers could speed up the process for in-line filtering of documents in a large set. The analysis of each document is independent of other documents therefore the process is trivial to parallelize.

The technologies described herein can be used to implement an email filter.

### Overview

The disclosed eMail Filter (eMF) is designed to monitor email messages and score them for “goodness of fit” to a predefined target domain model. Additionally, content is analyzed for other factors such as the mime type of the attachments. Messages scoring highly against the models (e.g., closely resembling the targeted concepts) and those containing images or other non-English text are routed for human review.

eMF was designed and developed to loosely couple with the Zimbra Collaboration Suite (ZCS). However, the use of standard libraries and communications protocols make eMF capable of being used with other eMail servers. eMF uses the virus checker/spam filter communication protocol. As far as ZCS is concerned, eMF operates and communicates like any other email filter.

For the purpose of the Gateway project, eMF has been tested extensively using ZCS Version 6.0.10 on Red Hat Linux 5.5. ZCS email functionality can be coupled with different email clients. However, the system was designed for, and has been tested using, Zimbra's web mail client. The scoring algorithm runs on the server as a daemon that is invoked for each email message. Depending upon the score, the message will either flow through to the intended recipient or be re-routed for human review. The reviewer's interface is also web-based. Therefore, the ZCS, eMF, and reviewer interface can be installed and run on a single machine.

As depicted in FIG. 28, the server with the eMF is to be located between two separate networks, with the purpose of transmitting “allowed” content between those networks. Suspected unallowable content will be flagged and held in suspense pending human review.

The system is intended to be coupled with other software packages such as ZCS and Apache Tomcat server in a secure environment. Apache Tomcat server is an open source webserver and servlet container developed by the Apache Software Foundation (ASF).

### Scope

The eMF can be run on a single machine or multiple machines. The machine(s) may be placed in a demilitarized zone (DMZ) as a gateway between two networks. Users sending and receiving messages are authenticated to the machine, and content to be sent is uploaded to the server, but does not flow beyond the server until it has either been automatically scored as being allowable, or has been declared allowable by a human reviewer. Therefore, disallowed content is stopped at the server and not disseminated beyond it. This allows the ability to control flow of information as needed.

User authentication is accomplished at the Zimbra-user level, thus only valid users are able to send, receive, and review messages. Only authorized reviewers may review messages.

The eMF software is designed to integrate with state-of-the-art pattern-matching hardware from NetLogic. These very-fast-throughput pattern matchers can achieve throughput of 10 GB per second. If needed for testing, a software module can emulate the hardware (e.g., while waiting for operating system upgrades, etc.).

### System Organization

The system has four major components, each made up of many modules. The two developed components are the eMF and the Reviewer Interface. The other two required components are ZCS and the authentication/validation software. As stated earlier, these can be collectively run on a single server, but may also be distributed for load balancing, security, and other operational reasons.

This description does not cover installation of the non-developed modules; information is publically available so that they can be installed correctly and are functioning correctly.

The eMF is made up of several modules: daemon (Gateway-Milter), content extraction, target pattern matching, target model scoring, message flow logic, and content highlight. The eMF is loosely coupled with the ZCS, as eMF receives a call for each message. The eMF is not unlike a virus scanner plug-in, and it uses the same communication protocol. One of the eMF processing byproducts is that the content of the message is highlighted based on the goodness of fit to the targeted models.

The Reviewer Interface allows a human reviewer to access the highlighted content via a web-based interface. The interface facilitates the review process and allows the operator to adjudicate the content and take action.

The components are loosely coupled, as they only share the location of the highlighted content. The eMF only suspends the flow of messages that require review; messages scoring below the user-defined threshold flow directly to the recipient's inbox.

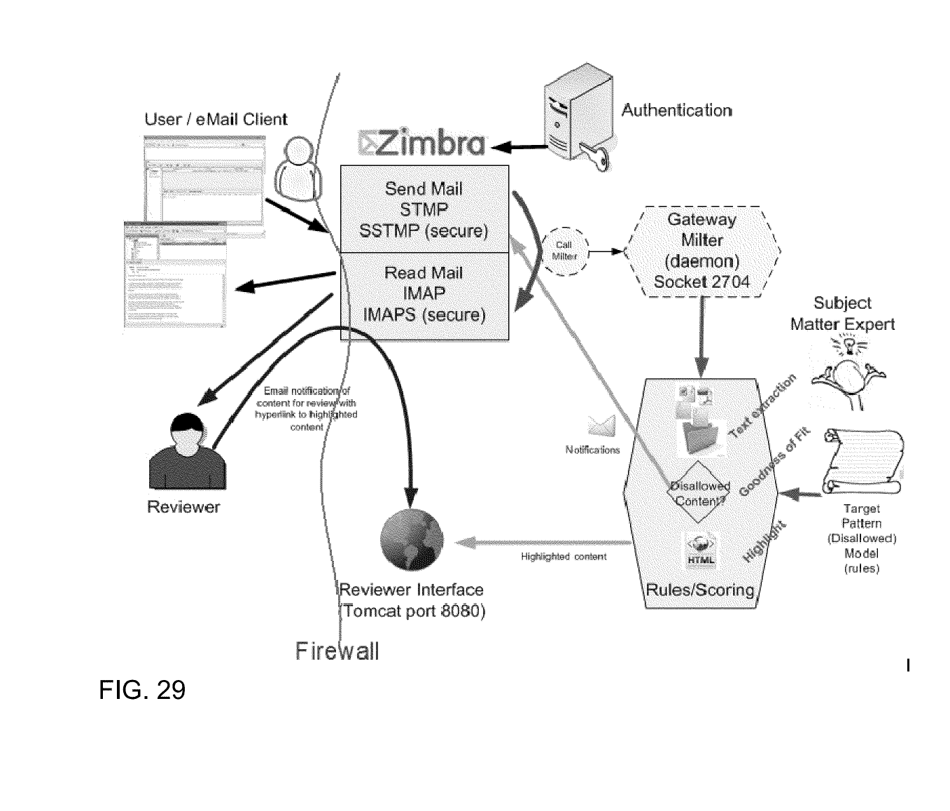

The workflow is depicted in FIG. 29. It begins with a user's creation of an email message with the appropriate classification markings. The message is sent through the ZCS interface, and the mail-processing module makes a call to the Gateway Milter daemon. This call is made in series with other filters, such as virus scanners and spam filters. The Rules/Scoring module first extracts the content. Then it does a simple pattern matching before calling the scoring algorithm.

Next, a message decision flow is consulted for the appropriate action for each message. A message and its attachments are analyzed together. The first step of the process is to unpack the original files, and then the “text” is extracted using the open source Apache Tika package. eMF does not analyze images and words with non-English text. Messages containing image files and those having a low ratio of English to non-English words must be routed for human review. The message is then either forwarded to the recipient's inbox or rerouted to a reviewer's inbox for adjudication. In the case of rerouted messages, there is a configuration option to inform the sender that the message has been delayed.

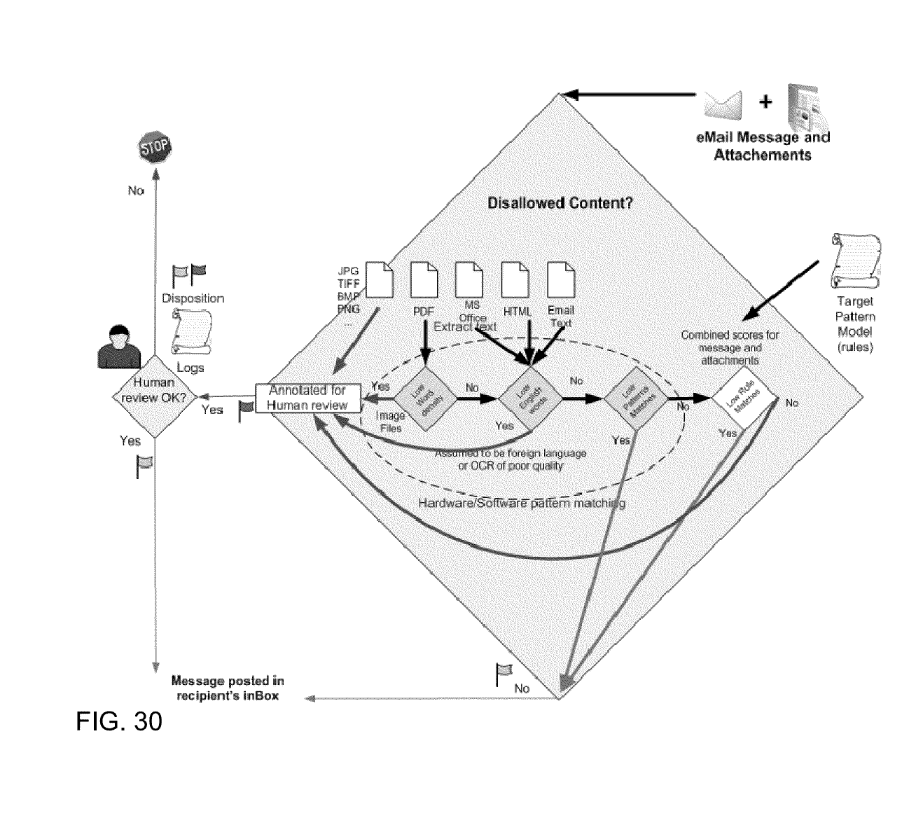

FIG. 30 provides an exemplary Message Scoring Flow. Rerouted messages remain in the reviewer's mailbox until action is taken. In one example, the action can be one of the following:
1. Approve and forward: The message does not contain disallowed content (i.e., is a false positive) and is delivered to the intended recipient(s).
2. Reject and reply: The message is not appropriately marked for classification and is returned to the sender for remarking.
3. Follow-up required, as dictated by site-specific guidance: The message contains disallowed content and therefore additional human action is required.

### System Description

i. Environment

The system uses a combination of open source packages, developed code, Apache Tomcat, and the Zimbra Collaboration Suite (ZCS). Because of ZCS dependencies and operational requirements, the software has been extensively tested on Red Hat Linux Version 5.5. The developed code runs on many other platforms, but it is dependent on the platforms that support ZCS. Infrastructure includes the following: Linux/Unix platform with Pthreads; ZCS Version 6.0.10+; Java Version 1.6+; HTML browser with JavaScript support, C, C++; Tomcat Version 5+; Sendmail/libmilter and eMF Distribution CD

ii. Features

The code was written in a modular fashion with unit-level testing and testing at the overall system level as well. Some of the major modules are documented below.

Rules:

Rules are built by a knowledgeable domain expert using a grammar that facilitates the definition and targeting of disallowed content. The syntax of the language and how it is used in scoring are documented in detail herein.

Scoring:

This algorithm transforms the user-written rules into machine-usable patterns that are sent either to the software emulator or the high-throughput pattern matching hardware. The choice to use the emulator or hardware is a user-configurable option, as documented herein. The results of the pattern matching are then coupled with complex domain rules for in-context scoring of matching terms.

Message Flow Logic:

The message flow module uses values from different algorithms, such as the “English” word ratio, the presence or absence of image attachments, and other content indicators, to decide whether the message contains disallowed content.

Gateway-Milter:

The gateway-milter daemon code runs continuously, listening to requests and email messages being sent, from the ZCS. Once a request is received, it spins off a separate thread to handle that request. In this manner, the processing of one message should not delay the delivery of another. The software emulator is not as fast as the pattern-matching hardware. Messages are processed in parallel, up to the maximum number of threads specified in the configuration file.

Derivative Classifier (DC) Review Tools:

The review tools are the modules that a human reviewer will use to adjudicate the contents of suspected messages. The interface is web-based and uses the Zimbra email client interface. The account is a special “reviewer” email account and actions taken within this account have special meaning. If a reviewer “forwards” the message, it is interpreted by eMF as the reviewer stating that the message is no longer suspected (e.g., the system has encountered a false positive). If the reviewer “replies” to a message, the message goes back to the sender for a classification marking correction, and if it is deemed to contain unallowable content, the message may be kept for future reference/action. In addition to containing a standard inbox, the reviewer account may have additional email folders to hold adjudicated messages. Suspicious content in each message is highlighted, as described below.

Highlighter:

The highlighter tool highlights the targeted content in the context of the original file. It uses results from the pattern matching as well as the goodness-of-fit results from the scoring algorithm. It displays the file in an HTML browser with hyperlinked and highlighted text.

Inventory:

Setup software and applications are contained on a Distribution CD with eMF software including all required third party open source software and libraries as well as all the code for Reviewer interface. This distribution disk assumes that the other required packages have been installed. This CD contains sample unclassified rules and testing material.

eMF Installation:

The gateway-milter and other modules do the email content scoring, redirection of emails, and notification to the user that the email has been redirected. The gateway-milter is based upon the design of the Clam Antivirus software and the Libmilter API software, which is part of the sendmail 8.14.4 distribution which is publicly available as open source. The documentation for the Libmilter library can be found the milter website.

Preparing for Installation:

It is assumed that ZCS 6.0.10, Apache Tomcat 6 or newer, and Java JDK 1.6 or newer are installed and configured properly. Test of the functionality of these packages is preferably done prior to eMF installation.

User accounts must be created and passwords assigned. Also, the Linux account “zimbra” is the owner of the installation directories and other zimbra work files. Ideally the installation location is the default “/opt/zimbra” directory.

Testing for ZCS, sending a simple email message can be used. This test will walk through all the paces of login, email composition, and email reading using the ZCS web interface. User validation/authentication is required, and only valid users will be able to get to the ZCS web mail interface. Any issues encountered should be resolved before proceeding.

Testing for Tomcat, using a web browser to open the default URL will verify proper functioning. Furthermore, Tomcat should be set up to run under the Linux zimbra user account. How this is done depends on the way Tomcat is installed. For example, for “package” installations a configuration value (TOMCAT_USER) needs to be changed to zimbra. In others, the Tomcat process needs to be started from the zimbra account.

Testing for Java, the “java—version” command on a terminal window will verify that it is configured correctly. The first line of the output should be something like: java version “1.6.0_{—}24”. Output such as “command not found,” and “java not recognized,” indicates that Java is not properly installed.

Gateway-Milter Installation:

The recommended location of the gateway-milter installation is “/opt/zimbra/data/output” assuming that zimbra is installed in the default location “/opt/zimbra”. An alternate location is possible. Similarly, special accounts such as “dc_scanner” and “special” are created on the ZCS system. The configuration file in the installation directory reflects these values. The configuration file also specifies the location of the Tomcat server. This value is updated prior to installation. Also, if the default location is not used, several test scripts are updated to reflect the chosen installation directory.

Scripts that are to be updated are:
gateway_install/sbin/score.sh: The GATEHOME variable should reflect the eMF installation location.
gateway_install/LinuxScoreDist/distGateway/compile.sh: The MAINHOME variable should be updated. The default value. “/opt/zimbra/data/output” can be used for a default installation. This is the folder where all the data files for scoring and analysis are located, both software and data. This folder contains a subfolder for the “rules”, and other folders such as “results” where the highlighted content is stored for adjudication before it is moved to a permanent archival location. The MAINHOME folder is created by the installation script and the software and sample rules are installed at this location.
gateway_install/LinuxScoreDist/distGateway/testrun1.sh: The MAINHOME variable should be updated

ZCS to Gateway-Milter Configuration Parameters:

There are many parameters in the configuration file. The default values should work well, though any changes to these values should be carefully chosen before installation as they may have a significant impact on the correct running and communications between processes. After initial installation this file is located at /opt/zimbra/clamav/etc and the parameters can be modified to affect scoring and message rerouting.

Four parameters are involved in correct communication between ZCS and the milter daemon. They are: MilterSocket, TemporaryDirectory, OutputDirectory, and LogFile. Details for each are documented below.

The Milter socket value should correspond to the value that will be used after the installation script. In the sample command line depicted below, the value 2704 should be consistent. This value was chosen because it is in the proximity of the other filter daemons, and does not conflict with other standard installed Red Hat Linux packages.

postconf -e ‘smtpd_milters = inet:127.0.0.1:2704’
MilterSocket inet:2704

The next three values are used for logging, processing, and the location of analysis output files. The recommended installation values are depicted below, assuming that Zimbra is installed in the default “/opt/zimbra” location. Adjust as necessary for the local environment.

TemporaryDirectory /opt/zimbra/data/tmp
OutputDirectory /opt/zimbra/data/output
LogFile /opt/zimbra/log/gateway-milter.log

### Gateway-Milter to Scoring Configuration Parameters:

The values listed in this section are used for scoring and can be updated after installation by editing the configuration file. These parameters are used in the communication between the milter and are crucial to the scoring process.

DerivativeScanner is the name of the account where suspected email messages would be rerouted. This account should be a zimbra email account. Notice that there is only one Derivative Classifier account value. All suspect messages will be routed to this account.

# The id of the derivative scanner.
DerivativeScanner dc_scanner

ScoreScript identifies the scoring script that will be invoked for every message to be processed. The output of this script is passed back to the miller. Warnings and other messages generated by this script are logged to the milter log file identified in the previous section.

# The path and fname of the scoring script to execute.
ScoreScript /opt/zimbra/clamav/sbin/score.sh

Messages that score higher than the ScoreTrigger value will be rerouted for human review. This value needs to be carefully chosen and must be correlated to the rules used in scoring. Refer to Section 0 of this manual for more information.

#The score trigger on which the scoring script will be executed
ScoreTrigger 250

EnglishPercentThreshold is another trigger parameter, the ratio of English words vs. non-English words. If this ratio is below the number indicated by this value, the message is rerouted. The scoring works well with good English text, but OCR or foreign language documents should be reviewed by a DC.

# English Percent Threshold, a calculated score that scans all
# words in the content of the email and to see if its one of
# the 5000 most common words. The byte count is used to
# create a ratio of those words against all words in the
# document, aka English byte coverage.
EnglishPercentThreshold 60

SpecialAddress is used by the DC Reviewer to identify false positives. Those messages deemed to be false positives will be “forwarded” by the DC Reviewer to this special address to indicate that the message should be released.

#The special address that the derivative classifier will send the
email to.
SpecialAddress special

Hyperlink is the string associated with the URL for the DC review browser. This value is added to the top of each message rerouted for review. This is a web-based URL that points to the installation location of Tomcat and the linked results directory under Tomcat. The unique ID of a message is added to the value in this line to create the hyperlink added to rerouted messages. This is the hyperlink a DC reviewer will follow to review the contents of a suspected message. The value the hypertext transfer protocol (HTTP) is localhost:8080 should reflect the values to be used at this particular site. The value as shown here may only be appropriate for testing.

#The path and name of the hyperlink for Tomcat.
Hyperlink http://localhost:8080/dcReviewBrowser/?

### Restarting the Gateway-Milter:

After any change is made, the gateway-milter process must be restarted using the following commands executed by the “root” user:

ps -ef | grep gateway-milter
kill -9 <process-id>

where process-id is that of the gateway-milter

/opt/zimbra/clamav/sbin/gateway-milter

### Installation Script

The installation script (install.sh) needs to reflect three values as intended for installation at this site:
INSTALL_DIR, DEPLOY_TO, and TOMCAT_DIR

To verify that these values are set as intended, edit the “install.sh” script located at the top level of the installation directory as copied from the distribution CD. Suggested values can be included in the distribution install.sh script.

INSTALL_DIR is the location of the installation files. This is the destination directory for copying the contents of the distribution CD. This directory is transient and therefore can be erased after successful testing has been completed.

DEPLOY_TO directory is the location for software deployment. If changed from the recommended value as provided in the distribution CD, it should be changed in the other scripts. Furthermore, all instances of this value must be changed in the configuration file.

TOMCAT_DIR is the top level Apache Tomcat directory. At this level, the webapps, bin, etc. folders are located. The Tomcat setup allows the hyperlinks to be able to refer to the URL that will display the highlighted content. This directory is dependent on the installation and has no default location. The recommended value is:
/opt/tomcatX

where X is the version of Tomcat.

### Installation Instructions

The distribution disk contains a folder named gateway_install.tar.gz it should be unpacked to “/opt”. Beware: the opt partition might be too small for the eMF code and zimbra. If this is the case, create “opt” under “/local” and create a symbolic link from “/”.

cd /local
mkdir opt
cd /
ln -s /local/opt opt

The entire /opt/gateway_install/README file disclosed herein include a few salient points of the installation procedure as it directly relates to the milter process. The “postconf” command is the one that registers the milter with postfix as listening on port 2704 of the local machine. Prior to installation, shut down Zimbra.

su zimbra
zmcontrol stop

Copy the folder gateway_install to /opt.

cd /opt/gateway_install
./install.sh

After the script runs, execute the following commands:
To permanently turn off default sendmail, the following command should be run once.

chkconfig sendmail off
su zimbra
cd /opt/zimbra/postfix/conf
postconf -e ‘smtpd_milters = inet:127.0.0.1:2704’
zmcontrol start

Exit from zimbra account to root,

cd /opt/zimbra/clamav/sbin
./gateway-milter

At this point the gateway milter software should be running and filtering content.
The Tomcat server should be restarted at this time.

### Configuration

Access Control: Zimbra and Tomcat operations should be executed from the “zimbra” Linux account. This account should also be used to make configuration changes.

The milter process should be started from the “root” account.

Configuration Files The main configuration file will be in /opt/zimbra/clamav/etc/gateway milter.conf. This file can then be updated if installation values change later on.

The whitelisted_addresses file contains a list addresses that will be ignored by the scanner. It is beneficial if this list is correct and complete, as otherwise, messages can be misrouted (e.g., allowed to pass through unscanned or get loop back to the reviewer repeatedly. These also include addresses for system messages and other internal routine mail messages. It is located at:
/etc/whitelisted_addresses

### Zimbra Timeout Configuration:

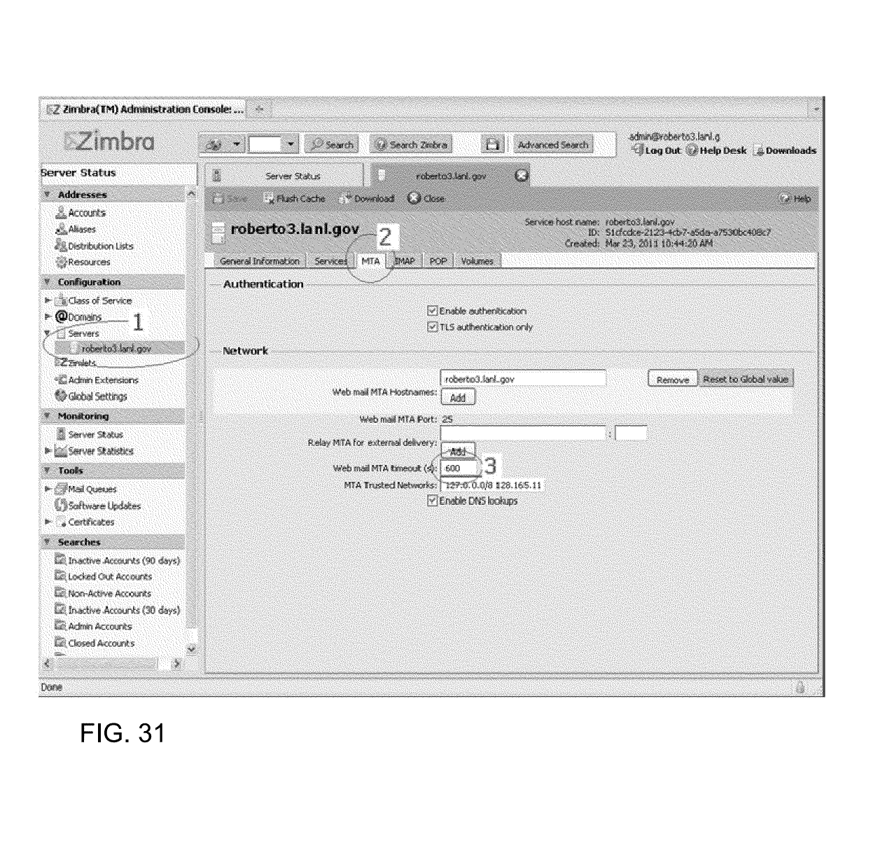

Messages are not accepted by the system until scoring has been completed. The default Zimbra system timeout may be too short to accommodate messages that are very large messages. As a result, the web interface will indicate that the message was not received by the system, when in fact it may have been processed correctly. This usually occurs with messages with very large attachments. To address this issue, it is recommended that the following Zimbra option be set accordingly. As shown in FIG. 31, below, this is done within the Zimbra Administrator web interface via the following steps:
1. Choose this Zimbra server,
2. Select the MTA tab
3. Replace the “web mail MTA timeout (s):” from 60 to a number higher depending on the expected size of files to be sent. As shown 600 (10 minutes will allow processing of very, very long files). A smaller number, such as 300, may be adequate.

### Temporary Files and Archival of Analysis Folders:

The eMF process generates a series of temporary files and analysis folders that should be periodically removed and/or archived. Files located in /opt/zimbra/data/tmp and /opt/zimbra/data/output/process should be cleaned after 24 hours. Folders in the /opt/zimbra/data/output/results folder should be archived for future reference. These folders contain the expanded attachments, text extracted from files, highlighted content and scoring information. These folders have a unique name with the form of msgYYMMDD_#######_dat. These files are the ones referenced by the hyperlink provided for the reviewer in the messages rerouted to their in-box. It is beneficial to give the reviewer ample time to adjudicate the message, such as not less than one week after the message was sent.

Suggested Linux commands are as follows:

rm -rf ‘date -date=’1 days ago’ +’/opt/zimbra/data/tmp/msg%y%m%d_*’‘
rm -rf ‘date -date=’1 days ago’
+’/opt/zimbra/data/output/process/msg%y%m%d_*’‘
mv ‘date -date=’7 days ago’
+’/opt/zimbra/data/output/results/msg%y%m%d_*’‘ <archive-folder>

These commands should be part of a cleanup script to be run on a daily basis for cleaning up and archiving following site specific guidance. Notice should be taken in the use of forward and backward quotes and spacing as show in the commands listed above.

### Errors, Malfunctions, and Emergencies:

ZCS and Tomcat management documentation is beyond the scope of this manual. The only new process is the gateway-milter. The best way to clear-up errors is to systematically check the packages for basic functionality. Start with Zimbra, it is best to use the “zmcontrol” function. As zimbra execute the “zmcontrol status” command to verify if all the zimbra modules are operational. If not this should be resolved first. Second, the milter should be restarted as a precaution as instructed below.

To check to see if the milter is running, use the following command:
ps −ef|grep gateway-milter
   This should display a process called gateway-milter and should be running. If it is not running, then start it by using the commands (as root):

cd /opt/zimbra/clamav/sbin
./gateway-milter

If you suspect that the milter is hung, it can be restarted by first killing the process identified by the “ps” command listed above, and then starting it again. One indication of a hung miller is the inability to send emails. If the miller is not running, a correctly configured ZCS/eMF system will not allow messages to flow.

By default the milter is not configured to run at system start time and should be set up according to each site's start-up procedures. It may be appropriate to use “/etc/init.d” scripts for this purpose.

The same procedure used to restart a hung milter should be used if changes are made to the configuration file.

Start-up or run time errors are written to the log files listed below. If problems occur, consult these two logs for error indicators.

Zimbra has many different error conditions and they will change with newer releases. However, it should be noted that once the milter is installed, mail will not flow through Zimbra unless the milter is running correctly. This is a fail safe condition; that no email will flow unless it has been scanned. Therefore, if mail can not be delivered (it can be composed but an error occurs when sending) the milter may be the problem. One can look at the milter log file to see is some error is condition is recorded, then as a precaution the milter may be restarted and try sending the message again. A simple text message should be used for basic testing first. If the milter process dies after each test then eMF support should be contacted for in depth guidance.

### Log Files and Messages:

/var/log/zimbra.log
/opt/zimbra/log/gateway_milter.log

The zimbra.log file contains Zimbra-specific messages and may have indicators of Zimbra installation problems.

The gateway_milter.log file contains detailed entries about the messages are they are being analyzed. It can be monitored in real time by using the “tail-f” command. This is useful for testing installation.

### Rules and Scoring

Rules can be used for defining the targeted concepts and determining the goodness-of-fit of a document's text to those concepts. Rules reside in the /opt/zimbra/data/output/rules folder. Changes to the rules file should be made in this directory and require a “recompile” of the rules. This process preprocesses the rules and optimizes them to be used in real time filtering. The script to compile the rules is located at /opt/zimbra/data/ouput/distGateway folder, and it is called compile.sh. Changes to the rules and execution of the script should be done under the zimbra account.

The main command is:

java -cp $MAINHOME/distGateway/lib:$MAINHOME/distGateway/Gateway.jar
lanl.gov.managers.RuleCompileManager -ruleFile $MAINHOME/rules/TRECrules.txt -
output $MAINHOME/rules/hwwords.txt -report

The -ruleFile parameter specifies the input rule file. This is a text file that follows the syntax described below. This file can have any name and location. The -output parameter is the location of the preprocessed rules file. This file is referenced by other scripts and therefore should maintain the name and location as specified in the compile.sh script. The compile script can be invoked as many times as needed to compile changes made to the rules. This should be an iterative process of rule development and testing. For rule testing there is a runtest1.sh located at same location as the compile script. This allows of line testing of rules and scoring. A correctly configured runtest1.sh requires only the name of the input file. The output is stored in the “/opt/zimbra/data/output/results/<file_name>.” For testing purposes the <file_name> folder should be deleted. This is not an issue when running the milter as it generates a unique name for each message.

The two main types of the rules are: concept rules and weighted rules. Concept rules are used to define words and/or phrases. The main purpose of this type of rule is to group conceptually-related concepts for later reuse. Concept rule blocks begin with the label “SYN” and end with “ENDSYN”. Weighted rules are used to assign a specific weight to one or more concept rules. Weighted rule blocks begin with the label “WF<weight function parameters>” and end with “ENDWF”. They are usually comprised of one or more references to concept rules. Only the weighted rules contribute to the total score of the document when they are matched.

Concept Rule Syntax

Every concept rule definition must start with the following:
SYN <Rule Name>
   where <Rule Name> is a unique identifier of the concept rule that will be used for expansion of other Concept Rules. The value of <Rule Name> may include special characters and may be a single-word or multiword string. For simplicity, it is best to use single words in CamelCase or use a “_” in place of spaces.

Every rule definition must close with the following line:
ENDSYN
   Rule lines can be constructed with single words or multiple words (phrases). Words may appear in any order on the line; word order does not constrain matching.
blue line
   will match in the following text:
“The line connecting these two points is in blue.” (1)
   As well as:
“The water is so blue that it's hard to find the line where the sky meets the ocean.” (2)
   Rule lines may contain regular expressions.
warm\w* days?
   In the line above, the regular expression “\w*” means “match any zero or more word characters,” meaning that “warm” may be followed by any number of letters, and “day” is optionally followed by an “s?”.
   This rule line matches all of the following sentences:
“The water in the lake is warmer with every day.” (3)
“I look forward to the day when it's warm enough to wear shorts.” (4)
“Warmer days are much anticipated.” (5)
“Today is a warm day compared to yesterday.” (6)
   If word order is important, the phrase must be contained within double quotes. For example:
“warm\w* days?”
   will match sentences (5) and (6), shown above, but not sentences (3) and (4).
   It is recommended that rule writers think carefully when using “\w*” because wildcards can often match in unexpected contexts. For example:
plan\w*
   will match “plan”, “plans,” and “planning.” It will also match “plane,” “plant,” and “planet.” It is also possible to require that all elements of a set of two or more words appear within a particular syntactic locality. The supported locality constrainers are listed below, in descending order of restrictiveness:
   Document locality, which is activated with the following rule syntax:
d:(<words and/or SYN references>)
   The word list enclosed in a document-level locality translates to requiring that all of the words in the list appear within the document.
   Paragraph locality, which is activated with the following rule syntax:
p:(<words and/or SYN references>)

The word list enclosed in paragraph-level locality translates to matching all of these words within the same paragraph. A paragraph is defined as a series of words or numbers ending with any one of {‘.’ ‘!’ ‘?’}. By default, paragraphs are limited to having no more than 10 sentences. Sentence locality, which is activated with the following rule syntax:
s:(<words and/or SYN references>)

The word list enclosed in sentence-level locality requires that each of the listed words appear within the same sentence. This is the DEFAULT locality; if no locality is specified, and the words do not appear in double quotes, each of the specified words must appear, in any order, to trigger a match to the specified definition. By default, sentences are limited to having no more than 30 words.

Clause locality, which is activated with the following rule syntax:
c:(<words and/or SYN references>)

The word list enclosed in clause-level locality requires each of the words to appear within the same clause in order to count as a match for this rule line. A clause cannot be longer than the sentence that contains it and are therefore limited to having no more than 30 words.

A primary purpose of SYN rules is to group concepts that are related to one another in some meaningful way so that the SYN can be incorporated into other SYN rules or weighted rules. Each line in a SYN rule definition is considered to be interchangeable with each other line within the same rule definition. Once a rule is defined, it can be reused in other rule definitions by referring to its unique name. If the rule name is one single word, without any spaces, it can be referenced by preceding the name with an equal sign (‘=’) anywhere in rule definition lines:

# Initial declaration, can be placed before or after its
intended reuse
SYN huge

huge
monstrous
humongous

ENDSYN
# Reusing previously declared rule in combination with
# other words
SYN big

big
large
=huge

ENDSYN
SYN weather

weather
hail
sleet
snow\w*

#don't want “rainforest” here, so explicitly articulate
this.

rain
raining
rained

ENDSYN
# Defining something that might deserve weighting later
SYN Horrible Weather

# The reference to another rule also can be used in any
# of the locality boundaries with or without other

words,

# phrases, or SYN references.
# It might be good to define a SYN for “horrible” as

well.

c:( horrible =weather )
c:( =huge storms?)
typhoons?
hurricanes?
tornadoe?s?

ENDSYN

If the rule name contains empty spaces in its name, the following syntax must be used:

SYN BadWeather

c:( bad weather )
storm\w*
=HorribleWeather

ENDSYN

### Weighted-Rule Syntax

Weighted rules are collections of one or more concepts, with a weighting function assigned to each collection. The syntax is generally the same as for a concept rule, except that these rules are meant mainly for re-usage of concept rules, as they do not have any unique name identifier. As mentioned before, their primary use is to define the weight function by which the included concept rules will contribute to the total score of the document.

There is a variety of weight functions were made available for defining how the rule in weighted. They are:
CONST, for a constant weight applied each time the rule line is matched in the document.
SLOPE, to allow for a successively increasing or decreasing point increment with each successive occurrence of matching text in the document.
STEP, to allow the rule writer to explicitly articulate the point increment for each successive occurrence of matching text in the document.
   All weighting function blocks being with “WF” and end with “ENDWF.” The weighting functions are described in more detail below.
   Consider the following text as it is scored by various weight functions.
“It seems that the weather was bad around the globe last week. There were a number of huge storms on the East Coast of the U.S., a hurricane off of the Texas coastline, and numerous typhoons in Asian waters.” (7)

CONST
A constant weighting function assigns the specified number of points each time the rule is matched in the text of the document.
   CONST weightConstant
means that the points contributed by and rule line contained in the WF block are described by the following equation:
   increment=numHits * weightConstant
All lines in the file that are not surrounded by either SYN or WF enclosures are treated as CONST with the weightConstant defaulting to 1.

For the weight rule:

WF CONST 5
=BadWeather
ENDWF

text (7) would be scored with five points for each of the four matches to the rules associated with the concept rule “Bad Weather,” for a total of 20 points.

Similarly,

WF CONST 25
=HorribleWeather
ENDWF

would yield a score of 75 points, based on matching three instances of “Horrible Weather” (“huge storms,” “hurricane,” and “typhoons”).
Negative weightings are allowed, and are for dampening the impact of “known bad” contexts. For example, “the Miami Hurricanes” and “Snow White” are unlikely to be a reference to weather of any sort.

WF CONST −25
“Miami Hurricanes”
“Snow White”
ENDWF

SLOPE
SLOPE slope offset
means that the points contributed by and rule line contained in the WF block are described by the following equation:
   increment=slope*(numHits−1)+offset
The default values for slope and offset are 0 and 1, respectively. Thus, the weight rule

WF SLOPE
=BadWeather
ENDWF

would yield a score of 0* (4−1)+1=1 point.
If, instead, the rule was defined as

WF SLOPE 3 0
=BadWeather
ENDWF

the score would be 3*(4−1)+0=9 points.

STEP
Step functions are designed to allow for specific amplification or dampening of a set of rules for each successive match.
   STEP step0 step1 step2
means that the points contributed by and rule line contained in the WF block are described by the following equation:

if (numHits<=numSteps) increment=Σstepᵢ, for i=1 to numHits−1(this translates to step₀+step₁+ . . . +step_{numHits-1})

else

increment=step₀+step₁+ . . . +step_{numHits-1}+step_{numHits-1}*(numHits−numSteps)
Each match increments the score by the value of the step associated with the match count for that match, until the match count exceeds the number of declared steps. One the number of matches exceeds the number of steps, the point increment is the same as the last step weighting for that and all subsequent matches.
   STEP 10 5 3 2 1 0
means that the first match contributes 10 points to the score, the next one contributes 5, etc., and that all matches beyond the 5^{th} contribute nothing.
The rule

WF STEP 10 5 1 0
=BadWeathers
ENDWF

would contribute 10+5+1 points to the total score of test (7).

### DC Reviewer Interface

The DC Reviewer Interface provides the Derivative Classifier with access to the suspected content via a web-based interface. The directory for each message contains the analyzed files that are needed to adjudicate the messages that scored above the predefined limit. The interface can be easily accessed through the provided link in any redirected message. The original message, extracted text, and any attachments, are accessible through the interface. Package files such as zip, tar, gzip, and bzip are expanded into folders so that the reviewer can see their raw content by following the links provided within the interface.

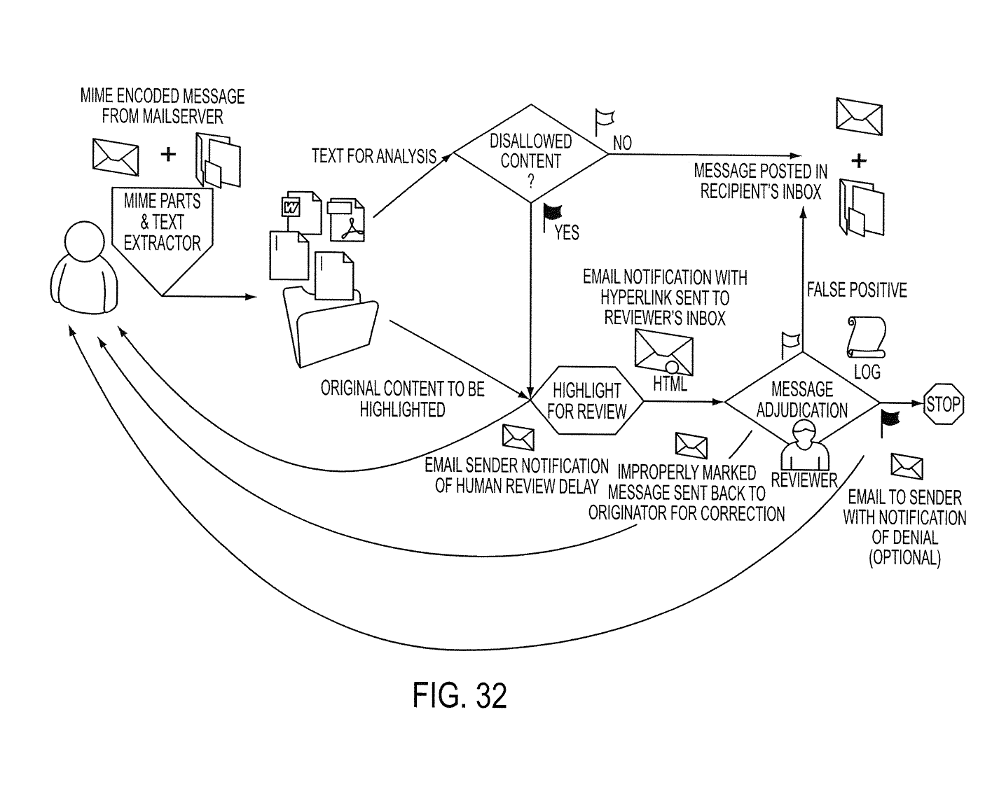

An overview of the process is depicted in FIG. 32. The process begins when the original sender generates a message using the ZCS web interface. The contents of the message and any attachments are expanded into a directory on the server. Then the text is extracted from each of these files and combined into a single text file that is then scored by the eMF. Those messages that, in their combined text file, score higher than the threshold are routed for human review. Also, during the expansion process, attachments such as images and other audio/video formats are flagged for human review.

If a message scores higher than the threshold or contains unsupported formats, the message is routed for review. At this time, the possibly-disallowed content, in context, is highlighted, to facilitate a rapid review of the message. The re-routed messages are sent to a special account as defined in the configuration file. The email message contains a hyperlink to the material for review. The DC then reviews the content and decides what action to take. If this is a “false positive,” the reviewer may allow the message to flow to the intended recipients. If the message is not properly marked, the message should be sent back to the original sender for correction. If the message contains disallowed content, the message is retained and not allowed to flow, requiring further actions outside of the eMF software.

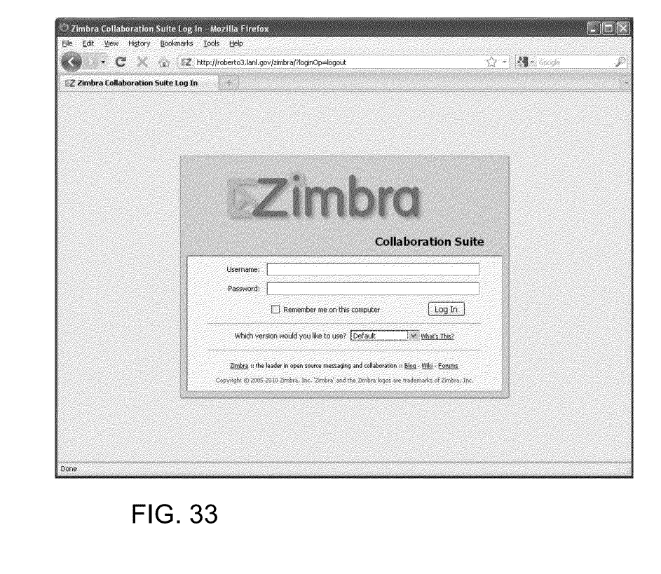

The DC reviewer will log on to ZCS using the web-based interface shown in FIG. 33. There is only one review account. This account must be created prior to system use, and it must correspond to the value stated on the configuration file.

The value to modify is called:

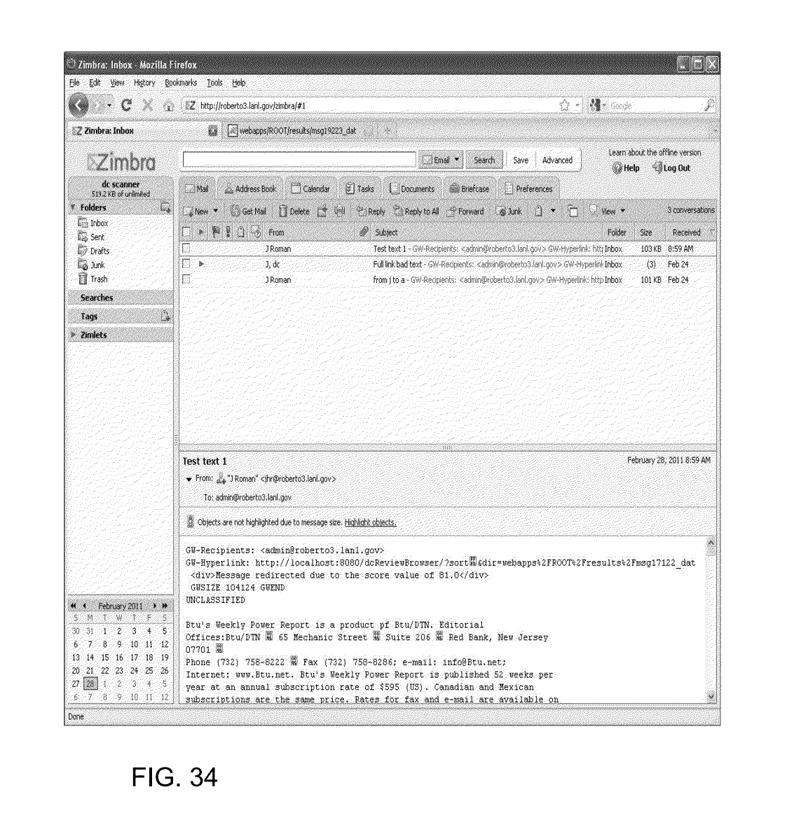

Logging into the system will bring up an unmodified web email interface under ZCS. As with any email, it will display the messages in the inbox, and give the ability to manage messages as well as to create other mailboxes as needed. Redirected messages are displayed in the interface. The actions taken on this account are interpreted by the eMF by the nature of this account. A sample inbox is shown in FIG. 34.

The top part of the web page displays a list of the incoming messages. In FIG. 34, the message highlighted at the top of the inbox is displayed in the lower pane. It contains eMF-added content such as the names of the intended recipients, a hyperlink to the content for review, and a brief message saying why the message was redirected, such as for having a high score or content that the eMF could not analyze. As depicted in FIG. 34, the large text file attachment causes Zimbra to require an additional click in order to activate the hyperlink.

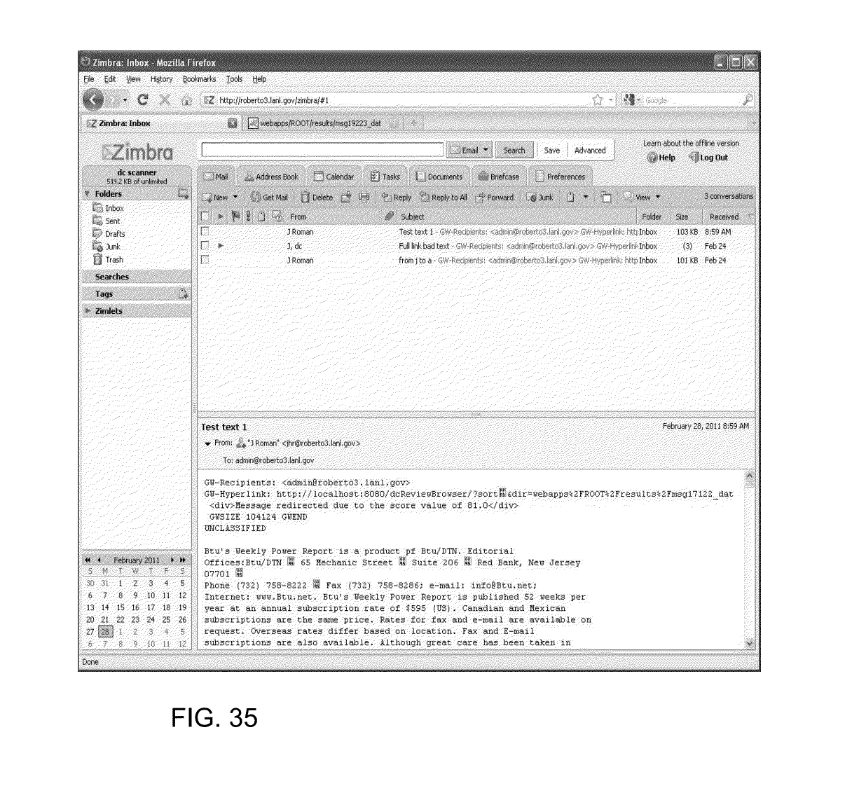

In FIG. 35, the same message is displayed and the hyperlink is now “clickable.” This extra step is only required for messages with a large body of text. All information added to the original email by the filter has a tag of “GW-”. These system-generated messages are documented later.

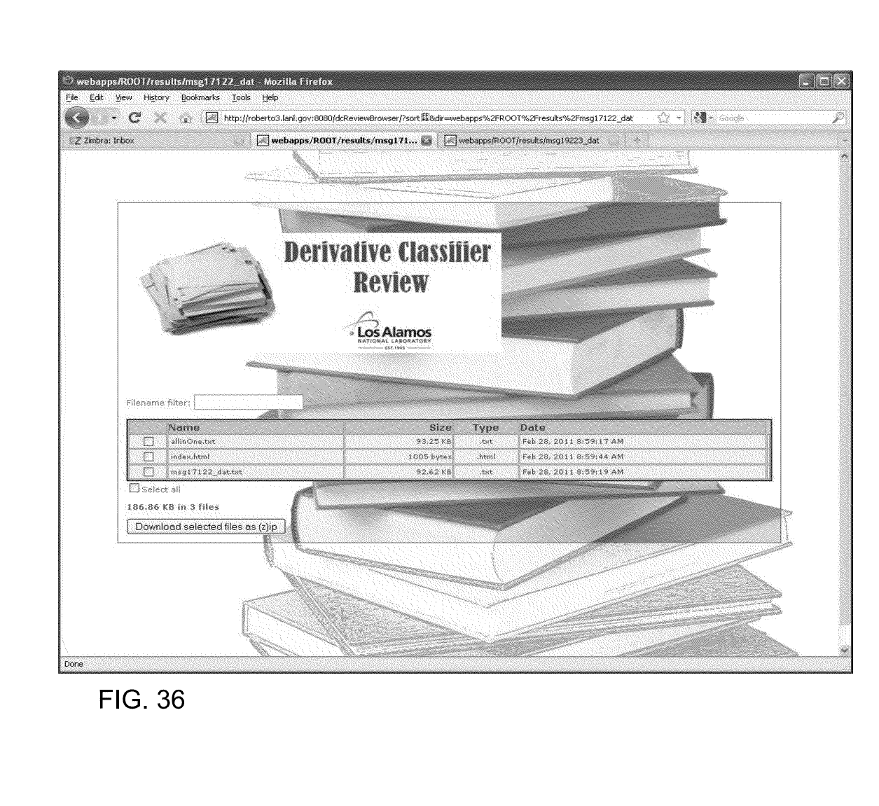

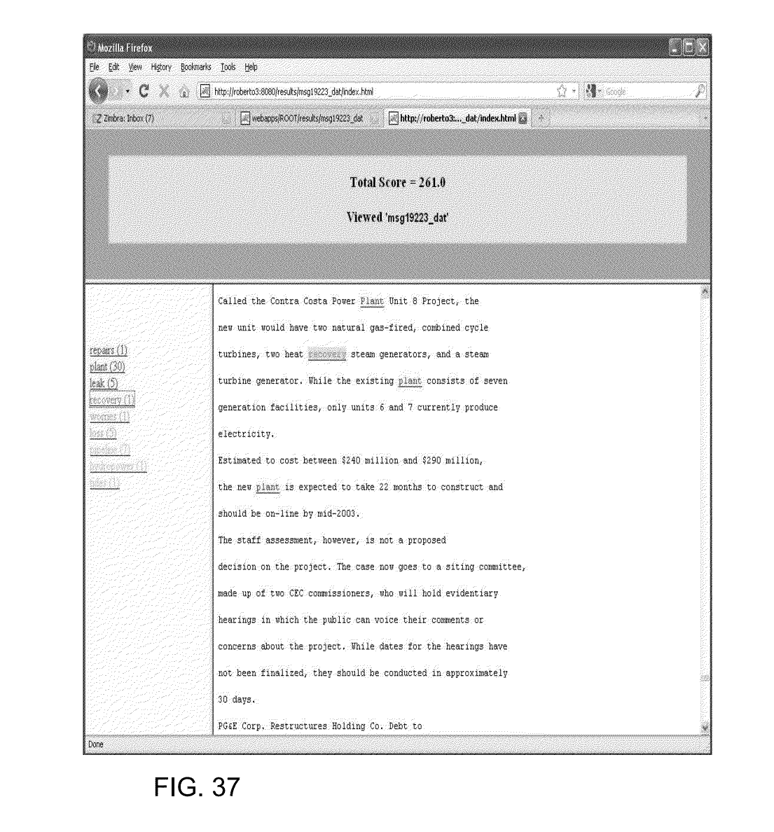

When they hyperlink is clicked, the user will see something similar to the image depicted in FIG. 36. This display shows three files for this message. One is the body of the message, second is the highlighted content, and finally the combined text. The associated “index.html” is depicted in FIG. 37.

In the top pane, the score and the system-generated email message identifier are provided. The pane on the left contains indices of the matched words that contributed to the scoring of the document. They are arranged from the highest-weighted rule (starting from the top) to the least significantly weighted rule. The color-coding of red to green corresponds to the contribution of a term in a context rule. The number in parentheses is the number of matches of that term in the combined text. Finally, on the right panel is the actual combined text content of the message.

The left index panel is interactive, allowing the user to navigate through the text to the first instance of a term in the text panel. The right panel also supports interactive mode; it allows users hit to hit navigation. A click on the right side of a term takes you to the previous instance of that term, if a previous instance exists. A click on the left side of a term takes you to the next instance of that term, if a subsequent instance exists.

Here is the list of commonly seen files in the viewed directory:
index.html
   This file contains highlighted text of the message in HTML format for easier evaluation of the contents and matched words/phrases. The file is accessible through the web browser. This file contains the text from the body of the email message and text extracted from all the attachments. The start location of each is delineated by “*** FILE: <filename>” and the end of the text for that attachment will have a “*** FILE END <filename>”. This helps the reviewer identify the source of the text displayed in this file.
<message_identifier>.txt
   The file contains all of the text content extracted from the message body and all of its attachments.
msg_body.eml
   This file contains the header and the text from the email only.
<directory_name>
   These directories contain the original files as extracted from an archive (Zip, Tar, GZip, or BZip) file that is attached to this message. If there are nested archives, the directory structure would represent that. These files are unpackaged to facilitate the review process.
<message_identifier>.txt.score (HIDDEN)
   The file contains rule definition and indexing information about matches in XML formatting for verification purposes. All of the listed matches are filtered, and every entry is an actual hardware word match that contributed to the score calculation.
<message_identifier>.txt.score.highlight (HIDDEN)
   This file was produced during the scoring process as an input file for the Highlighter package that generated index.html file.
<message_identifier>.bin (HIDDEN)
   This file is in binary format and is an output file from hardware that was used for further processing by the scoring subsystem.
web/ (HIDDEN)
   The directory web/ contains all of the templates, scripts, and style sheets that are required and used by index.html file.
   The reviewer then uses the ZCS email web interface to perform the adjudication of a message. There are four possible actions:
1. Leave message in inbox and adjudicate at a later time. Maybe outside consultation is required, researching the topic, etc. The message is held in suspense until one of the three actions below is taken.
2. Decide that the message is not marked appropriately. To execute this action, the reviewer simply “replies” to the message. In the body of the reply, which will go back to the original sender, the reviewer should note any comments, guidance, or other appropriate material to help the user correct markings or other classification issues for this message.
3. Decide that the flagging of the message is a “false positive,” that in reality the message only has “allowed” content. To take this action, the reviewer uses the “forward” button on the ZCS web interface and specifies “special” in the “To:” field of the outgoing message. No other changes or modifications should be made to the message as these will be removed.
4. Decide that this message contains unallowable content. This requires actions outside of the system that are not documented here, as guidance and policy will vary from site to site.

For options 1 to 3 the message could be moved to another Mail folder created by the reviewer to denote action taken, pending action, or other ways of organizing the messages as needed by the reviewer.

Sample error messages and their interpretation are depicted below. Only messages that require adjudication are rerouted to the DC Reviewer. Rerouting occurs for several reasons. A snapshot of the message as it is displayed in the ZCS web mail window is shown.

At the top of the message sent to the reviewer, there is a hyperlink to the details for that message, and following the hyperlink is a brief explanation of why the message was rerouted. The possible conditions that reroute a message are as follows:

1) The message contains disallowed content

2) The message contains unsupported file formats

3) The message contains foreign language or jumbled text

4) A software processing error occurred.

The reviewer may need to take different action depending on the condition of the rerouted message. If the reviewer determines that this message does contain disallowed content, he or she should follow site-specific guidance. Otherwise the reviewer may determine that the message is a false positive and should be allowed to flow through the system or sent back to the originator for changes. The system-generated messages that may appear at the top of the rerouted message are displayed below. Following these messages there may be additional information such as the file names of offending attachments and/or the programming error codes.

### Email Message:

“There is probable disallowed content in this message based on a score of ###.##”

Condition one means that the goodness of fit for the disallowed model is higher than a configuration threshold and therefore the system suspects that it is disallowed content.

### Email Message:

“This message contains images or non-supported file formats. Those attachments could not be assigned a score.”

Condition two signifies that the body of the message or one or more of its attachments contains files in non-supported format for text extraction. These are files such as images, audio and video, or other special formats. A list of the offending files follows the message for this condition. The reviewer should carefully consider all factors such as scoring and the content of image and other files to make a decision.

### Email Message:

“A score could not be assigned to an attachment to this message. Some part probably contains foreign language or jumbled text.”

Condition three signifies that text extracted from the body of the message or one or more of its attachments does not look like English text. These may be spreadsheets, files that used Optical Character Recognition (OCR) to extract text out of images, or those in a foreign language. As for condition two, the reviewer should carefully consider all options and decide if this is allowed or disallowed content.

### Email Message:

“There was a program error in processing this message.”

Condition four signifies that there was a software error in processing this message and scoring and other analysis may be unreliable. The data available in the review interface may still be good, but may not be complete, in which case the reviewer should carefully examine the message and decide what action to take.

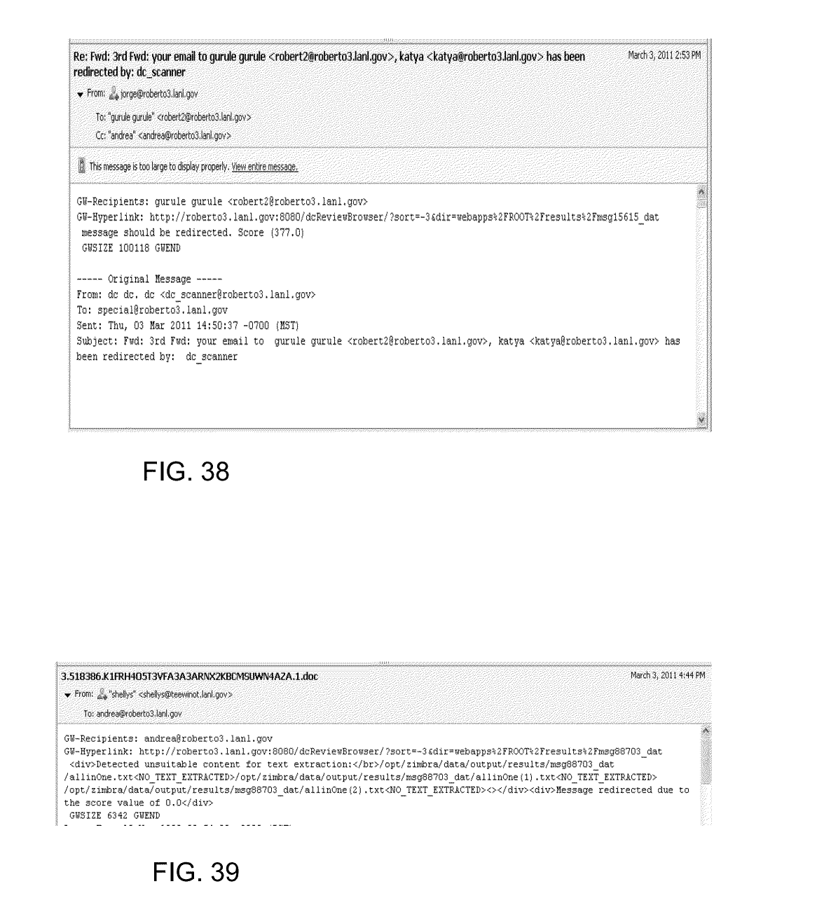

FIG. 38 shows a typical rerouted message. It contains no attachments, but the body of the message scored 377.0 (red oval), which in this case was above the 250 trigger score threshold. The sender and intended recipient information is located at the top of the message, as marked with a green oval, above.

FIG. 39 shows a message from which no text could be extracted. Again, this will force a message to be rerouted because the eMF could not consistently score this message.

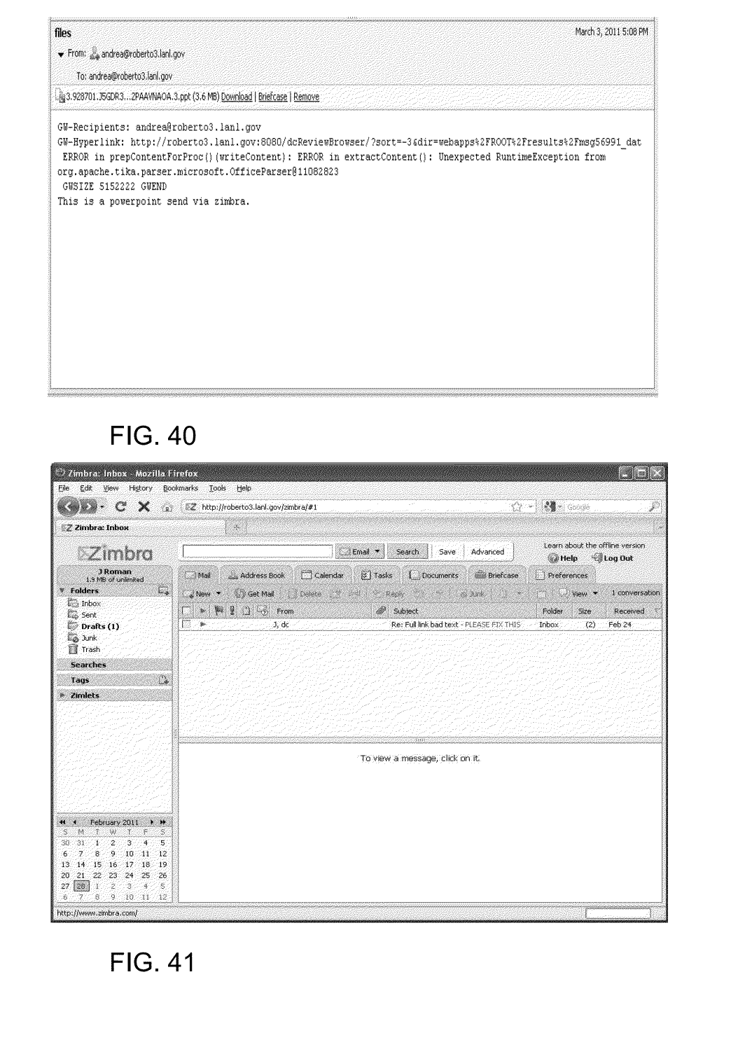

FIG. 40 shows a PowerPoint attachment that eMF could not analyze, and thus it is routed for human review. The blue oval indicates the attachment for this message. The red oval with the text:

ERROR in prepContentForProc( ) (writeContent): ERROR in
extractContent( ): Unexpected RuntimeException from

org.apache.tika.parsermicrosoft.OfficeParser@11082823
   indicates that an error occurred in this case in the extractContent module, and it was a Microsoft Office error. If this problem persists, it should be addressed by support personnel. Otherwise, it simply means that eMF could not reliability score this message and therefore it should be reviewed by a DC. Specifically this, particular Powerpoint file was created using a very old Office 95 format.
   eMail User Notes

Various actions can be taken by the system for messages generated using ZCS and eMF. It should be noted that email messages that flow through this system will be filtered for unallowable content. These messages and messages containing audio, video, and images will be redirected for human review and therefore be delayed. Similarly, content that is not marked appropriately may be delayed pending review. Therefore, it is encouraged that users will carefully select the material including attachments to be sent, and ensure they only contain “allowed” content and are marked appropriately.

Email users will log on to the system using the site-specific provided URL. This will prompt the user for account name and password. Once these have been provided, a screen, like the one depicted in FIG. 41, will be displayed.

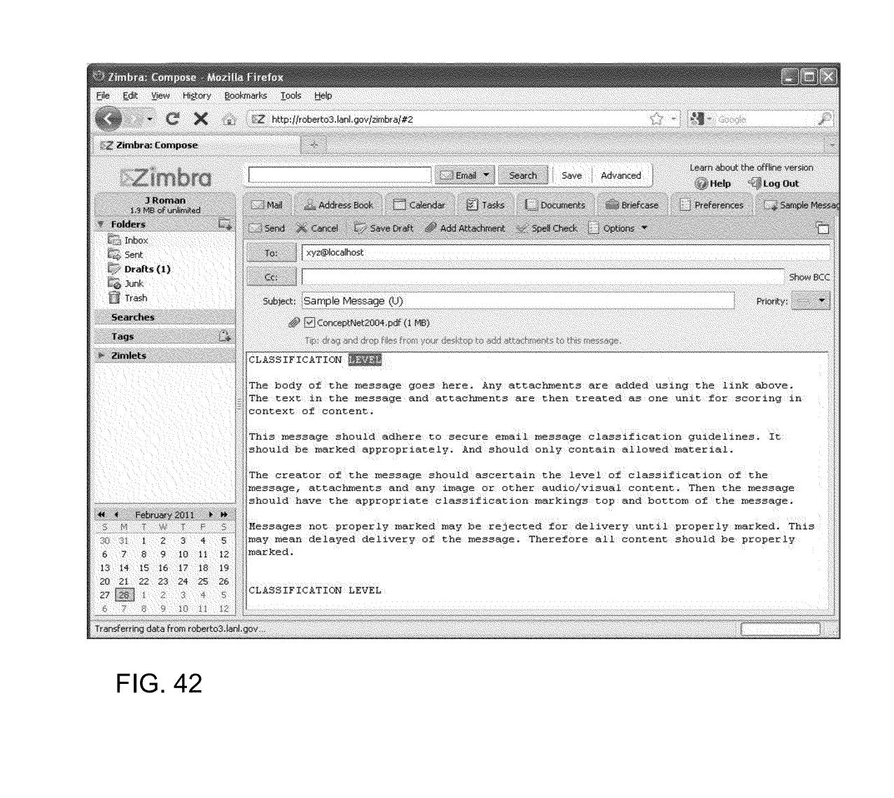

Clicking on the “New->Compose” under the Mail tab will bring the user to a screen depicted in FIG. 42. The user should follow site-specific guidance for marking the message appropriately.

Messages that do not contain disallowed content, images or other audio/visual attachments will flow through the system unchanged. Other messages will be redirected for human review and will be delayed if a reviewer is not readily available.

Selecting the “Send” button will initiate the analysis of the message and will wait for the server's reply before allowing the user to continue. Messages with long attachments may take a minute or more to process. The user should be patient and wait for the system's reply before proceeding.

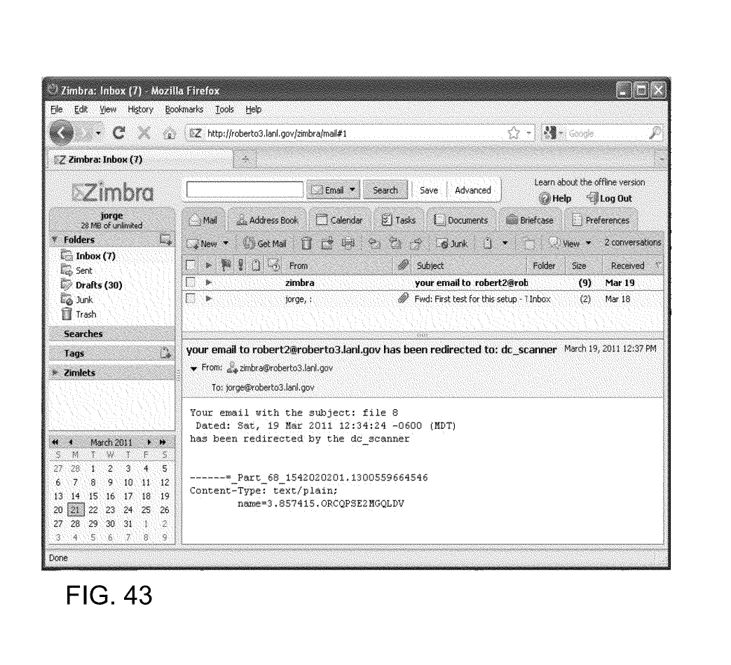

Messages that are rerouted for DC review will generate a warning back to the original sender to indicate that the message will be delayed until it has been reviewed. A sample message sent to original sender is depicted in FIG. 43. It displays the list of intended recipients at the top and a brief message that it has been redirected to dc_scanner.

Another condition that causes emails to be rejected is the size of the attachments. Most sites restrict the size of an email and attachments to 10 MB. Please adhere to local site guidance, as these large email messages will be rejected by the system.

Exemplary README file

Gateway-milter install instructions.
(Assumes standard installation of zimbra at /opt/zimbra and tomcat
/opt/tomcatX)
Install zimbra
Install and test Apache Tomcat from http://tomcat.apache.org/
Install test Java (simple java test is show below, if version is less than
1.6 or error this needs to be corrected before proceeding)
> java -version
Prior to eMF installation shutdown Zimbra and Tomcat.
> su zimbra
> zmcontrol stop
> cd /opt/tomcatX
> bin/shutdown.sh
Unpack the gateway_install.tar.gz to /opt. Insure that /opt has enough
disk space for a new installation. If not you might want to consider
creating /opt in /local and creating a soft link to it from /opt ln -s
/local/opt opt.
As ROOT:
> cd /opt/gateway_install
> ./install.sh
After the script runs execute the following commands:
> chkconfig sendmail off
> su zimbra
> cd /opt/zimbra/postfix/conf
> postconf -e ‘smtpd_milters = inet:127.0.0.1:2704’
> zmcontrol start
> cd /opt/tomcatx
> bin/startup.sh
As ROOT
> cd /opt/zimbra/clamav/sbin
> ./gateway-milter
To monitor milter log file:
> cd /opt/zimbra/log
> tail -f gateway*.log
At this point the gateway milter software should be running and
filtering content.
User accounts need to be created for “special”, “dc_scanner” under
zimbra.
Also, the zimbra MTA timeout variable should be increased to 300.
Test first by sending a simple email message through Zimbra 's web
mail interface.
Access to tomcat should also be tested using a web browser (FireFox is
recommended) point it to the location:
http://localhost:8080 (this will test basic access and should use the
correct hostname and port number)
http://localhost:8080/dcReviewBrowser (if the above test works this will
test the installation of the reviewers interface)
If these tests are successful more detailed content filtering testing can
proceed.
The gateway-milter software is based upon the design of the clamav-milter
which uses the libmilter api which is part of the sendmail distribution,
see http://www.sendmail.org/doc/sendmail-current/libmilter/README
and http://www.elandsys.com/resources/sendmail/libmilter/

Exemplary gateway_milter.conf file

##
## Example config file for gateway-milter
##
# Comment or remove the line below.
##
## Main options
##
# Define the interface through which we communicate with sendmail
# This option is mandatory! Possible formats are:
# [[unix|local]:]/path/to/file - to specify a UNIX domain socket
# inet:port@[hostname|ip-address] - to specify an ipv4 socket
# inet6:port@[hostname|ip-address] - to specify an ipv6 socket
#
# Default: no default
#MilterSocket /opt/zimbra/data/gatewa-milter.socket
MilterSocket inet:2704
#MilterSocket tcp:7357
# Define the group ownership for the (unix) milter socket.
# Default: disabled (the primary group of the user running clamd)
#MilterSocketGroup virusgroup
# Sets the permissions on the (unix) milter socket to the specified mode.
# Default: disabled (obey umask)
MilterSocketMode 660
# Maximum number of simultaneous threads of the Message processing to run
# small number overloads the system less, but less messages pass through.
# If messages are small then 10 would be best. However, if messages are long
then
# 3 is a good default.
MaxThreads 3
# Remove stale socket after unclean shutdown.
#
# Default: yes
FixStaleSocket yes
# Run as another user (gateway-milter must be started by root for this option
to work)
#
# Default: unset (don't drop privileges)
User zimbra
# Initialize supplementary group access (gateway-milter must be started by
root).
#
# Default: no
AllowSupplementaryGroups yes
# Waiting for data from clamd will timeout after this time (seconds).
# Value of 0 disables the timeout.
#
# Default: 120
#ReadTimeout 120
# Don't fork into background.
#
# Default: no
#Foreground yes
# Chroot to the specified directory.
# Chrooting is performed just after reading the config file and before
dropping privileges.
#
# Default: unset (don't chroot)
#Chroot /newroot
# This option allows you to save a process identifier of the listening
# daemon (main thread).
#
# Default: disabled
PidFile /opt/zimbra/log/gateway-milter.pid
# Optional path to the global temporary directory.
# Default: system specific (usually /tmp or /var/tmp).
#
TemporaryDirectory /opt/zimbra/data/tmp
# The output directory used in the script that starts the scoring process
# Default: system specific (usually /tmp or /var/tmp).
#
OutputDirectory /opt/zimbra/data/output
# The id of the derivative scanner.
DerivativeScanner dc_scanner
# The path and fname of the scoring script to execute.
ScoreScript /opt/zimbra/clamav/sbin/score.sh
#The score trigger on which the scoring script will be executed
ScoreTrigger 60
# English Percent Threshold, A calculated score that scans all words in the
content of the email and
# to see if it's one of the 5000 most-common words. The byte count is a used
to create a ratio of those words against
#all words in the document, aka English byte coverage.
EnglishPercentThreshold 60
#The special address that the derivative classifier will send the email to.
SpecialAddress special
#The path and name of the hyperlink for Tomcat.
Hyperlink http://localhost:8080/dcReviewBrowser/?sort=-
3&dir=webapps%2FROOT%2Fresults%2F
#Server for the Tomcat server
Server http://localhost:8080
# If this option is set to ″Replace″ (or ″Yes″), an ″X-Virus-Scanned″ and an
# ″X-Virus-Status″ headers will be attached to each processed message,
possibly
# replacing existing headers.
# If it is set to Add, the X-Virus headers are added possibly on top of the
# existing ones.
# Note that while ″Replace″ can potentially break DKIM signatures, ″Add″ may
# confuse procmail and similar filters.
# Default: no
AddHeader Add
# When AddHeader is in use, this option allows to arbitrary set the reported
# hostname. This may be desirable in order to avoid leaking internal names.
# If unset the real machine name is used.
# Default: disabled
ReportHostname dkm.lanl.gov.GATEWAY
# Execute a command (possibly searching PATH) when an infected message is
found.
# The following parameters are passed to the invoked program in this order:
# virus name, queue id, sender, destination, subject, message id, message
date.
# Note #1: this requires MTA macros to be available (see LogInfected below)
# Note #2: the process is invoked in the context of gateway-milter
# Note #3: gateway-milter will wait for the process to exit. Be quick or fork
to
# avoid unnecessary delays in email delivery
# Default: disabled
#VirusAction /usr/local/bin/my_infected_message_handler
##
## Logging options
##
# Uncomment this option to enable logging.
# LogFile must be writable for the user running daemon.
# A full path is required.
#
# Default: disabled
LogFile /opt/zimbra/log/gateway-milter.log
# By default the log file is locked for writing - the lock protects against
# running gateway-milter multiple times.
# This option disables log file locking.
#
# Default: no
#LogFileUnlock yes
# Maximum size of the log file.
# Value of 0 disables the limit.
# You may use ′M′ or ′m′ for megabytes (1M = 1m = 1048576 bytes)
# and ′K′ or ′k′ for kilobytes (1K = 1k = 1024 bytes). To specify the size
# in bytes just don't use modifiers.
#
# Default: 1M
LogFileMaxSize 0
# Log time with each message.
#
# Default: no
LogTime yes
# Use system logger (can work together with LogFile).
#
# Default: no
LogSyslog yes
# Specify the type of syslog messages - please refer to ′man syslog′
# for facility names.
#
# Default: LOG_LOCAL6
LogFacility LOG_MAIL
# Enable verbose logging.
#
# Default: no
LogVerbose yes
# This option allows to tune what is logged when a message is infected.
# Possible values are
# Off (the default - nothing is logged)
# Basic (minimal info logged)
# Full (verbose info logged)
# Note:
# For this to work properly in sendmail, make sure the msg_id, mail_addr,
# rcpt_addr and i macros are available in eom. In other words add a line like:
# Milter.macros.eom={msg_id}, {mail_addr}, {rcpt_addr}, i
# to your .cf file. Alternatively use the macro:
# define(‘ confMILTER_MACROS_EOM′, ‘ {msg_id}, {mail_addr}, {rcpt_addr}, i′)
# Postfix should be working fine with the default settings.
#
# Default: disabled
LogInfected Full
##
## Exclusions
##
# Messages originating from these hosts/networks will not be scanned
# This option takes a host(name)/mask pair in CIRD notation and can be
# repeated several times. If ″/mask″ is omitted, a host is assumed.
# To specify a locally orignated, non-smtp, email use the keyword ″local″
#
# Default: unset (scan everything regardless of the origin)
#LocalNet local
#LocalNet 192.168.0.0/24
#LocalNet 1111:2222:3333::/48
# This option specifies a file which contains a list of basic POSIX regular
# expressions. Addresses (sent to or from - see below) matching these regexes
# will not be scanned. Optionally each line can start with the string ″From:″
# or ″To:″ (note: no whitespace after the colon) indicating if it is,
# respectively, the sender or recipient that is to be whitelisted.
# If the field is missing, ″To:″ is assumed.
# Lines starting with #, : or ! are ignored.
#
# Default unset (no exclusion applied)
#Whitelist /etc/whitelisted_addresses
# Messages from authenticated SMTP users matching this extended POSIX
# regular expression (egrep-like) will not be scanned.
# As an alternative, a file containing a plain (not regex) list of names (one
# per line) can be specified using the prefix ″file:″.
# e.g. SkipAuthenticated file:/etc/good_guys
#
# Note: this is the AUTH login name!
#
# Default: unset (no whitelisting based on SMTP auth)
#SkipAuthenticated \hat{ }(tom|dick|henry)$
# Messages larger than this value won't be scanned.
# Make sure this value is lower or equal than StreamMaxLength in clamd.conf
#
# Default: 25M
#MaxFileSize 10M

### Exemplary Tomcat Installation Guidelines

Tomcat under Red Hat Linux is usually installed via a simple extraction of the distribution contents from a “.gz” file. An exemplary sequence is as follows:

1. Download tomcatX.Y.Z.gz for Red Hat from the internet.

2. As root:
a. Unzip tomcatX.Y.Z.gz to /opt/tomcatX
b. chown -R zimbra:zimbra/opt/tomcatX
c. modify/opt/tomcatX/bin startup.sh and shutdown.sh. Add JAVA_HOME variable to location for default Java installation. Add as first line: “export JAVA_HOME=path-to-java” where path-to-java is the location of the directory where java is installed.
d. su zimbra
e. cd/opt/tomcatX/bin
f. startup.sh or shutdown.sh

### Exemplary Rule Graph Software (Advance Rule Creators)

The rule-graphing package is located in the /opt/zimbra/data/output/GTree directory. To run it, the user is in the GTree directory (where FixFile.jar, guess.bat and guess directory are located).

The command is:
java -cp FixFile.jar GraphTree input_file output_file
   The Guess GUI window will pop up and the control can be used to adjust what and how items are displayed. The input_file & output_file can be located anywhere in the system (relative or absolute paths must be used). The input is a file with rules and output is a “.gdf” file to be used to graph the rules.

guess.bat (this is the name of the script being called) must contain the right script commands for the OS, and in Linux/Unix it must be an executable (chmod 775 guess.bat).

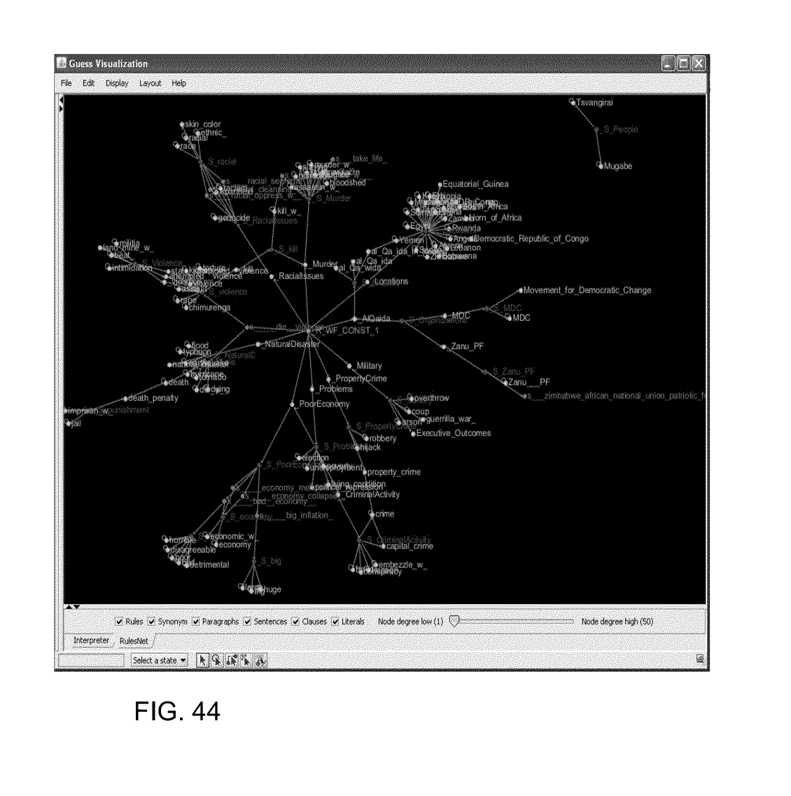

A sample screen is depicted in FIG. 44:

In the center, the mail rule in this file is provided, then synonyms (depicted such as in red), sentences (such as in purple), clauses (such as in blue), and simple terms (literals, such as in orange). These can be toggled on and off to display or hide the items listed.

This function is provided for advanced users, and it can be very powerful for displaying the details of complicated rule sets in one graph.

### Example 49

### Exemplary Computing Environment

The techniques and solutions described herein can be performed by software, hardware, or both of a computing environment, such as one or more computing devices. For example, computing devices include server computers, desktop computers, laptop computers, notebook computers, handheld devices, netbooks, tablet devices, mobile devices, PDAs, and other types of computing devices.

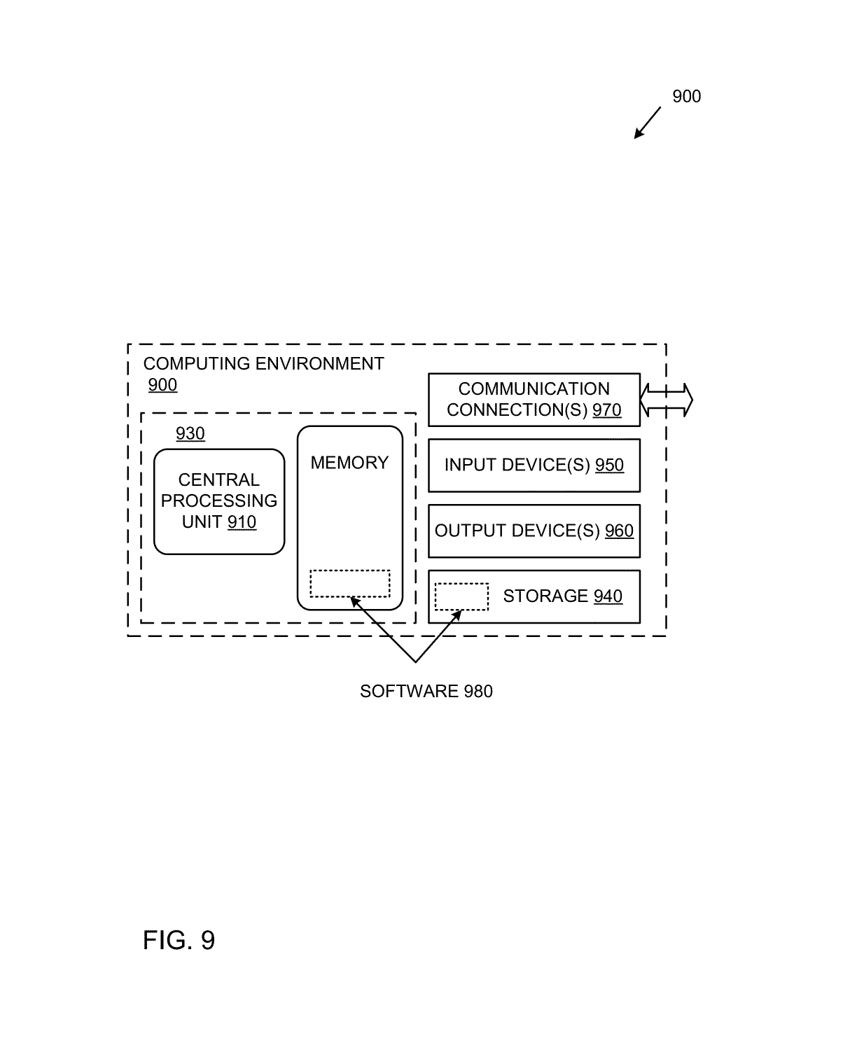

FIG. 9 illustrates a generalized example of a suitable computing environment 900 in which the described technologies can be implemented. The computing environment 900 is not intended to suggest any limitation as to scope of use or functionality, as the technologies may be implemented in diverse general-purpose or special-purpose computing environments. For example, the disclosed technology may be implemented using a computing device comprising a processing unit, memory, and storage storing computer-executable instructions implementing the enterprise computing platform technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like. The disclosed technology may also be practiced in distributed computing environments where tasks are performed by remote processing devices that are linked through a communications network. In a distributed computing environment, program modules may be located in both local and remote memory storage devices

With reference to FIG. 9, the computing environment 900 includes at least one processing unit 910 coupled to memory 920. In FIG. 9, this basic configuration 930 is included within a dashed line. The processing unit 910 executes computer-executable instructions and may be a real or a virtual processor. In a multi-processing system, multiple processing units execute computer-executable instructions to increase processing power. The memory 920 may be volatile memory (e.g., registers, cache, RAM), non-volatile memory (e.g., ROM, EEPROM, flash memory, etc.), or some combination of the two. The memory 920 can store software 980 implementing any of the technologies described herein.

A computing environment may have additional features. For example, the computing environment 900 includes storage 940, one or more input devices 950, one or more output devices 960, and one or more communication connections 970. An interconnection mechanism (not shown) such as a bus, controller, or network interconnects the components of the computing environment 900. Typically, operating system software (not shown) provides an operating environment for other software executing in the computing environment 900, and coordinates activities of the components of the computing environment 900.

The storage 940 may be removable or non-removable, and includes magnetic disks, magnetic tapes or cassettes, CD-ROMs, CD-RWs, DVDs, or any other computer-readable media which can be used to store information and which can be accessed within the computing environment 900. The storage 940 can store software 980 containing instructions for any of the technologies described herein.

The input device(s) 950 may be a touch input device such as a keyboard, mouse, pen, or trackball, a voice input device, a scanning device, or another device that provides input to the computing environment 900. For audio, the input device(s) 950 may be a sound card or similar device that accepts audio input in analog or digital form, or a CD-ROM reader that provides audio samples to the computing environment. The output device(s) 960 may be a display, printer, speaker, CD-writer, or another device that provides output from the computing environment 900.

The communication connection(s) 970 enable communication over a communication mechanism to another computing entity. The communication mechanism conveys information such as computer-executable instructions, audio/video or other information, or other data. By way of example, and not limitation, communication mechanisms include wired or wireless techniques implemented with an electrical, optical, RF, infrared, acoustic, or other carrier.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### Non-Transitory Computer-Readable Media

Any of the computer-readable media herein can be non-transitory (e.g., memory, magnetic storage, optical storage, or the like).

### Storing in Computer-Readable Media

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

### Methods in Computer-Readable Media

Any of the methods described herein can be implemented by computer-executable instructions in (e.g., encoded on) one or more computer-readable media (e.g., computer-readable storage media or other tangible media). Such instructions can cause a computer to perform the method. The technologies described herein can be implemented in a variety of programming languages.

### Methods in Computer-Readable Storage Devices

Any of the methods described herein can be implemented by computer-executable instructions stored in one or more computer-readable storage devices (e.g., memory, magnetic storage, optical storage, or the like). Such instructions can cause a computer to perform the method.

### ALTERNATIVES

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. A method of document filtering according to a plurality of filter rules performed at least in part by a computing device, the method comprising:
sending a document to specialized hardware or software emulator for evaluation according to configuration information derived from the plurality of filter rules, wherein the configuration information comprises word patterns appearing in the plurality of filter rules;
receiving evaluation results from the specialized hardware or software emulator; and
based on the evaluation results, classifying the document.

2. One or more computer-readable storage devices storing computer-executable instructions causing a computer to perform the method of claim 1.

3. The method of claim 1 wherein:
the evaluation results comprise indicated locations of the word patterns within the document.

4. The method of claim 3 wherein at least one of the filter rules specifies a locality condition, the method further comprising:
determining whether the locality condition is met, wherein the determining comprises processing the indicated locations of the word patterns within the document.

5. The method of claim 1 further comprising:
evaluating the document in the specialized hardware according to the configuration information derived from the plurality of filter rules.

6. The method of claim 1 further comprising:
deriving the configuration information from the plurality of filter rules.

7. The method of claim 1 further comprising:
determining whether the document has sufficient content of a particular human language, wherein the determining comprises performing hardware-accelerated pattern matching.

8. The method of claim 1 wherein:
the filter rules comprise one or more locality conditions specified via
(a) a plurality of word patterns within delimiters; and
(b) a locality type name outside the delimiters.

9. The method of claim 8 wherein:
the locality type name is specified via a single character.

10. The method of claim 1 wherein:
the document comprises an email message;
classifying the document comprises choosing between classifying the document as “permitted” and classifying the document as “not permitted”;
wherein the method further comprises:
responsive to classifying the document as “not permitted,” blocking the document from being sent outside of an organization.

11. The method of claim 1 wherein:
the filter rules comprise at least one concept rule specifying a plurality of conceptually-related words; and
the filter rules comprise at least one filter rule that incorporates the concept rule by reference.

12. The method of claim 1 wherein:
the filter rules comprise at least one filter rule specifying a weight.

13. The method of claim 1 wherein:
the filter rules comprise at least one filter rule specifying a weighting via a slope and offset.

14. The method of claim 1 further comprising:
displaying the document, wherein the displaying depicts words in the document that satisfy the filter rules with distinguishing formatting.

15. A context-sensitive filter accommodating hardware acceleration comprising:
memory;
one or more processors coupled to the memory;
a document scorer configured to receive a document and configured to process location information from specialized hardware, the document scorer further configured to output scoring results for the document based at least on the location information from the specialized hardware and a rule processing data structure constructed from a plurality of filter rules.

16. The context-sensitive filter of claim 15 wherein:
the rule processing data structure supports locality conditions.

17. The context-sensitive filter of claim 16 wherein:
locality conditions for document, sentence, and paragraph locality types are supported.

18. A hardware device comprising:
one or more processors, wherein the one or more processors are configured to perform a method comprising:
receiving a document;
receiving configuration information incorporating a list of word patterns; and
outputting evaluation results indicating positions within the document of the word patterns in the list of word patterns.

19. One or more computer-readable devices comprising computer-executable instructions causing one or more computing devices to perform a method comprising:
receiving an email message;
determining whether the email message contains sufficient English language content via hardware-accelerated pattern matching;
responsive to determining that the email message contains sufficient English language content, performing hardware-accelerate context-sensitive filtering on the email message via a plurality of filter rules, the performing generating a score; and
responsive to determining the score meets a threshold, blocking the email message from being sent.
